(19) United States
(12) Patent Application Publication
(10) Pub. No.: US 2013/0341934 A1
(43) Pub. Date: Dec. 26, 2013

(54) HYBRID POWER GENERATOR COUPLED TO GRAVITY POWER GENERATOR USING BALANCE WHICH HAS PRESSURE LOAD DEVICE

(71) Applicant: Eiji Kawanishi, Kawasaki-si (JP)

(72) Inventor: Eiji Kawanishi, Kawasaki-si (JP)

(21) Appl. No.: 13/261,179

(22) PCT Filed: Aug. 20, 2010
(86) PCT No.: PCT/JP2010/064539

§ 371 Date: Apr. 26, 2012

(30) Foreign Application Priority Data
Aug. 24, 2009 (JP) 2009-192940
Nov. 16, 2009 (JP) 2009-260651

(51) Int. Cl. B61D 43/00; H02K 57/00; F03D 9/00; F03B 13/00

(52) U.S. Cl. CPC B61D 43/00; F03B 13/00; H02K 57/003; F03D 9/002
USPC 290/1 A; 290/54; 290/55; 290/3

(57) ABSTRACT

There is provided a hybrid power generating system for hydraulic power, thermal power (nuclear power) turbines, geothermal, an engine room of a ship, wind power, solar power, a train (high-speed underground electric railway). The system of the present invention for existing hydraulic power, thermal power (nuclear power) turbines, geothermal, an engine room of a ship, wind power, solar power, a train (high-speed underground electric railway), a factory or the like is installed in a space for a power generator in sites of primary, secondary, tertiary substations. A torque converter automatic transmission which serves as a coupling clutch is coupled with a rotating shaft of a motor of the above, a cylinder of pressure load equipment working with a weight, water pressure, oil pressure, air pressure or the like which is suitable for potential energy serving as output is provided on each end of a load balance, a power which is increased according to a ratio of balances is transmitted to cylinders of a reciprocating balance at a fulcrum position, the increased power is input by a crank and combined in the power generator, and thereby output is increased.

### TECHNICAL FIELD

In a Hybrid power generating system, a wind turbine, a solar, a waterwheel and a heat turbine power generator and electric power regenerated by water stream of a ship and trains coupled with an existing motor and an existing dynamo of a gravity power generating unit using balances and increases an output by input of a power which is increased corresponding to a ratio of balances balance through a fluid device such as a weight, a water pressure, an oil pressure, an air pressure, and a vapor pressure are done with a medium

### BACKGROUND ART

A gravity power generating unit having pressure load equipment is shown in Patent Documents 9 to 14. Pressure force by an oil pressure, an air pressure and weight, and a little pressure force by a water pressure, a vapor pressure and a water stream are injected in a large aperture of a cylinder of each pressure load equipment, A stroke of the cylinder is smallest not to cause a pressure drop. In the cylinder, a slight amount of capacity is injected and discharged. Pressure load balances are provided on central axes of a plurality of trunnion double rod cylinders on the right and the left of a fulcrum and are subject to the power (gravity) increased according to the ratio of upper and lower two stage balances. Top and bottom chambers of the cylinder are filled up with oil sealed up, and a closed circuit variable displacement hydraulic pump is actuated by an external power to switch the top and bottom chambers alternately. The increased power is input into a crank mechanism by reciprocating balances with an upper portion of a rod. Or, the water pressure, a steam pressure are added to a head chamber, a top and bottom rod chamber by using a double acting single rod or a double rod cylinder of a water pressure or steam pressure, instead of the double rod oil hydraulic cylinder. The water pressure and the steam pressure may be used together with oil pressure. The increased output force is gradually input from the input device which is installed on the ground of the front edge side of a load balance to a power generating output power by the existing rotation output by external power (a waterwheel, a heat turbine, a wind turbine, solar light, a water stream). The object of the power generator is to achieve increase in generation output while balancing with the load output. According to the present invention, the power which is increased by the pressure load equipment is input from the reciprocating power transfer unit to the power generator by coupling with a rotating axis of large or small horizontal axis or vertical axis wind turbine power generator, an axis of large or small gas or steam turbine power generator, a solar power generator, or a rotating axis of an engine of a large-scale ship (of a water stream) and a power generator propellant axis drive. Or a power is increased by the pressure load equipment using a regenerated surplus power of the primary, the secondary, the tertiary substations, a railway construction site, and a large-scale plant, and the increased power is input from the reciprocating power transfer unit to the power generator.

### PRIOR ART DOCUMENTS

### Patent Documents

[PATENT DOCUMENT 1] JP-B-7-83630, Method for Controlling Linear Induction Motor
[PATENT DOCUMENT 2] Japanese Patent No. 2800586, Braking System for Electric Vehicle
[PATENT DOCUMENT 3] Japanese Patent No. 2782079, Method for Transporting Passenger between Platform of Deep Underground Subway Station and Platform off Aboveground Station
[PATENT DOCUMENT 4] JP-A-2005-92240, Platform for Tramway Vehicles
[PATENT DOCUMENT 5] JP-A-2006-76458, Support Device for Setting Up Train Timetable and Storage Medium for Storage of Processing Program Thereof
[PATENT DOCUMENT 6] JP-A-2007-98965, Method and Device for Controlling Hybrid Trains
[PATENT DOCUMENT 7] JP-A-2007-252084, Control Unit for Electric Cars
[PATENT DOCUMENT 8] Japanese Patent No. 3924077, Power Storage Motor and Method for Storing Power with Use of Power Storage Motor
[PATENT DOCUMENT 9] Japanese Patent No. 4281072, Gravity Power Generating unit Using Balances
[PATENT DOCUMENT 10] International Patent Application No. PCT/JP2009/053425
[PATENT DOCUMENT 11] Japanese Patent No. 4333930, Gravity Power Generating Unit Using Balances and Having Pressure Load Equipment
[PATENT DOCUMENT 12] Japanese Patent No. 4367795, Gravity Power Generating Unit Using Balances and Having Pressure Load Equipment
[PATENT DOCUMENT 13] Japanese Patent No. 4480051, Hybrid Power Generating System to Be Coupled with Gravity Power Generating Unit Using Balances and Having Pressure Load Equipment
[PATENT DOCUMENT 14] Japanese Patent No. 4544545, Deep Underground Tunnel High-Speed Underground Electric Railway for Single Track and Straight Railway
PATENT DOCUMENTS 9 to 12 disclose that power is increased by weight or fluid pressure according to a ratio of balances, the increased power is added to a fluid in a cylinder disposed on the right and the left of the fulcrum position to pressurize the fluid, and input in a power generator having a crank mechanism associated with the cylinder.
PATENT DOCUMENT 13 discloses that the above device is combined and coupled with unused or wasted heat of a boiler, water pressure force of a dam, water stream of a ship travelling at high speed (such as a tanker), or inefficient natural energy of solar, wind power (vertical axis wind turbine) and water power (high-altitude dam), or regenerated electric power of a train.
PATENT DOCUMENT 14 discloses that a station of a underground electric railway is placed on the ground instead of underground, and a high-speed low-floor train and a single-track deep underground tunnel of small diameter having height difference are employed. A train suppresses acceleration on downhill zone from a platform down to a level zone. This braking zone is adapted for a zone of regenerating power. This underground railway service comprises a plurality of aboveground stations, a section between the stations including a downhill zone to a level zone, the level zone and an uphill zone from the level zone, and a high-speed low-floor wheel train and a magnetically elevated linear motor train which run at accelerated speed. The regenerated electric power is returned to the substation facilities, and combined with electricity of a motor of a hydraulic pump of a gravity power generating unit using balances use having the pressure load equipment and the reciprocating power transfer unit. The power from the weight, water pressure from a building, etc., or stored air pressure force, or oil pressure equipments is increased according to the pressure load balance, and added to a fluid of the closed circuit reciprocating cylinder to pressurize the fluid, thereby an output of a power generator from the crank mechanism is increased. In urban areas, constructed is an energy saving high-speed underground electric railway for short-distance transport between stations having deep-underground tunnels and power for running trains between the stations is provided by taking in the regenerated electric power. The present invention is made by combining PATENT DOCUMENT 13 and PATENT DOCUMENT 14.

### DISCLOSURE OF INVENTION

### Problems to be Solved by Invention

The quantity of water in dam is limited. Although in steam or gas turbine power generating, waste heat from thermal engine is reused, cost for uranium, natural gas, coal, crude oil is limited. The natural energy such as wind power, solar power generator is ranked as renewal energy but inefficient, and is employed as complex power generation which is incorporated in existing commercial power generation. Nuclear energy provokes anxiety for the future in terms of discharge of carbon dioxide. Each power generating system has disadvantage. In the present invention, as an assist device making up for disadvantages of waterpower, heat, nuclear, wind power, solar and geothermal power generation, provides a gravity power generating unit, the gravity power generating unit using the balance having the pressure load equipment as in PATENT DOCUMENTS 13 and 14 with a rotating axis of a power source of each of a waterwheel, a heat turbine, a wind power, impellent motor of a ship, solar, train and large-scale plant. The water pressure, vapor pressure are employed in the double acting single rod cylinder which is the pressure load equipment. In the wind power, solar, small-scale water flow power generation and a train, a weight, oil pressure, air pressure are used for the pressure load equipment. In addition, the water pressure of a navigating ship at a speed is used for the pressure load equipment. A load material to be most suitable for the pressure load equipment is selected, and an appropriate generator, motor are selected out of induction or synchronous power generators.

In the gravity power generating unit using balances and having the pressure load equipment which is coupled and engaged with a water wheel of water power generation, the double acting single rod cylinder is used as the pressure load equipment which is provided on right and left tips of a loaded balance. A head chamber of a water pressure cylinder on each of right and left top end portions of the load balances is communicated with a hydraulic pipe from a high-altitude reservoir, a rainwater tank or a stream, and a water pressure is added by difference in height. The water pressure becomes a force proportional to an area of the head chamber under the pressure pushing on a piston. The capacity during stroke of a hydraulic cylinder is equal to a slight discharge quantity of water, and the head chamber of the hydraulic cylinder is fixed to a frame from the ground in an arbitrary orientation. Or the head chamber of the hydraulic cylinder is fixed to the balance in an arbitrary orientation and pressurizes a frame from the ground. A water pressure force from the hydraulic pipe becomes a pressure force of the tope end of the cylinder rod through a pressure force/flow control electric operated valve, then is added on the left and the right of the load balance, and ‘places a load continuously on them. The rod chambers of the right and left hydraulic cylinders communicate with one another via a hydraulic oil tube by a closed circuit variable displacement pump. The water pressure is produced by pressurizing the hydraulic oil, and the balance is configured to automatically shift a load from one end to the other end alternately. The pressure load equipment comprises a quick opening and closing shut-off solenoid ball valve having a timer, an solenoid discharge valve in the head chamber to which the water pressure tube is connected, and an electromagnet which is provided on the leading end portion of the rod, and a control device such as a permanent magnet. Power increased by the ratio based on length of a lower load balance is transmitted to the right and the left double rod cylinders of the lower load balance. The double rod cylinder is configured to drive by the closed circuit variable displacement capacity hydraulic piston pump upper and lower, double chambers which connect upper and lower balances which are symmetrical about their fulcrums. A crank rod is provided on the upper, short-size reciprocating balance which operates at the same time and at the same place as the lower balance, the crank rod is connected to the cylinder rod, and continuous with right and left crank gears which are installed on the ground. The increased power is input into the power generator of the reciprocating hydraulic transmission unit which comprises a flywheel on an intermediate gear which is a center of the crank gear. A countershaft, a gear shaft of the power generator is coupled and engaged with a vertical a vertical axis of a large-sized generation waterwheel, and a horizontal axis of a small-sized generation waterwheel via overdrive/reduction gears. The number of revolutions is adjusted by a torque converter automatic-transmission which is a clutch. In addition, at the place such as a dam where high pressure power is provided, instead of the double rod hydraulic cylinder, double acting water pressure single rod cylinder of a water pressure double rod cylinder having an arbitrary rod diameter may be used. Both of the upper head chamber and the lower rod chamber may be constructed to operate by quantity of high-pressure water from the water pressure tube via the pressure and water flow control valve and the solenoid quick injection or discharge valve which adjust timer. In addition, oil pressure may be put in a rod chamber from a closed circuit variable displacement piston pump which is incorporated in the above multiplex oil pump. Slidability may be improved by using the water pressure and oil pressure together. In a form of using quantity of water of small-size small-scale hydraulic power generation, the pressure is low, therefore, a power is increased by loading and unloading (contact with the ground) the balance alternately according to the ratio of balances by using pressure load equipments, namely a hydraulic or a pneumatic cylinder optionally provided on the load balance or a air hydraulic cylinder, and thus increased power may be input. And the increased power moves the crank rod and the double rod cylinder (the double acting water pressure single rod cylinder) operating simultaneously with the crank rod up and down. The closed circuit variable displacement piston pump of the model which is driven with the inverter vector control motor which is an external power is constructed to switch automatically an angle adjustment forward reverse tilt plate of load sensing type at positions of top and bottom dead centers, and small quantity of oil is introduced in the upper and lower chambers. The rotating waterwheel power generator operate the motor for the double rod cylinder and the hydraulic pump which are coupled with one another, and by alternate input, water pressure and quantity of water are injected in the upper and lower chambers of each of the water pressure double acting single rod or water pressure double rod cylinder, via a flow control valve, an on-off valve which is an solenoid ball valve using a timer, and a discharge valve. The water pressure and the quantity of the water is injected in the head chamber of the reciprocating water pressure single rod cylinder of the load pressure device, then becomes a large gravity to be input according to the ratio of the upper and lower balances with respect to length of the load balance. The power is associated with increase in quantity of oil by 30% by the tilt plates of the upper and lower variable displacement pumps incorporated in the multiplex pump which is provided at a position of fulcrum, or increase in quantity of water from the water pressure/water volume control electric valve. And the number of revolutions of the power generator consequently comes into balance with the number of revolutions of the power generator operated by waterwheels. For the power generator, used is a vector control inverter synchronous power generator or an induction generator. The vector control inverter synchronous power generator is adapted for combining output by gradually adding power increased by the water pressure of the pressure load equipment to revolution power of the power generation facilities by waterwheel.

Thermal power generation using a saturation steam pressure of boilers and a nuclear power generation are main power generation facilities for commercial electricity. A double acting single rod steam pressure cylinder is applied for the pressure load equipments which are provided right and left leading end portions of the load balance. A distance of stroke is optimized to eliminate drop of an air pressure in the head chamber, thereby a slight quantity of the steam is injected or discharged. For the cylinder, used is a fluorine type elastomer seal packing which withstands saturation temperature of the steam. In consideration of heatproof temperature of a seal, a cylinder sleeve is constructed of water-cooled radiator structure comprising an air-cooling fin and a water jacket to protect the seal, while a piston rod is constructed of a radiator structure comprising a water cooling fin. A rod chamber may be constructed to lower oil temperature by operation of a closed circuit variable displacement hydraulic piston pump. In addition, the rod chamber is formed into a pipe which is open-ended and unloaded for weight saving. In the rod chamber, an attraction and repulsion forces of a permanent magnet and an electromagnet may be used. Further, in the double rod hydraulic cylinder of the reciprocating oil pressure transfer unit having upper and lower chambers of sealed structure by using closed circuits, rise in oil temperature causes leakage from the seal packing and decrease in oil viscosity, therefore the above water cooling structure is employed for cooling down the oil temperature and keep the oil temperature constant. The above-mentioned multiplex hydraulic pump is actuated by using an external vector control inverter motor. The double rod cylinders linked with upper and lower balances which are coupled with a steam turbine generator having a boiler, a crank mechanism, and a power generator connection mechanism or the like are the same as those using the above hydraulic power generation. In addition, at the place where a high steam pressure is provided, the above double acting single rod steam pressure cylinder or double rod steam pressure cylinder of water-cooled structure may be applied to the upper and lower balances at position of fulcrum. Saturated steam pressure may be applied for the cylinder head chamber, while oil pressure may be applied to the rod chamber for facilitating slidability. The steam pressure may be applied to both upper and lower chambers by using a seal packing made of fluorine type elastomer of heat resistance and good slidability as well as injecting grease. Actuation of the cylinder is switched at upper and lower dead points by a heat-resistant solenoid switching valve by means of a timer and a limit switch. The actuation of the double acting single rod steam pressure cylinders is switched alternately right and left, and associated with loading and unloading by alternate actuation of the solenoid on-off valve using a timer and a discharge valve. The steam turbine has the number of revolutions greater than that of a waterwheel. A coupled power generator is installed on the ground near the leading end of the load balance. For the coupled power generator to which torque of a power increased by a steam pressure is added from a device for gradually balancing an increased power by using a speed decreasing device and the above torque converter automatic-transmission, the vector control inverter synchronous generator or the induction generator providing an output in combination with the steam pressure generation.

A gas turbine power generator has a higher revolution rate, and is provided with a torque converter automatic reduction gear on its rear axle. A crank mechanism of a reciprocating oil pressure transfer unit and an electric control machinery of pressure load equipment are the same as those of water pressure and steam pressure power generation. For the pressure load equipment, a steam pressure cylinder which is also adapted for cooling of gas heat, a hydraulic cylinder, a pneumatic cylinder, an air hydraulic cylinder with use of a weight are used. Control devices such as a heat-resistant poppet form solenoid on-off shut-off valve, an solenoid discharge valve are provided in the head chamber, and control devices such as an electromagnet and a permanent magnet are provided on the leading end portion of the rod, thereby a pressure is applied from a steam tube to the head chamber of the pressure load chamber. And, the above oil pressure or steam pressure cylinder is used for the reciprocating oil pressure transfer unit, and the vector control inverter synchronous power generator or induction power generator, and the motor are the same as the above.

A geothermal power generation is generation by using steam pressure, therefore using nature. In the geothermal power generation, difference in pressure and quantity of steam are used. High pressure is achieved by a large diameter of a steam pressure cylinder of pressure load equipment. Used are the same double rod cylinder of closed circuit structure of the reciprocating oil pressure transfer unit and the same multiplex oil hydraulic pump as above, and the crank mechanism and other constitution were the same as above.

At present, a horizontal axis variable-pitch propeller blade is mainly used for wind power generation. With use of new Darrieus form blade equipment of the present invention, electricity production is increased. Now a group of a plurality of units of horizontal axis wind turbines are in a suitable lot, and electricity generated as a whole is applied to commercial electricity. In the new wind power station which has a plurality units of large-scale wind turbines of the new equipment, amount of power generation per unit is increased. With the use of the equipment allowing for doubled production of electricity only by a single unit, it may be considered to convert the equipment to other energy equipment such as a superconductive storage or an electricity accumulating equipment.

In a present large-scale horizontal axis propeller wind turbine, drag and lift forces from wind pressure act on a swept rotor area which is formed by three blades. Turning force of the horizontal axis may be obtained by controlling and braking variable pitch, a gear of a rotor portion of a hub is coupled with a tower central shaft via a spiral bevel gear. Here, employed is a downwind rotor system in which the rotor and a yaw mechanism of a tower spinning portion as auxiliary equipment automatically adjust orientation of a nacelle portion so as to orient the hub of a front portion of the blades in the same direction towards which the wind is blowing. A long rotating shaft which extends vertically from an interior of the nacelle to the ground, a lower portion of the tower is coupled with a horizontal axis gear power generator of an above-ground part via a spiral bevel gear or a bevel gear. Alternately, the large-scale horizontal axis propeller wind turbine is structured in such a manner that in the tower, the vertical shaft is connected directly to a multi polar low revolution permanent magnet synchronous generator, the central shaft is provided with a fly wheel on a lower portion of the shaft of the generator, thereby the central shaft is floated up and attracted by a permanent magnet and an electromagnet. An integral stress construction of the shaft and the tower is formed by a plurality of bearings of a middle portion. Or, a spinning mechanism is structured in such a manner that the nacelle and the tower portion are formed into an integral fixed structure, a yaw mechanism is provided in the portion thereof above ground, in strong winds the orientation is changed automatically while in light winds the orientation of the tower portion above ground is changed by a spinning motor with the use of a controller including a wind direction sensor. Similarly to the case with gas turbine power station and substation, the oil hydraulic cylinder, the pneumatic cylinder and the air hydraulic cylinder may be used for the pressure load equipment. The air hydraulic cylinder uses a weight installed on the ground near the left and the right leading end portions of the load balance.

an air high mud cylinder using a weight installed in a hydraulic cylinder, a pneumatic cylinder, the ground of the tip of right and left of a load balance in pressure load equipment can be employed. A force is increased according to a ratio of balances, the number of revolutions and output are changed according to the change of wind power, the fly wheel near the generator on the ground and a torque converter automatic transmission work with quantity of oil increased or decreased in upper and lower closed circuit variable displacement oil hydraulic piston pumps of the same model of machines of double rod cylinders by external motors of vector control inverters of reciprocating oil pressure transfer units, cylinder pressure force and magnetic force of the pressure load equipment are adjusted to be constant, the increased power transmits electricity to a starting motor of an external electricity in light winds and to a commercial electricity that is load in strong winds, the double rod cylinder is an oil hydraulic pump, the pump is an oil pressure motor, the external motor is a power generator, the motor just provides an output for moving up and down the weight of the pressure load equipment, and the power of increased difference is input and combined in the commercial electricity in strong winds.

When weights of the ground near right and left leading ends of the load balance are used, the output from one of multiplex pumps, a small size closed circuit variable displacement oil hydraulic piston pump to rod chambers of right and left air hydraulic cylinders is constant. And a low revolution multi polar vector control inverter permanent magnet synchronous generator is used, but a squirrel cage induction generator may be also used. A flywheel is used as an auxiliary device for wind power and gravity devices. Vertical axis wind turbines (Savonius form, paddle form) have a long history, but efficiency is not preferable compared with horizontal axis wind turbine power generators and other power generating systems. The straight bladed vertical axis Darrieus wind turbine or the like is provided with a plurality of variable blades capable of control for light winds and braking, a low revolution generating vector control inverter synchronous power generator is applied for a generator on a part above the ground. Thereby, although driving force of winds of 5 to 6 m per second or greater is required in the present system, the new system is structured in such a manner that revolutions sufficient to generate electric power may be caused by winds of 2.0/m per second or less, and power is increased by combining input of the increased power from the pressure load equipment and the wind power.

For vertical wind turbines, the arcuate Darrieus wind turbine and the straight bladed wind turbines, a variable pitch blade, a variable blade axis and a forward reverse revolution axis are applied. For right and left blades or a plurality of blades a central shaft, namely a tower portion is not provided. Right and left upper blade shafts are installed and fixed on the ground with the use of a tower structural member which is a semicircular frame member surrounding the blade shafts on three or four sides. An upper axis of the coupling structural member and an axis of a lower power generator are adapted for a main bearing portion. A plurality of, right and left upper blade shafts and lower blade shafts are entirely formed into one fit-in shaft, the fit-in shaft is fitted in and engaged with a magnetic bearing. One center shaft between center portions of upper and lower main shafts and the plurality of the blade shafts are reinforced with a horizontal reinforcing plate. The horizontal reinforcing plate and the blade plate are fixedly bonded in surface-to-surface relationship to form a bearing center portion structure in which the blade plate is flexible with respect to the blade axis. The bearing of the blade plate fixed to the horizontal reinforcing plate and the upper and lower fit-in shaft is applied to a plurality of variable control, fixedly braking, blade shafts, and an individual blade shaft is rotated by an individual oil pressure or electric motor gear to construct each of them a variable blade shaft, and the blade shaft is moved to a position most suitable for forward reversal rotation, thereby achieved is a structure in which a pitch with respect to right and left blade surface lifting force blade may be adjusted. The blade may be rotated even in light winds by adjusting the position of the blade subject to winds in the framing member, the tower. For reinforcement, the right and left blades were reinforced horizontally individually at any arbitrary position such as upper or lower center portion, and a rotation structure is constructed by receiving a blade central shaft in upper and lower reinforcing shaft which is designed slim and light-weight. The device is small-sized. Or in the structure having sufficient wind pressure resistance due to upper and lower plays of upper and lower shafts and strength of the material for the blade, any arbitrary shaft and horizontal reinforcing plate may be used. When each blade rotates by around 90 degrees, each shaft moves to the position where all blades are oriented in the direction of wind, thereby wind power is eluded in strong winds such as typhoons blow. In the straight bladed wind turbine, of straight line wing-like, semicircular frame members to be fixed on the ground are framed straight thereby forming a tower surrounding blades on three or four sides or any number of sides. Similarly to the arcuate blades, a central tower portion is not provided, separate from a central shaft of an axis bearing, an oil pressure or an electric multi rotation axis is provided, according to the number of the blade surface and the horizontal plate to be fixedly connected to the blade. A rotating shaft is provided as a large or small fit-in shaft in a center of the main shaft. Each is applied to forward reverse revolution by 90 degrees and a plurality of blades are oriented in the direction of wind, thereby wind power is eluded in strong winds. In almost the same structure as the arcuate blade wind turbine, a low revolution permanent magnet synchronous power generator, or an induction power generator is provided in a lower shaft, and a permanent magnet and an electromagnet are used in the lower bearing region, and the blade is slightly floated up by repulsion by adjusting a magnetic force, and loaded by attractive force. Self-rotation of the blade is achieved even in slight winds by using an electromagnetic bearing or a bearing for the upper bearing and employing floating structure. Thanks to the above structure for fixing the four-sided frame structure member on the ground, a wind turbine larger than the present Darrieus wind turbine may be installed on an installation area smaller than before. The size is reduced by providing a plurality of blades, and the tower and the shaft of a center axis which is reduced in diameter and weight defines an axis for receiving a horizontal reinforcing plate. The upper and lower shafts of a plurality of blades are adapted for a rotating gear axis and the structure of the blades is reduced in weight. A torque converter automatic transmission is provided on an axis of a permanent magnet synchronous power generator of a vector control inverter multi polar low revolution structure, and an intermediate gear of a crank mechanism of reciprocating oil pressure transfer unit constructed in a gravity power generating unit with the use of balance having pressure load equipment as stated above is coupled with a torque converter automatic transmission. A power of oil pressure, air pressure, etc. of the pressure load equipment on a leading end of the load balance is increased according to the ratio of balances, and the increased power is placed on the cylinder piston for pressurization by driving a double rod cylinder of a reciprocating oil pressure transfer unit with use of a closed circuit variable displacement oil hydraulic piston pump with an external electric power. An output is increased by increasing oil quantity, and it is input in a power generator. A vector control inverter motor of a multiplex oil pressure pump is actuated by switching between the external electric power and an electric power generated by wind power. The Darrieus, straight bladed, vertical axis wind turbine is structured by coupling with the gravity power generating unit using balances and having pressure load equipment for the purpose of combining the power generated by the wind power and the power generated by the gravity power generating unit to increase the power generation during drive by wind power.

In the above system, the structural member is installed fixedly on the ground with the use of the tower frame member which surrounds the wind turbine on three or four sides, and the one way rotating, arcuate Darrieus, straight bladed vertical axis wind turbine having a plurality of blades is constructed in the structural member. However, in the one way rotating wind turbine, stress such as a centrifugal force on a bearing portion will be a great burden. Therefore, the force exerted on the blades which are exposed to wind and rain for a long time period, a bearing and a fixed base is reduced by constructing an internal and an external forward reverse rotation wind turbines capable of pitch control. The distance of spacing for eliminating difference in wind speed by the arbitrary number of the blades and inner and outer blades is increased as much as possible respectively, a flywheel is provided for the difference in wind speed is changed into constant revolutions at intersection. The stress on the upper and the lower shafts is balanced with centrifugal force, thereby the burden on the bearing is reduced. This also serves to eliminate sound of winds. In two bearings on upper and lower portions of the tower, forward reverse rotating axes are applied to two of the rotating shaft for the whole of the internal blades and the whole of the outer blades. Two forward reverse rotating axes are combined to one electric generator by a torque converter reverse rotation transmission. In the inner and outer blades, a lateral pitch may be adjusted by sliding each variable blade rotating shaft in upper or lower holes in the blade plate. Repulsion and attractive force of a permanent magnet and an electromagnet which give flying force to the plurality of the blades, the weight of the flywheel and wind power, a magnetic bearing and a bearing reduces frictional resistance. The burden of the stress such as expansion and contraction, deflection and torsion due to strong wind resulted from the structure without a central tower is reduced by a play in vertical motion of the axis and entire levitation force. Each of blade shafts is a variable blade shaft, the blade shaft is moved to a position most suitable for forward reverse rotation, a right and left blade surface lift force structure is constructed, thereby a control system is provided allowing for power generation even in breeze. A directly-connected, low revolution, multi polar permanent magnet synchronous power generator or an induction power generator is used, a shaft of the generator is coupled with a gravity power generating system using balances via a spiral bevel gear and a torque converter automatic transmission of other shaft. This serves also as an auxiliary motor activated by an external electric power for start up of rotation of the blades in initial operation. The external motor of the vector control inverter of the reciprocating oil pressure transfer unit is activated by switching to an internal power generation during wind power generation.

The above one way rotation blade is in a range of a plurality of blades rotating forwardly and reversely inside and outside, as one existing technology. The present system has a structure which is fixed by a framing structural member, and is a large-scale vertical wind power generator of which production of electricity per unit is increased by the plurality of the blades. The system of simple structure having a single blade is not explained here.

A solar power generation generates electricity in proportion to the daylight hours and the number of the solar panels, electricity generated is used or stored by connecting to a commercial power supply by means of inverter control, and solar power generation is inefficient generation similarly to wind power generation, and is required to increase production of electricity in the limited daylight hours. A gravity power generating unit with the use of a balance having pressure load equipment corresponding to production of electricity of a large-scale solar power generating station is installed, and a vector control inverter power generator is constructed, and the power generator is coupled and engaged with a large-scale solar power generating station. The pressure load equipment is constructed by using an oil hydraulic cylinder, a pneumatic cylinder, an air hydraulic cylinder using a weight as in the above wind power generation. As for the closed circuit variable displacement piston pump of a multiplex oil hydraulic pump driven by the external engine of the reciprocating oil pressure transfer unit, in the solar power generation, instead of a power by connecting a power generator of the engine (water power, thermal power, wind power, water flow) and the gravity power generating unit, a power from solar power generation is used for the motor of multiplex oil hydraulic pump of the reciprocating oil pressure transfer unit and the pressure load equipment, therefore, the system is a hybrid power generating system which combines the power generated by input a power increased by the weight, oil pressure and an air pressure, and a power generated in the solar power generation. According to an existing technology, in a site where wind power is obtained, a solar power generating unit generates a power while wind power is used for power generation after sunset, in rain or cloudiness. A power generating unit is combined with the gravity power generating unit using the balance having the pressure load equipment such as a weight, thereby constructed is a complex hybrid power generating unit combined with the power wind, solar, or gravity for improving efficiency.

An oil, a liquefaction gas, a coal, an iron ore, a container carrier, a large special service ship, a self-navigation work vessel, a vessel, a submarine, or the like has a propeller shaft of a diesel engine, a gas turbine engine, a nuclear power or a motor propeller shaft from a power generator.

A large diesel engine of low or middle revolution is coupled to a gravity unit with the use of a balance having pressure load equipment on flywheels of an engine front part. A gas turbine, a nuclear power steam turbine are of a high revolution, and a propeller shaft is coupled to an intermediate gear shaft of a crank gear of a reciprocating oil pressure transfer unit via a reduction gear device and a torque converter automatic transmission. In head chambers of right and left large water pressure double acting single rod cylinders of the pressure load equipment, a high water pressure is taken through a water pipe from a bow of the ship with the use of own ship speed. When a steam pressure double acting single rod cylinder is used, each of a cooling boiler steam pressure from a gas turbine and a boiler steam pressure of nuclear power is injected in a head chamber of the cylinder via a pressure/flow rate control electric valve, only by a small quantity corresponding a short stroke, thereby a pressure on the leading end of the rod is obtained. The pressure is placed on the right and the left of the load balance, and the load is applied constantly thereto. When a high pressure force is required by water flow of self-navigation vessel, a high water pressure pump to be activated by an external motor is provided in a water pipe, and an oil hydraulic pump or a compressed air storage cylinder by an air compressor is used. In the above structure, an engine is connected directly, and a torque converter automatic gear box is connected to a power generator or a motor propeller shaft of a ship with motor propeller shaft. Pressure load equipment and a reciprocating oil pressure transfer unit are the same as in the water power, thermal power and wind power generations. In the case of a ship on cruise for a long period of time, water flow caused by the ship provides a load output, and a fuel cost is saved by increased cruising speed.

In train service, electric power, whether direct current or alternating current, which is used for operation of entire number of train services for uptown and downtown on railway routes is transmitted by a plurality of substations via overhead cables. The train services include local train service, limited express train service or the like. The electric power more than required for total number of train services is transmitted, for safety purpose. In the conventional system, regenerative electric power is not consumed efficiently by trains going uptown/downtown. An electric power consumption becomes to a maximum from when a train starts till when the train runs at a nominal velocity, will be decreased when the train operates with inertia driving force, and when a regenerative brake is used for deceleration, an electric power is returned via overhead cables to reuse the regenerated electric power is used properly, without discarding the regenerated electricity. The structure is constructed as follows. The above-mentioned gravity power generating unit using balances and having pressure load equipment is installed each substation, an inverter vector control squirrel-cage induction generator is activated by surplus electric power which is regenerated electric power, and oil pressure force is generated by operating two closed circuit variable displacement piston pumps which are connected upper and lower chambers of the double rod cylinders of the multiplex oil pressure pump of the reciprocating oil pressure transfer unit, and one closed circuit variable displacement piston pump which is connected to the rod chambers of right and left air hydraulic cylinders using oil hydraulic pumps, pneumatic pumps, weights of the pressure load equipments. In addition, the water pressure of a rainwater reservoir of a building of a substation or the like located on a high place is used. A power is increased by placing a load alternately on right and left of the balance according to the ratio of balances, the increased power increases output from increased oil pressure from two variable displacement pumps, and a generated power of the squirrel-cage induction generator of right and left crank mechanism, and a middle shaft, is transmitted to a general commercial electric power or re-transmitted to the overhead cables. Although the main purpose is to supply the commercial electric power, in this structure, since the electric power from the power increased by the pressure load equipment is returned again to the substation, the electric power to be transmitted from the main transmission line to the overhead cable is saved. The power increased in proportion to the length of the load balance is gradually discharged by a single action air cylinder of the device to which the above increased power is input gradually. The increased power transmits a power generated from the crank mechanism, while balancing with the output of the squirrel-cage induction generator, the motor by a rotation sensor of the generator and a program of a controller.

In construction of a high-speed underground electric railroad in a town area, a level track through a tunnel is constructed in a land over a public land and a private land, underground at a depth of 50 m. When total distance is supposed to be 30 km, there are five stations from a first to an end station, a distance between adjacent stations is 7.5 km, each station has three platforms for passengers, and four to six trains, connecting trains or buses can stop at the station. A distance from an underground level section to an uphill section is 1 km, and that of a down hill section is 1 km, for speed-up and slowdown sections. For a train, a high-speed low-floor rotary motor train or a magnetically elevated liner car which is allowed for acceleration up to 400 km/h on the downhill section of 1 km is applied. It accelerates at the highest speed along the downhill section of 1 km length, runs along a level section, and then slows down along the uphill section, finally stops by a platform at a station. Here, in a basic operation of a train shuttle service between the first and the end stations, the gravity power generating unit using balances and having pressure load equipment is provided each of a plurality of the stations, the electric power regenerated on a downhill braking section may be used as much as possible, thereby production of the electric power is increased, the electric power is supplied as the commercial electric power, while electric power is generated in the overhead cables. A diameter of a shielded tunnel of 6.0 m is used for a train service of standard gauge or broad gauge in a single track straight railway, that of 5.0 m for the low-floor rotary motor train and the magnetically elevated linear motor car.

When a double and straight track tunnel is divided into upper and lower parts for operation of the magnetically elevated low-floor linear motor car o in both directions, the diameter of the shielded tunnel is 8.0 m. A shielded tunnel is constructed with use of eight boring machines with shields from spots of five stations of the example, at the same time, each of the stations, and other facilities on the ground such as platforms are constructed, and it takes about three years to complete the whole system. The straight railway track section may be a tunnel section underground at depth of more than 50 m including a private land. Each section between adjacent stations has the same slope and distance, and for the land surface section, the public land is used as much as possible.

When the system is planned to have the same structure as an existing underground railway system having a double track and underground stations, the system of the present invention is advantageous. In the single track railway of the present invention, a train runs from a station aboveground, down to a level section deep underground, along the level section with inertial driving force, then up to and arrives at the next station above ground. Soon after that, the train starts for the second station, while the single track is shared by another train which left the starting station is kept there. This structure is advantageous. The sections except for the aboveground stations with are in cylindrical tunnels and it is not necessary to provide a train with windows. It takes 3 to 4 minutes from boarding to arrival, and acceleration from departure to a downhill section is about 2 G. When a low-floor train runs on single straight track, the standard gauge or the broad gauge broader than that in a tunnel at high speed, the low-floor train does not roll, therefore. In the train, seats may be eliminated, but a plurality of hand rails and straps may be provided. Automatic steps for handicapped people at stoppage time is arranged to shorten boarding and alighting time. On an uphill slowdown section, a train slows down by itself on the uphill. Different from existing underground railway system with double track in which the distance between adjacent stations is 2 to 3 km, the track between adjacent aboveground stations is straight and 10 km long, and the system of the present invention is suitable for underground railways which requires high-speed.

To a high-speed train, alternating current 20000V is supplied via overhead cables by electric substation equipment installed in a starting station, an intermediate station, a last station, and a three phase alternating current bipolar VVVF inverter vector control high-output squirrel-cage induction motor is activated via a transformer, a rectifier in the train. The train has 10 cars, maximum possible velocity at 350 km/h, and a light-weight motor made of aluminum alloy with output of 5400 kW/h. The train is constructed low-floor in such a manner that small wheels (around 700 mm) are disposed under seats in a side wall floor. A bearing is provided at height of its floor portion. When a train operates along the level section with inertial driving force, the velocity is 250 km/h to 300 km/h. When the train accelerates on a downhill section from the platform, a potential energy is suppressed by a regenerative brake, a zone to a level section, a course of 700 m of travelling time 10 seconds is adapted for a regeneration zone. Each train departs every three minutes, and the same position of each tunnel becomes a regeneration place. In each train, electric power is transformed to high voltage and returned to substation equipment which is provided in each station, and input in a squirrel-cage induction motor of the gravity power generating unit using balances and having a plurality of pressure load equipments which are activated by an electric power which is transformed to low voltage. An intermittent electric power is changed to a continuous rotary power by a flywheel of a crank mechanism. With the electric power and the transformed low-voltage electric power, or a commercial electric power, a force of an air hydraulic cylinder using weight of the ground or a double acting oil pressure cylinder of an oil pressure unit, or a force of a double acting storing air pressure single rod cylinder or the like from a high place is applied to a load alternately to right and left of the pressure load equipment on a weight load balance, while using attractive force and repulsion force of a permanent magnet and electromagnet. A power increased according to the ratio of balances with respect to a reciprocating balance is applied to pressurize quantity of oil in upper and lower chambers of right and left oil pressure closed circuit double rod cylinders at a position of fulcrum, and a multiplex pump is activated by a vector control inverter alternating current three phase six polar squirrel-cage induction motor. The multiplex pump organizes auxiliary pumps for adding oil and replacing hydraulic oil, the air hydraulic pump and the same two closed one variable displacement piston pumps into one. The power increased according to the ratio of balances increases rotation of the crank mechanism associated with right and left oil pressure closed circuit double rod cylinders by adding oil in the oil hydraulic pump, and output of the vector control inverter three phase six polar squirrel-cage induction power generator is increased. An electric power corresponding to an electric power to be consumed by a plurality of high-speed train is transmitted at high voltage from a plurality of substation equipments to overhead cables, or transmitted at low voltage to a commercial electric power.

A superconductive elevated linear motor car is employed in air terminals or the like using subseafloor. Such air terminals where the number of passengers is temporarily large are at long distance from major stations, or such terminals are at long distance from a town area where numerous people are attracted for quick access to stations at destination. In the train operation in deep underground tunnel where a distance between adjacent stations is short in the town area, a small and a light-weight onboard primary member type magnetically elevated linear motor train is applied.

### Means of Solving the Problems

According to the invention of claim 1, a hybrid power generating system for coupling a large-scale water turbine generator with a gravity power generating unit using balances, the gravity power generating unit having pressure load equipment, the hybrid power generating system, comprises a water turbine (78a) to be subject to water pressure energy of height difference of a large-scale hydroelectric power plant, and to be rotated by a large volume of water from a water pressure pipe at high pressure, a power generator (11) integral with the water turbine (78a), a gravity power generating unit (A) having pressure load equipment, using upper-lower two step balances with a center on their fulcrum, each of the balances having a fulcrum point at a center thereof, and a torque converter automatic transmission (86) disposed between the water turbine generator and the gravity power generating unit (A), for coupling the water turbine generator with the gravity power generating unit (A) into one power generating system. The larger the wind turbine is the less frequently will the wind turbine turn. Double acting single rod water pressure cylinders (9a) are provided on right and left leading end portions of the lower balance, a separate pressure water pump for applying water pressure by the height difference communicates in a head chamber of each of the double acting single rod water pressure cylinder (9a), via a pressure control electric valve and a flow control electric valve, leading ends of the cylinder rods are on right and left portions of a load balance (1), and apply a pressure force constantly in proportion a pressure receiving area of a piston in the head chamber. Rod chambers of the right and left double acting single rod cylinders communicate with one another via a oil hydraulic tube (23), and load is applied alternately to the right and left rod chambers by pressurizing the hydraulic oil by an variable displacement oil hydraulic piston pump (27) for a closed circuit in a multiplex oil hydraulic pump (14). The pressure load equipment has control device, the control device comprises a quick acting solenoid on-off shut-off valve (67) and a solenoid discharge valve between the pressure water pipe (4) and the head chamber, permanent magnet (7) and an electromagnet (6) on the leading end portion of the rod. A reciprocating oil pressure transfer unit is provided on a center portion between right and left ends of the balance, the reciprocating oil pressure transfer unit has a plurality of, right and left a double rod oil hydraulic cylinder (3a) at positions each of which set by a short distance according to a ratio of balances, and a power increased by the pressure load equipment is transferred alternately to the double rod oil hydraulic cylinders to pressurize a piston. Upper and lower chambers of the double rod oil hydraulic cylinders are continued via two closed circuit variable displacement oil hydraulic piston pump (25) of the same model which are activated by an external motor, and the right and left double rod oil hydraulic cylinders is switched by the closed circuit variable displacement oil hydraulic piston pump (25), using a limit switch (34) at upper and lower dead center positions and a timer (38), at the same time as activation of the pressure load equipment. The multiplex oil hydraulic pump (14) is a multiplex quintuplex oil hydraulic pump (14) activated by an external motor, in the multiplex quintuplex oil hydraulic pump (14), and two auxiliary pumps (26, 28) for replacing hydraulic oil are incorporated at a vertically and laterally symmetrical position, a fulcrum. A forward reverse tilt plate is angled by sensing a load of an increased power, and the forward reverse tilt plate is switched by an automatic cam (46) under power transmission of an intermediate shaft, to define a variable displacement tilt plate angle for increasing pressure of the hydraulic oil. The external motor (12) activates the auxiliary pump so as to serve a function of supplying the hydraulic oil. The vertical axis water turbine generator (11) has a flywheel (8) for adjusting volume of water, an rotation axis of the vertical axis water turbine generator rotates a horizontal axis with a spiral bevel gear, the horizontal axis rotating is coupled with a shaft of right and left crank gears (17) of the gravity power generating unit, and coupled with right and left double rod cylinders (3a) and a crank rod (15), a water turbine rotates with up and down movement of the double rod cylinder, the cylinder functions as a pump, the oil hydraulic pump of the closed circuit functions as an oil hydraulic motor, and the pump motor functions as a power generator. The water turbine transmits a commercial electricity as a load. A device is provided for gradually inputting an increased power to the double rod cylinders moving up and down. In the generator, an output configuration is arranged in such that a power increased according to a ratio of balances is input from the torque converter automatic transmission, balancing with the flywheel, a water turbine (78a) gradually increases an output by increased volume of water, balancing with an output of the water turbine power generator, accordingly the power which is increased with pressurizing the variable displacement oil hydraulic piston pump is converted to rotation output, the water turbine generator is capable of generating and combining power. A synchronous or an induction generator of a vector control inverter is used. The upper and lower closed circuit oil hydraulic pump (25) of the same model, and the right and left double rod oil hydraulic cylinders serve as conveyance media for coupling both power generators by closing circuits to transfer a small quantity of hydraulic oil alternately between the right and left ones. As countermeasure against sliding heat, a water-cooling radiator (89) of water jacket is applied for an inside of a pipe piston rod and a cylinder sleeve, or to the double acting single rod water pressure cylinder (3b), a double rod water pressure cylinder of arbitrary rod diameter is applied, the double rod water pressure cylinder includes head and rod chambers in which both a water pressure and an oil pressure are applied, and is incorporated in a power generation space. That means, in the present invention, the gravity power generating unit using the balances and having the pressure load equipment is coupled with a power generator of an existing water power generating system to combine outputs, thereby a generated power is increased.

According to the invention of claim 2, a hybrid power generating system for coupling a small-size small-scale water turbine generator with a gravity power generating unit using balances is provided. The gravity power generating unit has pressure load equipment. The hybrid power generating system comprises a small-size small-scale water turbine generator having a water turbine (78a) and a power generator (11), the water turbine (78a) being selected according to water volume, water flow to use a source of water, a drainage canal or the like at a place of small height difference, a gravity power generating unit (A) including pressure load equipment and upper-lower two step balances and further including a power generating equipment coupled with the power generator (11) via a horizontal axis. The power generating equipment has a rotating intermediate axis disposed at a position of the balance. Double acting single rod water pressure cylinders (9a) of large diameter are provided on right and left leading end portions of the lower balance, reciprocating oil pressure transfer units are provided on a left and a right of an upper reciprocating balance with respect to a fulcrum point thereof for connecting and linking the upper and lower balances to one another, a pressure from the small volume of water and height difference is increased according to a ratio of balances into a high pressure, and the high pressure is transmitted in upper and lower chambers of closed circuit double rod oil hydraulic cylinders (3a) of the reciprocating oil pressure transfer unit. Closed circuit variable displacement oil hydraulic piston pumps (25) of the same model are coupled with external driving means and are connected between upper chambers and between lower chambers, a load of an increased power is applied alternately pistons of the right and left closed circuit double rod oil hydraulic cylinders (3a), at upper and lower dead points, and a power further increased is input in the water turbine power generator (11) from the closed circuit double rod oil hydraulic cylinders (3a) and a crank at a position thereof. Or, an air hydraulic cylinders (93) are used as pressure load equipment, instead of the water pressure cylinders, an air pressure is filled in head chambers of the air hydraulic cylinders (93), a load which is more lightweight than a weight placed on the ground is applied on leading ends of a load balance, when the weight contacts the ground by adjusting an oil pressure force in a rod chamber, no load is applied, a power is increased by switching the load alternately to one another, according to a ratio of balances, and inputs in the power generator from the crank mechanism of the double rod cylinders. Alternatively, double acting single rod pneumatic cylinders having an open circuit oil hydraulic unit (79) and a storage tank may be used as pressure load equipment. A power is increased by discharge of an air pressure of a single acting air cylinder (5) which is a device for gradually inputting a power and by increase of the air pressure by pressurizing the closed circuit variable displacement oil hydraulic piston pumps (25) of the reciprocating oil pressure transfer unit, the power serves as rotating output, the output by the volume of water is combined with the increased power while adjusting a volume of water of the water turbine power generator and balancing with the increased power, to increase the output, the increased power is input in the water turbine power generator (11), and thereby combined with the generated power. Multi polar low revolution synchronous power generator (11) is used in a vector control inverter. The upper and lower closed circuit variable displacement oil hydraulic pump (25) of the same model, and the right and left double rod oil hydraulic cylinders (3a) are conveyance media for coupling both power generators by closing circuits to transfer a small quantity of hydraulic oil alternately between the right and left ones. The multiplex oil hydraulic pump (14) is multiplex and is activated by a vector control inverter motor (12) for a commercial electric power, the multiplex oil hydraulic pump (14) organizes one closed circuit variable displacement piston pump for a rod chamber of the double acting single rod water pressure cylinder (9a) and for a rod chamber of the air hydraulic cylinder (9e) of the device, a high-pressure variable displacement piston pump (26) which is one of auxiliary pumps for increasing or replacing the hydraulic oil in the double rod cylinder with its circuit closed, and an auxiliary gear pump (28) which is one for the pressure load equipment. A device is provided for gradually inputting an increased power to the double rod cylinders moving up and down. A water turbine (78a) gradually increases an output by increased volume of water, balancing with an output of the water turbine power generator, accordingly the power which is increased by pressurizing two closed circuit variable displacement oil hydraulic piston pumps (25) is rotation output, the water turbine generator is capable of generating and combining power. A synchronous or an induction generator (11) of a vector control inverter is used. In order to ensure switching of loading and unloading of the pressure load equipment, a permanent magnet and an electromagnet are provided on frames placed on the balance and the ground, or the frame placed on the ground, and an attraction and repulsion forces thereof is used. Revolution each of a motor (12) and a power generator (11) of the vector control inverter is controlled by a programmed controller, and a power is increased by a small volume of water using each control device and combined with the small-size small scale water turbine power generator that is coupled thereto. That is, the present invention provides a water power generation by a slight water flow and water pressure, and a generated power is doubled.

According to the invention of claim 3, a hybrid power generating system comprises a power generator (12) of a boiler (77) of thermal power generation of a steam, gas turbine power generating equipment, geothermal, nuclear power generation, and a gravity power generating unit (A) which is coupled to the power generator (12) using balances and having pressure load equipment. Double acting single rod steam pressure cylinders (3c)are applied to the pressure load equipment on right and left leading ends of a lower load balance, and a stroke of the cylinder is set so as to discharge a slight quantity of steam, not to cause a pressure drop in a head chamber where saturated steam pressure which is air pressure is added. A seal packing or the like made of a fluorine type elastomer seal packing which withstands saturation temperature of the steam is used, a cylinder sleeve is formed into a structure of water-cooling fin (90), and water-cooling radiator (89) of a water jacket in consideration of heatproof temperature of a seal for protecting the seal. Since a piston rod is adapted alternately to load and unload by using attraction and repulsion forces of a permanent magnet and an electromagnet, the piston rod is formed into a lightweight pipe having a structure of water-cooling radiator fin (89). The rod chamber is open-ended and unloaded, or is loaded by loading alternately on right and left cylinders by a small-size closed circuit variable displacement oil hydraulic piston pump (27), one of a multiplex oil hydraulic pump (14), by switching load and unload under protection by the seal packing. A lower load balance (1) and an upper reciprocating balance (2) are connected and linked to one another at right and left positions with respect to fulcrum by double rod oil hydraulic cylinders (3a) of the reciprocating oil pressure transfer unit. Right and left upper rod chambers are the same in quantity of a hydraulic oil, right and left lower chambers are the same in quantity of the hydraulic oil, and loading is switched alternately between right and left rod chambers by the multiple oil hydraulic pump (14) activated by the vector control inverter motor (12) with external supply of electric power. Alternatively, a double acting single rod steam pressure cylinder (3c), or a double rod steam pressure cylinder of an arbitrary rod diameter is used, the upper and lower chambers are protected by the seal packing, and one of oil hydraulic chambers is pressurized by a closed circuit variable displacement piston pump. A water-cooling radiator structure is employed for keeping the oil temperature constant. For the multiplex oil hydraulic pump (14), a vector control inverter motor (12) is used. In a power generator coupling mechanism comprising a turbine power generator by steam from the boiler (77), the double rod oil hydraulic cylinder (3a) linking the upper and lower balances, and an intermediate axis of a crank mechanism, a steam gas turbine power generator has high revolution, is provided with a speed reducer and a torque converter automatic transmission (86) on a rear axis thereof, and is coupled with the crank mechanism of the reciprocating oil pressure transfer unit. For electric control devices relative to a force-discharge valve of the pressure load equipment, since a steam has high temperature, a heat-resistant poppet type solenoid on-off shut-off valve activated by a limit switch (34), a timer (38), a solenoid discharge valve (85), an electromagnet (6) or a permanent magnet (7) on a leading end portion of the rod are applied, thereby input from a steam pipe (83) into a head chamber is controlled. When steam pressure is not used in the gas turbine power generator, by using double acting single rod oil hydraulic cylinders (9c) or single rod pneumatic cylinders (9d) of oil hydraulic pump units fixed on frames placed on right and left on the ground for the pressure load equipment on the load balance, and simultaneously using attraction and repulsion forces of the permanent magnet, the electromagnet on the leading end of the rod, load and unload is repeated. Alternatively, an air hydraulic cylinder (9e) having a head chamber filled with an air pressure and sealed is used for the pressure load equipment, the air pressure balances with a weight (10b) placed on the ground, near each of right and left leading ends of the load balance (1), loading and connection to the ground are repeated by force-discharge alternately by right and left small-size closed circuit variable displacement oil hydraulic piston pumps (27), flushing is done by an auxiliary pump (28), and attraction and repulsion forces of the permanent magnet (7), the electromagnet (6) on the ground and the balance are also used. A power increased by each of the pressure load cylinders is input from a crank to the steam turbine power generator (11) coupled with the intermediate axis. A rotating output is increased by the closed circuit variable displacement oil hydraulic piston pump (25) sensing two loads and also by gradual increase of oil pressure and replacement of the hydraulic oil by the auxiliary pump (26). The air pressure filled in the head chamber of the single acting air cylinder (5) of the device placed on a lower portion of the load balance (1) for gradually inputting an increased power is discharged, and an air pressure is input therein. The power generator is thermal power generator, nuclear steam power generator or gas turbine generator, for using high pressure from the boiler, turbine power generation of saturated steam of high temperature. When a geothermal power generation is used, a steam pressure is generated by pressure difference and the volume of steam in a steam borehole, and high pressure is obtained by using a double acting single rod steam pressure cylinder (9b) of large diameter in the pressure load equipment. In the geothermal power generation, the double rod oil hydraulic cylinder (3a) of closed circuit in the reciprocating oil pressure transfer unit, the multiplex oil hydraulic pump (14) which is activated by the vector control inverter motor (12), the pressure load equipment and the crank mechanism are the same in structure except for output difference as the boiler (77) of the aforementioned thermal, nuclear power generation, control devices is used, synchronous generator (11) or inductive generator (11) of the vector control inverter is applied for the power generator, and the steam, gas turbine power generators are combined with the gravity power generating unit using balances and having the pressure load equipment. That is, according to the present invention, by coupling the gravity power generating unit with an existing turbine power generating system, waste heat steam pressure is reused.

According to the invention of claim 4, a hybrid power generating system, comprises a large-size horizontal axis variable-pitch propeller wind turbine, and a gravity power generating unit using balances and having pressure load equipment. The gravity power generating unit is coupled with the propeller wind turbine, A gear of a rotor of the large-size horizontal axis variable-pitch propeller wind turbine is coupled with an axis of an upper portion of a tower, with a spiral bevel gear or a bevel gear. A blade surface is configured to automatically rotate blades in such a manner that the tower is located in front of a hub and the blade (93), and a yaw mechanism of a downwind rotor assists rotation, and functions as a braking apparatus (95). A gear power generator (11) having a horizontal axis is provided, the gear power generator (11) is coupled with vertically rotating long shaft (96) which extends down onto the ground under the tower, via the spiral bevel gear, alternately, and a vertical axis motor (11) is provided in the aboveground tower portion. By using a plurality of bearings of a middle portion, the shaft and the tower are formed into an integral stress construction. Or, a spinning mechanism for controlling wind direction may be also structured in such a manner that a nacelle and a tower portion are formed into an integral fixed structure, a yaw mechanism is provided in an aboveground portion, and in strong winds the orientation of the nacelle is changed automatically while in light winds the nacelle spins by also using an auxiliary oil hydraulic spinning motor with a controller according to information on wind direction from a sensor. The generator (11) having the horizontal axis or having the vertical axis, is coupled with a gravity power generating unit (A) using balances and having pressure load equipment and is adapted for gradually inputting an power increased according to a ratio of the upper-lower two step balances, by the torque converter automatic transmission (86). A pressure device selected from an oil hydraulic cylinder (9c) of a oil hydraulic unit (79) and a pneumatic cylinder (9d), or an air hydraulic cylinder (9e) subject to weight of a weight (10b) placed on the ground near right and left leading ends of the pressure load equipment (1) is used for the pressure load equipments on right and left leading end portions of a lower balance. The power increased according to the ratio of balances is transmitted to the double rod hydraulic oil cylinder (3a) which is connected and linked to the reciprocating balance (2) on the upper step at a position of a fulcrum, the power increased according to the ratio of balances is associated with an oil pressure by activation of two closed circuit variable displacement oil hydraulic piston pumps (25) of the multiplex oil hydraulic pump (14) activated by the vector control inverter motor (12) driven by an external supply of electric power, and the upper and lower closed circuit variable displacement piston pumps (25) are the same model. The pressure load equipment is structured in such a manner that an alternate output in chambers of right and left cylinders by one small-size closed circuit variable displacement oil hydraulic piston pump (27) is constant, an air pressure is filled and sealed in a head chamber, the air pressure is balanced with weight of the weight (10b), with assistance of attraction and repulsion forces of a permanent magnet (7) on the ground and the electromagnet (6) of the weight, and alternate loading and unloading are repeated between right and left cylinders at positions of upper and lower dead points of the air hydraulic cylinders. The power which is adjusted to be increased is added alternately on pistons of the right and left double rod cylinders of which upper chambers are the same in quantity of a hydraulic oil and lower chambers are the same in quantity of the hydraulic oil, then pressurizes the pistons to output an output power from the intermediate axes of right and left cranks which are coupled with and work with the reciprocating balance, and the output power is gradually balanced with an output of a flywheel ‘(8) which is placed near the power generator (11) and conditions revolutions of wind power and change of the output. In light winds, the gravity power generating unit (A) using balances and having the pressure load equipment is activated by an external electric power to be a starting motor for driving the wind turbines, while in strong winds, the gravity power generating unit (A) provides and transmits a combined electric power to a commercial electricity that is load, an external electric power is switched to an internal electric power, by a revolution output of the wind turbines, the double rod cylinders (3a) act as oil hydraulic pumps, the oil hydraulic pumps act as oil hydraulic motors, the motor (12) just provides an output for moving up and down the weight (10b) of the pressure load equipment, and the power of increased difference is input and combined in the commercial electricity, thereby combined electric power is provided. A low revolution multi polar vector control inverter permanent magnet synchronous generator (11) capable of corresponding wind power strength is used, a flywheel (8) is used as an auxiliary device for adding conditions of wind power and gravity, vertical axis power generator (1) is adapted for supporting weight by attraction and repulsion forces of an permanent magnet (7) and an electromagnet (6) in an under portion of the rotation shaft, control devices is provided. In the hybrid power generating system, the large-size horizontal axis variable-pitch propeller wind turbine, and a gravity power generating unit using balances and having pressure load equipment are coupled with one another to provide combined power generation both in light and strong winds. That is, according to the present invention, in the nacelle, only a gear box is disposed, strength of the tower is not different from an existing one, weight and inertial force of the flywheel is used for stabilization of the tower and adjustment of rotation, the hybrid power generating system is constructed with a horizontal wind turbine in which the blade subject to wind is automatically oriented downwind by a yaw mechanism of a downwind rotor.

According to the invention of claim 5, hybrid power generating system comprises one of vertical axis wind turbine power generators, an arcuate Darrieus wind turbine power generator and a straight blade wind turbine power generator, and a gravity power generating unit using balances and having pressure load equipment. The gravity power generating unit is coupled with the power generator. The vertical axis wind turbine power generator, the arcuate Darrieus wind turbine power generator or the straight blade wind turbine power generator is structured to have a variable pitch blade, a variable blade axis, and a forward reverse revolution axis. For right and left two blades or a plurality of blades, a central shaft, namely a tower portion is not provided, blade shafts (107) are provided to be entirely located on right and left upper portions, and a tower structural member (98) which is a semicircular frame member surrounding the blade shafts on three or four sides is fixed on the ground for supporting the blade shafts. An upper axis of a coupling structural member and an axis of a lower power generator are adapted for a main magnetic bearing portion, a plurality of, right and left upper blade shafts and lower blade shafts are entirely formed into one fit-in shaft (107), the fit-in shaft (107) is fitted in a main shaft, thereby a rotating shaft for whole blades is constructed. One center shaft (101) extending through between center of upper and lower main shafts and the plurality of the blade shafts (102) reinforced with a horizontal reinforcing plate (103) are provided, the horizontal reinforcing plate surface (103) and the blade plate surface are fixed, thereby a structure of the blade shaft (102) and the flexible center shaft (101) is constructed, in the fit-in shaft (107) in the bearing of the blade plate fixed on the horizontal reinforcing plate (103) and the upper and lower main shafts, an inserting hole (109) is formed for inserting each of a plurality of blade shafts (105) which may be variably controlled and braked, therein, and the blade plate (100) may be slid up and down in each bearing. Adjustment of expansion and contraction of the blade against bend, flexure and torsion of the blade, etc., in strong winds, and adjustment of pitch are possible, and upper and lower play portions (109a) are provided in bearing portions of the blade. Each shaft is rotated by oil hydraulic or electric motor gear (106), suppressed by being automatically tightened by a brake band, each shaft serves as a variable blade shaft rotating in right and left directions, thereby a structure of right and left blade surface lifting force blades is constructed. The blade may be subject to a wind power in a framing member tower (98) and rotated forwardly and reversely even in light winds by moving the blade surface so as to rotate forwardly and reversely, and adjusting the blade shaft to an optimum position. Each of the right and left blades (100) is reinforced by a horizontal reinforcing plate (103) at an arbitrary position such as a vertical center portion, and a rotation structure is constructed by receiving the right and left blades by upper and lower reinforcing shafts (102) which are designed slim and light-weight and a blade central axis (101). Alternately, when wind pressure is borne in upper and lower play portions in upper and lower shafts and material of the blade has sufficient strength, the shaft (102) and the horizontal reinforcing plate (103) are not required. The arcuate Darrieus wind turbine is structured in such a manner that when each blade shaft (105) rotates by around 90 degrees, each shaft moves to such position that all blade plates (100) are oriented in a direction of wind, thereby wind power is eluded in strong winds or typhoons blow. In the straight bladed wind turbine, semicircular frame members to be fixed on the ground are framed upright thereby forming a tower (98a) surrounding the blades on three or four sides or any number of sides, instead of providing a central tower as in the arcuate Darrieus blades. An entire blade rotating shaft (107) for the plurality of blade plate surfaces (100) and fixedly coupled horizontal plates (103b) is adapted for the fit-in shaft (107) which is fitted in the main shaft center magnetic bearing (97a). Each of the blade shafts may rotate forwardly and reversely by about 90 degrees. A low revolution permanent magnet synchronous power generator (11) is provide in a lower shaft (107), weight of the blade is reduced by floating action caused by repulsion, and increased by loading caused by attraction, by adjusting magnetic force of a permanent magnet (7) and an electromagnet (6) provided in the lower bearing portion, and self-rotation of the blade is achieved even in slight winds thanks to floating structure, by using an magnetic bearing (97a) and a bearing (97) simultaneously for the upper bearing. Fixing of the above frame structure member on the ground allows for installation of a wind turbine larger than the present straight blade Darrieus wind turbine on an installation area smaller than before, a size may be reduced by providing a plurality of blades, the shaft of a center axis of the tower which is reduced in diameter and weight defines an axis for receiving a horizontal reinforcing plate (103), the upper and lower shafts of each blade is adapted for a rotating gear axis (105), thereby the straight blade with turbine having blades without a tower is constructed. A torque converter automatic transmission (86) is provided on an axis of a permanent magnet synchronous power generator (11) or inductive power generator (11) of a vector control inverter multi polar low revolution structure, and an axis of an intermediate gear of a crank mechanism of reciprocating oil pressure transfer unit of the gravity power generating unit (A) using balances and having the pressure load equipment is coupled with an axis of the power generator. A power of oil pressure, air pressure, weight etc. added on the pressure load equipment on a leading end of the load balance (1) is increased according to a ratio of balances, the increased power is placed on a hydraulic oil which is filled and sealed in upper and lower chambers of the cylinder piston with the same volume, by activating right and left double rod cylinders (3a) of the reciprocating oil pressure transfer unit with use of two closed circuit variable displacement oil hydraulic piston pumps (25) of the same model, an output is increased by pressurizing pistons, and input into the power generator while balancing with a flywheel (8). A vector control inverter motor of a multiplex oil hydraulic pump (14) is actuated by switching between the external electric power and an electric power generated by wind power, the wind power generation and the power generation of the gravity power generating unit are combined, one of the vertical axis Darrieus wind turbine generator and the straight blade wind power generator is coupled with the gravity power generating unit using balances and having pressure load equipment, thereby the hybrid power generating system is constructed for the purpose of increasing power generation in high wind operation. That is, the present invention includes variable blades capable of forward and reverse rotation, and upper and lower play portions for preventing breakage of blades.

According to the invention of claim 6, a hybrid power generating system, comprises one of vertical axis wind turbine power generators, an arcuate Darrieus wind turbine power generator and a straight blade wind turbine power generator, and a gravity power generating unit using balances and having pressure load equipment. The gravity power generating unit is coupled with the power generator. A structural member is installed fixedly on the ground with the use of a tower frame member which surrounds the wind turbine on three or four sides, and vertical axis wind turbines. An arcuate Darrieus wind turbine or a straight bladed wind turbine having a plurality of blades rotating in one way is constructed in the structural member. In the wind turbine, stress such as a centrifugal force on a bearing portion caused by one-way rotation is a great burden, a force exerted on the blades, a bearing and a fixed base which are exposed to wind and rain for a long time period is divided into two by pitch control, to construct a wind turbine having an inner and an outer forward reverse rotation wind blades. In the wind turbine, the arbitrary number of inner blades and the arbitrary number of outer blades are provided, respectively. The distance of spacing between inner and outer blades is increased as much as possible, respectively, for eliminating difference in wind speed due to inner and outer blades. A flywheel (8) is provided for converting varied wind speeds to constant revolutions at intersection, a stress, a centrifugal force on upper and lower shafts are balanced each other for reducing a burden on the bearing, and are balanced with a power increased according to a ratio of balances. Two magnetic bearings (97a) on upper and lower portions of the tower serve to eliminate sound of winds by rotating two rotating shafts, an rotating shaft (107) for the inner blades, an entire rotating shaft (108) for outer blades forwardly and reversely. Forward reverse revolutions are switched and combined in one electric power generator (11) by a torque converter reverse rotation transmission (86a) of a lower axis. The outer blade (99) is not provided with a reinforcing plate, and each blade shaft (105) includes upper and lower plays (109a) for sliding (109) blade plates. For supporting weight of a plurality of the blades (99, 100) and the flywheel (8) and a floating force by wind power, repulsion and attractive forces of a permanent magnet (7) and an electromagnet (6), a magnetic bearing and a bearing are used concurrently to reduce frictional resistance. A structure without central tower is constructed, expansion and contraction of the blades and entire floating force by strong winds are absorbed in the upper and lower play portions (109a) of a shaft center, thereby the burden on the blades is reduced. Pitch is adjusted by clockwise and counterclockwise rotations of each blade shaft, the blade is rotated to a position for causing a blade lift force even in breeze, and thereby control is made allowing for power generation. A low revolution, multi polar, vector control inverter permanent magnet synchronous power generator (11) or an induction power generator (11) is directly-connected and used, and revolutions of axes of separate power generators are combined by a spiral bevel gear (94) of a torque converter transmission (86a). An intermediate gear shaft of the reciprocating oil pressure transfer unit of the gravity power generating unit (A) using the balance and having the pressure load equipment is coupled with the power generator via a torque converter automatic transmission (86). A power of oil pressure, air pressure, weight etc. added on the pressure load equipment on a leading end of the load balance (1) is increased according to a ratio of balances, the increased power is placed on a hydraulic oil which is filled and sealed in upper and lower chambers of the cylinder piston with the same volume, by activating right and left double rod cylinders (3a) of the reciprocating oil pressure transfer unit with use of two closed circuit variable displacement oil hydraulic piston pumps (25) of the same model, an output is increased by increasing oil pressure by pressurizing pistons, and input into the power generator while balancing with the flywheel (8). A vector control inverter motor (12) of a multiplex oil hydraulic pump (14) is actuated by switching between an external electric power and an electric power generated by wind power, the power generated by wind and the power generated by the gravity power generating unit are combined, it serves as an auxiliary motor (12) activated by an external electric power for start up of rotation of the blades in light winds. When power is generated by wind in fair winds, the electric power is switched from an external commercial electric power to an internal wind power generated power and then used, and inner and outer forward reverse rotation blades are combined. The vertical axis Darrieus wind turbine generator or the straight blade wind power generator is coupled with the gravity power generating unit using balances and having pressure load equipment, thereby the hybrid power generating system is constructed. That is, according to the present invention, a plurality of inner and outer blades rotate in forward and reverse directions, respectively, wherein a generated power is remarkably increased, thereby a stress on the bearing portion of the tower and the like may be decreased, and the vertical axis wind turbine may generate an electric power depending on the number of the blades, compared to the existing horizontal axis wind turbine.

According to the invention of claim 7, a hybrid power generating system comprises a gravity power generating unit (A) using balances and having pressure load equipment, adapted for inputting generated power in solar generated power of a large size solar power generating station. The gravity power generating unit is adapted for increasing a power according to a ratio of two step, upper and lower balances, and for inputting the increased power in the solar power generation of the large size solar power generating station. In solar power generation, a power is generated in proportion to daylight hours and the number of the solar panels (110), the generated power is connected to a commercial power supply (111a) and is stored in a power storage system (112) by means of inverter control, and since the daylight hours are limited, and solar power generation is required to increase production of power within the limited hours. A multiplex oil hydraulic pump (14) used for the pressure load equipment and a reciprocating oil pressure transfer unit is activated by a motor (12) which is driven by an external electric power. For the pressure load equipment provided on a leading end portion of a lower load balance (1) extending to the right and left, a water pressure cylinder by obtaining a water pressure from a high place, a steam pressure cylinder in a place where steam pressure is available, an oil hydraulic cylinder (9c) of an oil hydraulic unit (79), a pneumatic cylinder (9d), or an object which supports weight of the weights (10b) on right and left leading end portions of the load balance (1) by the air hydraulic cylinder (9c) may be used. Any one of them repeats loading and unloading alternately on the right and the left of the balance. A power is increased by the pressure load equipment according to the ratio of balances, and the increased power is transferred to right and left double rod oil hydraulic cylinders (3a) which are connected and linked to an upper reciprocating balance (2) at a fulcrum position. For the multiplex oil hydraulic pump (14) a vector control inverter motor driven by the external electric power is used. The double rod oil hydraulic pump (3a) is driven by two closed circuit variable displacement piston pumps of the same model which are provided between the upper chambers, and between the lower chambers, respectively. An alternate output of the water pressure, the steam pressure, the oil pressure or the air pressure from one small size closed circuit variable displacement oil hydraulic piston pump (27) provided between the pressure load equipments, or an alternate output into right and left rod chambers of the air hydraulic cylinders is constant. An air pressure is filled in the head chamber of the air hydraulic cylinder, to be balanced with weight of a weight (10b), or a pressure is injected and discharged in a head chamber of the water pressure, the steam pressure, or the pneumatic cylinder, and injected alternately right and left oil hydraulic rod chambers. With assistance of attraction and repulsion forces of the permanent magnet (7) and the electromagnet (6) of the weight on the ground or the load balance, loading and unloading is switched repeatedly, alternately on the right and left cylinders at a position of upper and lower dead points of the crank. A power increased by loading is placed alternately on pistons of right and left double rod cylinders (3a) in which volume of oil is the same between the upper chambers, and between the lower chambers, thereby pushing the pistons. With refill of hydraulic oil by an auxiliary pump (26) an output of the power generator (11) is gradually increased via intermediate axes of right and left cranks which are coupled and associated with the reciprocating balance, and the output of the power generator is combined with the solar generated power by a power conditioner (53). In hours without sunshine, such as nighttime and rainy day, the gravity power generating unit (A) using the balances and having the pressure load equipment is driven by a vector control inverter motor (12) which is activated by an external electric power, and functions as a solo gravity power generating unit or as a power generation unit constructed by combining the gravity power generating unit (A) and a wind turbine power generator, a power from each pressure load equipment is increased according to the ratio of balances and input in the gravity power generating unit (A). In strong winds, a combined electric power is transmitted to the commercial electric power which is a load. In a place where a water pressure from a high place is available, the water pressure cylinder is employed for each cylinder of the pressure load equipment, the reciprocating oil pressure transfer unit. In a place where a steam pressure is available from a boiler and a geothermal heat, the steam pressure cylinder is employed for each cylinder of the pressure load equipment, the reciprocating oil pressure transfer unit, alternately, an oil hydraulic (9c), a pneumatic cylinder (9d), a weight and air hydraulic cylinder (93) is used for the pressure load equipment. In a combined power generating station, a power is generated mainly by solar power generation in unpredictable sunshine hours in daytime, and the power is combined by connecting the power conditioner (53) of the solar power generation to unpredictable wind power generation. A low revolution multi polar vector control inverter permanent magnet synchronous generator (11) capable of corresponding wind power strength is used. During either of solar power generation or wind power generation, an external electric power is switched to an internal electric power. By a revolution output of the wind turbine power generation, the double rod cylinders (3a) act as oil hydraulic pumps, the oil hydraulic pumps act as oil hydraulic motors, an output of the motor (12) is applied just as an output for moving up and down the weight (10b) of the pressure load equipment, and the power of increased difference is input in the commercial electricity, thereby combined electric power is provided. In the hybrid power generating system, a generated power of a wind power generation or a separate gravity power generating unit (A), and a solar generated power are combined by the power conditioner (53). Each control device is provided for increasing output, and the gravity power generating unit using the balance and having the pressure load equipment is coupled. According to the present invention, since the solar power generating system may not generate an electric power in a rainy day and nighttime, an electric power is generated sufficiently in a sunny day and daytime, and used as a power for loading of the gravity power generating unit.

According to the invention of claim 8, a hybrid power generating system, comprises an oil, a liquefaction gas, a coal, an iron ore, a container carrier, a large special service ship, a self-navigation work vessel, a vessel, a submarine having a motor (12) propeller shaft connected to a diesel engine (113) and a power generator, a steam turbine propeller shaft of a gas turbine engine (114) or a nuclear power and a power generator, and a gravity power generating unit using balances and having pressure load equipment. A large size diesel engine is of low or middle revolution, a flywheel (8) is provided on a front part of the engine, and a gas turbine (78b), a nuclear power steam turbine (78) are of high revolution. The propeller shaft is coupled with an intermediate gear shaft of a crank gear of a reciprocating oil pressure transfer unit of the gravity power generating unit (A) using the balance and having the pressure load equipment, via a reduction gear device and a torque converter automatic transmission (86). In head chambers of right and left large size double acting single rod water pressure cylinders (9a) of the pressure load equipment, a high water pressure is taken through a water pipe (4) from a bow of the ship with the use of own ship speed. When a double acting single rod steam pressure cylinder (9b) is used, each of a boiler steam pressure (77) by cooling of a gas turbine (78b) and a boiler steam pressure of a nuclear power is injected in a head chamber of a cylinder via a pressure/flow rate control electric valve (92), thereby a pressure on a leading end of the rod is obtained, injection quantity of the steam pressure is very small so as to cause a slight stroke. The pressure is placed on a right and left of the load balance so as to be applied thereon constantly. Water is discharged while steam is circulated. A high water pressure pump (4b) to be activated by a motor (12) is provided in a pressure water pipe, thereby water flow of the self-navigation vessel is made at high pressure. For the reciprocating cylinder, a double rod oil hydraulic cylinder (3a), a double acting double rod water pressure cylinder, or double acting single rod water pressure cylinder (3b) is used. Oil pressure is applied in a rod chamber of the double rod cylinder. Used is the double rod cylinder in which oil pressure is applied in a rod chamber and water pressure is applied the other rod chamber, while used is the double acting single rod cylinder in which the water pressure is applied in the head chamber, and the oil pressure is applied in the rod chamber. The stroke is associated with a crank (15), and operating directions of the pistons are switched alternately between the right and the left cylinders by a switch (34) at upper and lower dead points. In a vessel without using water pressure force, the double acting single rod oil hydraulic cylinder (9c) of which activation is controlled by the oil hydraulic pump, or the double acting single rod pneumatic pump (9d) which is pressurized by the air pressure compressor and pressurized air pump is used. The structure of connecting the above directly to the engine is employed, and the generator or a motor propeller shaft of the motor propeller shaft ship is coupled via a torque converter automatic transmission. Power is generated at an arbitrary place where the water flow or the steam pressure is introduced, and the power is transmitted. Control is carried out by each control device provided in the pressure load equipment of the gravity power generating unit (A) using the balances and having the gravity power generating unit. In the case of a ship on cruise for a long period of time, water flow caused by the ship according to the cruising speed provides a loading output, a fuel cost is saved by using the steam pressure to increase cruising speed, and the gravity power generating unit using the balances and having the pressure load equipment is coupled. According to the present invention, space is defined in front of an engine, etc, in an engine room of a ship, and a steam pressure, an oil pressure and an air pressure may be used cyclically in the ship. Such space may be provided in other places in a motor propelled boat.

According to the invention of claim 9, a hybrid power generating system, comprises a train such as local train and limited express train, and a gravity power generating unit using balances and having pressure load equipment. An electric power which is used for operation of the number of train services for the entire distance of railway routes including uphills and downhills is transmitted to trains (118) by a plurality of substations using direct current or alternating current via overhead cables. An electric power consumption becomes to a maximum from when a train starts till when the train runs at a nominal velocity, will be decreased when the train operates with inertia driving force, and when a regenerative brake is used for deceleration, an electric power is returned via overhead cables in direct current and alternate current trains. The electric power more than required for total number of train services is transmitted, for safety purpose. To reuse properly the regenerated electric power which otherwise should have been discarded, the gravity power generating unit (A) using balances and having the pressure load equipment is installed at each substation. Two closed circuit variable displacement piston pumps (25) of the multiplex oil hydraulic pump (14) of a reciprocating oil pressure transfer unit and one closed circuit variable displacement piston pump (27) are driven by a motor (12) activated by the regenerative brake. The closed circuit variable displacement piston pumps (25) are provided between upper chambers and between lower chambers of the double rod cylinders (3a), respectively. The closed circuit variable displacement piston pump is provided between rod chambers of the pressure load equipment using oil pressure, air pressure, a weight, or water pressure from a rain reservoir, etc. of a building at a high place or between rod chambers of right and left air hydraulic cylinders (9e) using a weight, and oil pressure force is controlled by the closed circuit variable displacement piston pump (27). A single acting air cylinder (5) is adapted for input of power which is gradually increased by right and left alternate loading according to a ratio of the balances, output by discharge of the single acting air cylinder (5) and by two closed circuit variable displacement piston pump (25) is transmitted to a commercial electric power, as generated power of a generator (11) of a vector control inverter, from a rotation sensor of a power generator or the like via a controller (53). Alternately, a power generated by an increased power by the motor (12) activated by a surplus electric power is fed, thereby regenerated power at a substation of a train is used efficiently. That is, according to the present invention, regenerated power and external power are combined, and an output is increased by the gravity power generating unit, the power is transmitted again, and thereby contracted electricity is reduced.

According to the invention of claim 10, a hybrid power generating system, to be coupled with the gravity power generating unit using the balance and having the pressure load equipment as set forth in claim 9 is improved In a high-speed underground electric railroad service in land over a public land and a private land such as a town area, under bottom of the sea, or the like, a train runs on a single track straight railway of standard gauge or wider gauge connecting stations to one another, provided in a deep underground small diameter tunnel (126b). A plurality of platforms (126b) are provided per station in a starting station, a terminal station, and a plurality of intermediate stations which are provided on the ground, between adjacent stations, provided are an uphill zone and a downhill zone (124) which have the same inclination relative to a platform and the same distance, and a level zone which also has the same depth and distance. A part of the plurality of the platforms is adapted for the platforms for access to street cars on the ground or for access to route buses. The train service is based on a shuttle service on a single track between stations, therefore, when a route is completed between two stations, it may be adapted for commercial railway. For a train, a low-floor train (118a) driven by an alternate current high output rotating vector control inverter VVVF induction motor having each control device is used, allowing for acceleration up to 400 km/h along the downhill zone (for employing in smaller diameter tunnels, a magnetically elevated low-floor linear motor train is used), the train is accelerated to a maximum speed along the downhill zone, for braking a potential energy on the zone, and a regenerative brake is used. A regenerated power is returned to substation facilities (111) installed on the plurality of the stations, input as a driving power of a vector control inverter motor (12) of a multiplex oil hydraulic pump (14) of the gravity power generating unit (A) using the balance and having the pressure load equipment. The gravity power generating unit (A) using the balances and having the pressure load equipment has each control device and is driven at a low voltage. The multiplex oil hydraulic pump (14) organizes main pumps (25, 27) for each cylinder of the reciprocating oil pressure transfer unit and the pressure load equipment, and auxiliary pumps (26, 28) for flushing and increasing oil pressure into one unit. The pressure load equipment is activated by a closed circuit oil hydraulic piston pump (27). The pressure load equipment is an air hydraulic cylinder (9e) which are disposed under the right and left portions of the load balance (1) for applying a load of a weight (10b) alternately on the right and left of the load balance, or an apparatus for applying the load by a pressure force from any of an oil hydraulic unit, pneumatic cylinder, a water pressure cylinder using a water pressure from the high place, along with attraction and repulsion forces of a permanent magnet (7) and an electromagnet (6). By a reciprocating oil pressure transfer unit, right and left double rod cylinders (3a) located with a fulcrum of the load balance (1) therebetween are linked and connected to one another with the use of the reciprocating balance (2), in bilaterally symmetrical relation, a power increased according to a ratio of length between the reciprocating balance and the load balance is transmitted to the double rod cylinders (3a), one and the other upper chambers, and one and the other lower chambers are communicated by two closed circuit variable displacement oil hydraulic piston pumps (25) for producing a reciprocating drive force. Single acting air cylinders (5) which support the right and left portions of the load balance and gradually input a power thereto are installed on the ground. A power which is increased by discharge of the single acting air cylinder (5) is gradually input in the reciprocating oil pressure transfer unit. At the same time, from the auxiliary pump (26) an angle is changed so as to correspond to the increased power, a rotation output is increased, a flywheel (8) is provided in an intermediate gear shaft engaging with right and left crank gears of the speed increasing gear box (13) of a crank mechanism which is associated with the double rod cylinders (3a) coupled with the reciprocating balance (2), and the power is input from the intermediate gear shaft in the vector control inverter generator (11) and output therefrom. An electric power is generated corresponding to an electric power to be consumed by a plurality trains, is transformed to alternate current electricity at high voltage and fed to overhead wires, or transmitted to a commercial electric power. The train runs on a level zone, an uphill zone to a platform and arrives at the platform on the ground, using a power regenerated during run on a downhill zone and a power generated by the gravity power generating unit (A). Most of an amount of electric power for a plurality of single-track trains is supplied from the gravity power generating unit (A) using the balances and having the pressure load equipment, each of the single-track train departs from a station at 3 to 4 minute intervals. In the train service, a plurality of platforms (126) at each station are used, trains operate on a single track in such a manner that a train departs from a starting station (123a), arrives at a next station (123b), another train waiting at the next station (123b) departs immediately for the starting station (123a), the train stopping at the next station (123b) immediately departs for an intermediate station (123c), and after the train arrives at the intermediate station (123c), yet another train waiting at the intermediate station (123c) departs for the next station (123b). A train service comprises a train service stopping at every station between the starting station to the terminal station and a simple shuttle train service between stations. In the train service, a train departs from the starting station (123a) to the terminal station, at the same time a different train departs from the terminal station for the starting station, a person who gets on at the starting station (123a) and gets off at the terminal station and a person who gets on the terminal station directing the starting station do not change trains, although trains stop at every station, a person who gets on at any of intermediate stations may always get on a train waiting at the station or may await and get on either of the train directing the starting station and the train directing the terminal station, and a waiting time corresponds to a driving time between the stations. In regard to boarding and exiting of passengers, seats are eliminated, and instead, handrail stands (137) are provided on a floor, for smooth flow of passengers. A passenger step (130, 130a) is provided, the passenger step automatically operates with opening and closing of a door, thereby a gap and a level difference between the train and the platform are eliminated, allowing a passenger such as a passenger in a wheel chair, or a passenger with a baby buggy to get on and off swiftly and without inconvenience and to afford to spend time for getting on and off from arrival to departure of the train. For a single track train service, safety equipment is arranged on rails (126a) alongside of a platform at a train-stop-station, and the safety equipment has a mechanism for allowing only one train in a tunnel between the stations. In the high-speed underground electric railroad service, a section is connected between aboveground stations via a small-diameter deep underground tunnel (126b), each section includes a downhill zone, a level zone, and an uphill zone of generally the same distance, the section is of a straight railway with a single track of broad gauge, most of an electric power required for driving a plurality of low-floor trains (118a) driven by an alternate current high-output rotary induction motor may be provided by a plurality of the gravity power generating units (A) using the balances and having the pressure load equipments which effectively use an electric power regenerated in operation on the downhill zone. That is, in the high-speed underground electric railway of the present invention, a public land in a city area is used. For a high-speed train service, stations on the ground are connected by a straight track, single-track, deep underground shield tunnels of small diameter are employed, therefore, the undergrounds of private lands are necessarily used. Each section between adjacent stations comprises the same uphill and downhill zones and the same level zone. A regenerated power is input in the gravity power generating unit using the balances and having the pressure load equipment capable of efficient use, then increased power is fed to overhead wires. Safety equipment is provided to primarily operate in case of tight transport schedule.

According to the invention of claim 11, a hybrid power generating system for coupling a gravity power generating unit using balances and having pressure load equipment, and a high-speed underground electric railroad service in land over a public land and a private land such as a town area, under bottom of the sea, or the like, as set forth in claim 10 are improved. A plurality of platforms (126) are provided at each station of the starting station, the terminal station and a plurality of the intermediate stations, a deep underground single track tunnel is provided in each section between the stations, each of the deep underground single track tunnels has a structure of the same distance, the same downhill and uphill zones, a level zone of the same distance and depth, and the deep underground single track tunnel may be a small-diameter shielded tunnel. The magnetically elevated low-floor linear motor (118b) is a small-size high speed onboard primary member type magnetically elevated linear motor train (118b), and a low-floor train (118a) which can operate stably at high-speed. Alternately, a shielded tunnel of large size is provided, and the shielded tunnel is divided into upper and lower parts for operation on a double track. In the magnetically elevated low-floor linear motor train (118c), an air conditioner and a control device to be disposed in a ceiling of a compartment is disposed under seats (119b) provided on a side wall adjoined to a floor, thereby a vertical width is decreased compared to the aforementioned magnetically elevated low-floor linear motor train (118b). Concrete segments (127) of the tunnel are partly replaced with steel segments (127a), and a thin steel structural member (127b) which is provided integrally with a magnetically elevated structural member (127c) is adhered and fixed onto the steel segments (127a) of a center potion of the tunnel, thereby the tunnel is divided and blocked. A pressure plate (120) has a structure of applying wind pressure to restrain shaking of a body of the train running at high speed which is caused by distorted structure of an inside of a double track tunnel having upper and lower tracks, the pressure plates are provided on the steel structural members supporting the segments and the steel structural members (127b), spaced at arbitrary regular interval, the pressure plates are provided also on a roof of the train, thereby constructing a structure for maintaining constant airflow relative to top, and right and left sides of the body of the train to restrain shaking of the body of the train. A service of the magnetically elevated low-floor linear motor train (118c) uses an aboveground station having two-storied, upper and lower platforms. The magnetically elevated linear motor trains (118b, 118c) operating on a single and double tracks are accelerated to the maximum speed on the downhill zone, and a regenerated power by a regenerative brake used in the zone is input in the vector control inverter motor (12) of the multiplex oil hydraulic pump (14) of the gravity power generating unit using the balance and having the pressure load equipment, via each control device of a substation facility (111), as a driving electric power. A generated power of the vector control inverter power generator (11) is transformed again to an alternate current high voltage and fed to overhead cables or transformed to a commercial electric power, by a structure similar to a low-floor rotating motor train (118a). The magnetically elevated low-floor linear motor train (118b, 118c) is driven by using an alternating current high-output vector control inverter VVVF induction linear motor. When each distance between stations is longer and higher speed is required, a superconductive elevated linear motor train is employed. The high-speed underground electric railroad service comprises the small diameter deep underground tunnels. That is, the linear motor train service according to the present invention does not require mutual exchange with other railway companies. The linear motor driven train may be sized smaller than a rotary motor driven train. Magnetic elevation or a specification of wheels is selected in an arbitrary manner. The magnetically elevated linear motor train which may be small-sized may be applied for double track which is constructed by dividing the shield tunnel into upper and lower parts. This is a merit of the magnetically elevated linear motor train. The superconductive elevated linear motor train may be employed for transportation on a section of 10 km or more between stations, specifically for transportation between airports, etc. which requires ultra high speed.

According to the invention of claim 12, a high-speed underground railway service, as set forth in claim 10 is improved. A passenger step used by passengers is adapted for facilitating swift, safe and sure boarding and alighting, An internally threaded portion is formed in a lower portion of a housing portion of a sliding door (131), side portions of the step (130) on right and left portions contacting with a floor of a body of a train is adapted for bearings (133b), right and left externally threaded shafts are fitted in the internally threaded portions, then the shafts are connected to right and left portions of the step (130), the internally threaded portion (133) rotates the externally threaded shaft (132) about an axis along with opening and closing of the door, thereby the step of a proper width contacts a floor of a platform, the step is provided with a play as counter measure against shaking of the train, and the passenger step has a simple and sure mechanical structure for being stored in front of the door and extended to contact with the floor of the platform repeatedly. Alternately, in a train having cars which are configured so as to define generally constant gap and level difference relative to a platform along an entire length of the train cars, provided is a mechanism which is actuated by using an electric, pneumatic apparatus for extending the passenger step (130a) from an underside of a floor adjacent to a door and retracting the passenger step (130a) therein, cooperating with opening and closing of the door. Two types of step equipment (130, 130a) comprise a metallic portion and an elastic material such as rubber or plastic for eliminating the gap (134) and the level difference between the platform (129) and the floor adjacent to the passenger door. The passenger step is non-slip, and has proper width and thickness, thereby the passenger step is structured so as to allow passengers with a large carry-bag or a baby baggie, a passenger in wheelchair, or a handicapped passenger for getting on and off the train surely and safely. The passenger step may be applied for the linear motor train, an aboveground street car or a route bus. The high-speed underground railroad service is provided with the passenger step (130, 130a) for allowing reduction in boarding and alighting time surely and safely in a high-speed train operation. That is, in an existing railway service, a station staff brings and sets a step for wheelchair passengers as wheelchair passengers board and alight the train. The boarding and alighting time depends on the number of passengers. The travelling time consists not only the train's driving speed. The passenger step of the present invention facilitates smooth boarding and alighting of the passengers, thereby the boarding and alighting time is reduced.

According to the invention of claim 13, a high-speed underground railroad service, as set forth in claim 10 is improved. Handrail stands are provided for facilitating smooth flow of passengers getting on and off a train which stops at a station. Since the train departs from a station at 3 to 4 minute intervals and operates through tunnels in a short time period, no window is required. In a low-floor rotary motor train (7), a portion such as a floor which covers wheels is used for the required number of seats (119, 119a) for the handicapped, in a magnetically elevated low-floor linear motor train, each air conditioner, control device or the like to be disposed in a ceiling is positioned under seats on a side wall which contacts with the floor, a rest of the floor is not provided with seats, instead, hand straps or the like are provided, and hand rails on right and left side walls (137b) (hand rest) are provided, and two rows of the handrail stands (137) are provided on a center portion of the floor, in parallel relation to the side walls, or on the floor in parallel relation to the side walls. The proper number of the handrail stands (137) having proper length roughly at waist height are provided at positions except for those near passenger doors (131, 131 a), or a portion of a floor which does not disturb passengers from boarding or alighting, the handrail stands (137a) in place of seats are provided perpendicular to the direction of travel. Since the handrail stands (137a) are roughly waist-high, a passenger is allowed to lean his body on the handrail stand, while holding the strap with his hand, thereby the passenger may be prepared for acceleration during travelling at high-speed, the high-speed underground electric railroad service which are provided with the handrail stands by eliminating seats for facilitating smooth flow of passengers boarding and alighting may be applied to a commuting train, vehicle for the handicapped, or route bus. That is, in an existing double track train service, seats are required, but in a crowded train, even space for the seats appears bothersome. When the seats are eliminated in the train having windows, the windows become a nuisance. In a compartment where windows are eliminated, passengers lean on walls, a wide space is left on a floor, then handrail stands are required on a center portion of the floor, accordingly, the handrail stands (19) are provided in one or two rows in the compartment. The handrail stands have a length suitable for smooth flow of passengers.

### Effects of the Invention

In a hybrid power generating system of the present invention, proper pressure (potential energy) of existing power generations by water, thermal, wind, solar and water flow is applied a gravity power generating unit using balances and having pressure load equipment. Or, it is installed in a train, a factor, etc., and regenerated power or surplus electric power is applied to increase power generation. When a pressure (water pressure, steam pressure, water-flow, weight, etc.) and an apparatus or equipment for taking in the pressure are available, the pressure, whether a fluid or a solid substance, can be applied to the equipment The power is increased according to a ratio of balances, the increased power is taken in an energy and balanced with load, then converted to output, thereby efficiency of engines and turbines is increased. The present invention provides such equipment. The power generating system of the present invention capable of power generation by using slight amount of water. When this system is applied for a rainwater dam of natural restoration, agriculture and fishery may be encouraged in a downstream area. A regenerated electric power may be employed in the gravity power generating system. The railway service of the present invention comprises deep underground tunnels in a space under a city area of which land cost is high, a straight track, a rail gauge of an arbitrary width, single track, uphill, downhill and level zones of the same distance, and the same platforms on stations on the grounds, a high-speed low-floor rotary motor train or linear motor train is selected and the above ground stations are provided on a public land, or the like. In the single track, high-speed underground electric railway, cost is reduced by saving land cost, and employing small-sized tunnels and small-sized trains The effects of power generation may provide a following light-weight low-floor magnetically elevated linear motor train. A deep underground shield circular tunnel of diameter of 8.0 m may be divided into upper and lower parts, thereby a double track rail service may be provided. In this double track railway, a diameter of the tunnel may be saved compared to side-by-side double track. And, upper and lower lines are blocked from one another, trains do not pass each other, and this allows for more trains into service.

### BRIEF DESCRIPTION OF THE DRAWINGS

FIG. 1a is a schematic sectional view of a center position of the present invention where a gravity power generating unit using balances and having pressure load equipment is coupled with a power generator of a large-size hydroelectric power station. (Example 1)

FIG. 1b is a plane view of the above. (Example 1)

FIG. 1c is a schematic sectional view of a center position when the gravity power generating unit using balances and having pressure load equipment is coupled with a power generator of a small-size small-scale hydroelectric power station. (Example 2)

FIG. 2 a is a schematic view of a side section of a center position of the present invention where the gravity power generating unit using balances and having the pressure load equipment is coupled with a power generator of a thermal power station or a nuclear power station. (Example 3)

FIG. 2b is a plane view of the above. (Example 3)

FIG. 2c is a schematic view of a side section of a center position when the gravity power generating unit using balances and having pressure load equipment is coupled with a power generator of a geothermal power station. (Example 3)

FIG. 3a is a schematic sectional view of a center position of the present invention where a gravity power generating unit using balances and having pressure load equipment is coupled with a horizontal axis variable-pitch propeller blade wind. power generator. (Example 4)

FIG. 3b is a schematic circuit diagram when a permanent magnet synchronous power generator is used for the above. (Example 4)

FIG. 4a is a schematic view of a front section of a center position of the present invention where a gravity power generating unit using balances and having pressure load equipment is coupled with an arcuate Darrieus wind power generator. (Example 5)

FIG. 4b is a schematic view of a center axis portion of an upper part of a tower, seen from the ground. (Example 5)

FIG. 4c is a schematic plane view of the center axis portion of the upper part of the tower and a blade shaft at a center bearing portion of the power generator. (Example 5)

FIG. 4d is a schematic view of a side section of a center position where two balances which are used in the gravity power generating unit having the pressure load equipment are connected to one another.

FIG. 5a is a schematic view of a front section of a center position of the present invention where a gravity power generating unit using balances and having pressure load equipment is coupled with a straight blade wind power generator. (Example 6)

FIG. 5b is a schematic plane view of the center axis portion of the upper part of the tower and the blade shaft at the center bearing portion of the power generator. (Example 6)

FIG. 5c is a detail view showing that; arcuate, straight blade shafts are coupled with a power generator, a reverse rotation gear is incorporated in a torque converter, .inner and outer blade rotating shafts are rotated in a reverse direction by variable pitch of blades, but rotated in one direction in the power generator, a rotation output is generated by a power increased by a spiral bevel gear (a bevel gear) of a center shaft and weight (oil pressure, air pressure) of the gravity power generating unit using the balances, and the output is connected to a power generator by a toque converter automatic transmission to be combined, thereby an output is produced in the power generator. (Example 6)

FIG. B is an enlarged view of an insertion hole into which upper and lower portions of a straight blade plate are inserted for dispersing stress such as bend, flexure and torsion of the blade upward and downward, adjusting pitch and being fixed.

FIG. C is a view with respect to an arcuate blade plate, a blade shaft is provided with a sliding slot which is adapted for dispersing stress such as bend, flexure and torsion of the blade upward and downward, adjusting pitch and being fixed, an enlarged view of such an insertion hole.

FIG. 6a is a schematic view of the present invention where a power conditioner of a solar power generator is coupled and combined with generated power of the gravity power generating unit using balances and having pressure load equipment. (Example 7)

FIG. 6b is a schematic view showing that wind-generated power of the power conditioner of the solar power generation is coupled and combined with the generated power of the gravity power generating unit using balances and having pressure load equipment. (Example 7)

FIG. 7a is a schematic view showing that a gravity power generating unit using balances and having pressure load equipment which is subject to water flow of speed of a large ship or the like is coupled with an engine or motor thereof (Example 8)

FIG. 7b is a schematic view showing that the gravity power generating unit using balances and having a torque convertor automatic transmission and pressure load equipment is coupled with a diesel engine. (Example 8)

FIG. 7c is a schematic view of the gravity power generating unit using balance and having the torque convertor automatic transmission and the pressure load equipment is coupled with a gas turbine engine, and in the pressure load equipment a saturated steam pressure which is recycled from a nuclear powered ship or a submarine may be used for a cylinder. (Example 8)

FIG. 7d is a schematic view showing that the gravity power generating unit using balances and having pressure load equipment is coupled with a motor shaft of a motor powered ship which is powered by a diesel, gas turbine, and the pressure load equipment uses properly water-flow, steam pressure, oil hydraulic, or pneumatic cylinder. (Example 8)

FIG. 8a is a simple schematic view showing that with regard to regenerated electric power which may be discarded, in a feeding circuit in a train service, an output is increased by increasing power of weight, oil pressure, pneumatic pressure or water pressure of a building and the like of a gravity power generating unit using balances and having pressure load equipment according to a ratio of balances, and the power is fed again to a commercial electric power or overhead cables. (Example 9)

FIG. 8b is a schematic view of each deep underground tunnel extending from an aboveground platform down to right and left undergrounds, a schematic view of a reduced entire structure where each distance depth between the stations are the same. (Examples 10, 11)

FIG. 8c is a front sectional view of a route from an aboveground station down through an underground tunnel. (Examples 10, 11)

FIG. 8d is a plane sectional view of routes from a plurality of platforms of the aboveground station down through the tunnels. (Examples 10, 11)

FIG. 8e is a schematic view of a front section of magnetically elevated linear motor trains stopping at upper and lower platforms of an aboveground station on a section down through an underground tunnel. (Example 11)

FIG. 8f is a sectional view of a low-floor rotation induction motor train in a small diameter deep underground shielded tunnel. (Example 10)

FIG. 8g is a sectional view of the magnetically elevated linear motor train in the small diameter deep underground shielded tunnel. (Example 11)

FIG. 8h is a sectional view of the low-floor magnetically elevated linear motor trains running in an upper and lower double track tunnel which is constructed dividing the deep underground shield tunnel into upper and lower parts. (Example 11)

FIG. 9a is a schematic view of a platform and a passenger step operating with opening and closing of a passenger door, a train stops at the platform, the door is double sliding type, and the step is extended down to the platform. (Example 12)

FIG. 9b is a schematic view of a single sliding door of an express train stopping at a platform and a step is extended down to the platform. (Example 12)

FIG. 9c is a detailed plan view showing the step of the slide door extended down, and a bearing portion including internally and externally threaded portions of a housing portion for slidingly storing the door. (Example 12)

FIG. 9d is a schematic view showing that a step is slidingly extended down to a floor of the platform from a floor under the double sliding door of a train by a pneumatic cylinder. (Example 12)

FIG. 9e is a detail view of an externally threaded shaft (132) which is loosely fitted in an internally threaded screw (133) of the double sliding door. (Example 12)

FIG. 10a is a schematic construction view showing that handrail stands (137) are provided on a passenger car floor instead of seats, handrails (137b) on a sidewall in the passenger car, a part of handrail stands (137a) opposed to an acceleration direction, and handrail stands (137) on the floor. (Example 13)

FIG. 10b is a schematic view of the handrail stands (137), handrails (19b) on a sidewall from which windows are eliminated, and hand straps in the passenger car, viewed from the direction of travel. (Example 13)

FIG. 10c is a schematic view of the handrail stands (137a) provided in a front and rear portions or the like of the car, and the hand straps in the passenger car, viewed from the direction of travel. (Example 13)

FIG. 10d is a schematic view showing that two axis wheels without a drive motor are covered to provide a position for seats for handicapped persons or the like. (Example 13)

FIG. 10e is a schematic view showing that three axis wheels with a drive motor are covered to provide a position for seats for handicapped persons or the like. (Example 13)

[FIG. 11] A schematic view of a position for installing a double rod cylinder which is pressure load equipment in a center portion of the gravity power generating unit using balances and a crank mechanism.

FIG. 11a is a schematic sectional view of a gearbox (13) and a bearing base (19) of the crank mechanism, viewed from the side.

FIG. 11b is a perspective sectional view of the crank mechanism, viewed from the front.

FIG. 11c is a perspective sectional view of the gear box (13) of the crank mechanism, viewed from the plane.

FIG. 11d is a detailed sectional view of a double rod cylinder (3a).

FIG. 11e is a schematic sectional view showing the double rod cylinder, the bearing base (19) and bearing mounting (22) of upper and lower balances, viewed from the front.

FIG. 11f is a schematic sectional view showing the double rod cylinder (3a), the bearing base (19) and bearing mounting (22) of a pressure (weight load balance 1), viewed from the plane.

FIG. 11g is a schematic sectional view showing the double rod cylinder (3a), the bearing base (19) and bearing mounting (22) of the pressure (weight load balance 1), viewed from the side.

FIG. 11h is a schematic sectional view showing a fulcrum portion, the bearing base (19) and bearing mounting (22) of the weight load balance (1), viewed from the side.

FIG. 12a is a schematic sectional view of the gearbox (13) and the bearing base (19) of the crank mechanism, viewed from the side.

FIG. 12b is a schematic sectional view showing that double acting single rod water pressure cylinder (3b) which is activated by oil pressure and water pressure is applied to a reciprocating transfer unit, viewed from the side of a communicating piping.

FIG. 12c is a schematic sectional view showing that the double acting single rod water pressure cylinder (3b) which is activated by water pressure to upper and lower chambers is applied to the reciprocating transfer unit, viewed from the side. (Example 1)

FIG. 12d is a schematic sectional view showing that a double acting single rod steam pressure cylinder (3c)which is activated by steam pressure to upper and lower chambers is applied to the reciprocating transfer unit, viewed from the side. (Example 3)

FIG. 12e is a schematic sectional view of an arrangement of a weight load balance, a reciprocating balance, double rod cylinders (3a), a crank rod (15), a gearbox (13), a multiplex oil hydraulic pump (14), an electric motor (12) and a power generator (11), viewed from the side. (Examples 1, 2, 3, 4, 5, 6, 7, 8, 9, 10, 11)

FIG. 12f is a schematic sectional view of a position for mounting the weight load balance, the bearing base (19) of the fulcrum portion and right and left double rod cylinders (3a), viewed from the plane.

FIG. 12g is a view of a fulcrum center portion viewed from the side, showing a multiplex oil hydraulic pump (14) which is disposed at a laterally and vertically symmetric position between right and left double rod cylinders, and a double rod cylinder (3a).

FIG. 12h is a plan view of a reciprocating balance which couples right and left double, single rod cylinder rods (3a, 3b) are coupled with right and left crank rods (15).

FIG. 13a is a circuit diagram of a water pressure solenoid on-off shut-off valve (67a) and a water pressure solenoid discharge valve (68a) of a ball valve, butterfly valve of a large diameter of head chamber of double acting single rod water pressure cylinder (3b) of a reciprocating transfer unit. (Example 1)

FIG. 13b is a schematic sectional view showing that a double acting single rod water pressure cylinder (3b) which is activated by oil pressure and water pressure is applied to a reciprocating oil pressure transfer unit, viewed from the front. (Example 1)

FIG. 13c is a schematic sectional view showing that the double acting single rod water pressure cylinder (3b) which is activated by water pressure to upper and lower chambers is applied to the reciprocating transfer unit, viewed from the front. (Example 1)

FIG. 13d is a schematic sectional view showing that a double acting single rod steam pressure cylinder (3c)which is activated by steam pressure to upper and lower chambers is applied to the reciprocating transfer unit, viewed from the front. (Example 3)

FIG. 13e is a view simply showing an arrangement of a diverted water communicating pipe (4) to right and left head chambers of the reciprocating transfer unit and a water pressure solenoid on-off ball valve (67a) and a water pressure solenoid discharge ball valve (68a) provided on a discharge pipe. (Example 1) The oil hydraulic line of a rod chamber is omitted.

FIG. 13f is a view simply showing an arrangement of the diverted water communicating pipe (4) to the right and left head chambers and rod chambers of the reciprocating transfer unit and the water pressure solenoid on-off ball valve (67a, 67b) and the water pressure solenoid discharge ball valve (68a, 68b) with a capacity difference provided in a discharge pipe. (Example 1)

FIG. 13g is a view simply showing an arrangement of the right and left head chambers and rod chambers of the reciprocating transfer unit, a steam pressure communicating pipe (83), and a poppet steam pressure solenoid switching valve (85a, 85b) with a capacity difference provided in the discharge pipe. A water-cooling radiator (89) is provided in a piston rod fabricated into a pipe, a water-cooling fin (90) is provided in a cylinder, and a cylinder sleeve is adapted to a water jacket. (Examples, 1, 3, 4, 5, 6, 7, 8, 9)

FIG. 14a is a view simply showing an arrangement of pipe lines of a multiplex quintuplex oil hydraulic pump (14) to double rod cylinder (3a), the multiplex quintuplex oil hydraulic pump (14) is mainly for two closed circuit variable displacement piston pumps (25) used for the double acting single rod cylinder (9a) of the pressure load equipment, an open-circuit auxiliary piston pump (26) set at high pressure for refilling or replacing its hydraulic oil, a small size closed circuit variable displacement piston pump (27) to a water pressure cylinder rod chamber.

FIG. 14b is a view simply showing a circuit diagram of connection of two closed circuit variable displacement piston pumps (25) and to a double rod cylinder of an open circuit auxiliary piston pump (26) set at high pressure for refilling. It is used for a single acting steam pressure cylinder (9c), a single acting air pressure cylinder (9d), a double acting single rod pressure cylinder (9c) of the pressure load equipment, and an oil pressure in the rod chamber is not required for the air pressure.

FIG. 14c is a reciprocating transfer unit of the present invention comprises upper and lower two pumps (25) of a multiplex oil hydraulic pump (14) and a plurality of, right and left double rod cylinders (3a), water pressure from a high place is injected to a head chamber of a double acting single rod water pressure cylinder (3b), and the water pressure is applied as a main operating power. Each of them is provided with a water pressure solenoid on-off ball valve (67a) and a water pressure solenoid discharge ball valve (68a), and is activated by switching between these valves. A rod chamber has a closed circuit variable displacement piston pump (25) of closed circuit structure for input of power increased according to a ratio of balances and an auxiliary pump (26) for refilling.

FIG. 14d is a circuit diagram where a double acting single rod water pressure cylinder (3b) of which upper and lower chambers are activated by water pressure is applied to a reciprocating transfer unit and a water pressure solenoid on-off ball valve (67a, 67b) and upper and lower chambers are provided with a water pressure solenoid discharge ball valve (68a, 68b) with capacity difference. (Example 1)

FIG. 14e is a circuit diagram where a double acting single rod steam pressure cylinder (3c)of which upper and lower chambers are activated by steam pressure is applied to the reciprocating transfer unit, upper and lower chambers are provided with a poppet steam pressure solenoid switching valve (85a, 85b) with a capacity difference, a lubricant port for lubricating grease, etc. on a seal packing and a air pressure port (57) are provided. (Example 3)

FIG. 14f is an oil hydraulic circuit diagram of a multiplex oil hydraulic pump (14) of a reciprocating oil pressure transfer unit.

FIG. 14g is an oil hydraulic circuit diagram for refilling or replacing hydraulic oil in an auxiliary piston pump (26) of the multiplex oil hydraulic pump (14) of the reciprocating oil pressure transfer unit.

FIG. 15a is a schematic sectional view of a double acting single rod water pressure cylinder (9a) of pressure load equipment, with head chamber fixed on a frame (10) on the ground and in an upward direction, and electromagnets (6) and permanent magnets (7) on three positions of a leading end of a rod, viewed from the side. (Examples 1, 2, 8, 10, 11)

FIG. 15b is a schematic sectional view of the double acting single rod water pressure cylinder (9a) of the pressure load equipment, with head chamber fixed on the frame (10) on the ground and in upward direction, viewed from the front, showing that a high pressure water pumping unit (72) is provided for pumping water from a discharge tank (71) to a high place. (Examples 1, 2, 8, 10, 11)

FIG. 15c is a schematic sectional view of the double acting single rod water pressure cylinder (9a) of the pressure load equipment, with head chamber fixed on the frame (10) on the ground and in upward direction, and an open circuit oil hydraulic pump unit (79) mounted integrally on the frame (10), viewed from the side. (Examples 2, 4, 5, 6, 7, 8, 9, 10, 11)

FIG. 15d is a schematic sectional view of the double acting single rod water pressure cylinder (9a) of the pressure load equipment, with head chamber fixed on the frame (10) on the ground and in upward direction, and an oil pressure pump unit (79), viewed from the front. (Examples 2, 4, 5, 6, 7, 8, 9, 10, 11)

FIG. 15e is a schematic sectional view of a single acting single rod steam pressure cylinder (9b) of the pressure load equipment, of water-cooling radiator (89) structure, with head chamber fixed on the frame (10) on the ground and in upward direction, viewed from the front. (Examples 3, 8)

FIG. 15f is a schematic sectional view of piping of a single acting single rod air pressure cylinder (9d) of the pressure load equipment, with head chamber fixed on the frame (10) on the ground and in upward direction, and a compressed air pressure tank (35) for gradually inputting increased power which is shared, viewed from the front. (Examples 2, 4, 5, 6, 7, 8, 9, 10, 11)

FIG. 15g is weight load equipment where an air hydraulic cylinder (9e) is provided on a load balance, air is filled in a head chamber and sealed for balancing with a weight of the ground, and a load is connected to the ground. (Examples 4, 5, 6, 7, 8, 9, 10, 11)

FIG. 15h is a plane view simply showing an ‘arrangement of an electromagnet (6) and a permanent magnet (7) disposed on a round stainless steel plate on a leading end portion of each cylinder of the pressure load equipment. (Examples 1, 2, 3, 4, 5, 6, 7, 8, 9, 10, 11)

FIG. 16a is an oil hydraulic circuit diagram of closed circuit having a small size closed circuit variable displacement piston pump (27) and an auxiliary pump (28) of a rod chamber of a double acting single rod water pressure cylinder (9a) for the pressure load equipment. (Examples 1, 2, 8, 10, 11)

FIG. 16b is a layout drawing of an oil hydraulic circuit from pumps of a multiplex oil pressure pump for the pressure load device to right and left double acting single rod water pressure cylinders (9a) on leading end portions of a load balance. (Examples 1, 2, 8, 10, 11)

FIG. 16c is a circuit diagram of an open circuit oil hydraulic pump unit (79) of the pressure load equipment. (Examples 2, 4, 5, 6, 7, 8, 9, 10, 11)

FIG. 16d is a detailed sectional view of structure of the present invention where pressure drop at time of injection is eliminated by reducing capacity of head chambers of a single acting steam pressure cylinder (9b), a single acting air pressure cylinder (9d) with head chambers fixed on frames on the ground and in upward directions, viewed from the side. When necessary, an electromagnet (6) or a permanent magnet is mounted on a plate of a leading end portion of a rod, to be sandwiched between an electromagnet of an upper adjustment frame (10a) and an electromagnet (6) on a load balance, an injection and discharge stroke is done by attraction and repulsion forces of an electromagnet (6), and the stroke is done by magnetic force and timer (38), demagnetizing of complete load and certain separation are caused by demagnetizing and degaussing. (Examples 3, 8)

FIG. 16e is a detailed sectional view of a single action air cylinder (5) of equipment for gradually inputting increased power, provided on the ground near the leading end portions of a load balance for supporting the balance. (Examples 1, 2, 3, 4, 5, 6, 7, 8, 9, 10, 11)

FIG. 17a is a detailed sectional view of a multiplex quintuplex oil hydraulic pump unit (14) when a double acting single rod water pressure cylinder (9a) is used for the pressure load equipment. (Examples 1, 2, 3, 4, 5, 6, 7, 8, 9, 10, 11)

FIG. 17b is a detailed sectional view of a multiplex triplex oil hydraulic pump unit (14) used for single acting single rod steam pressure cylinder (9b), a single acting single rod air pressure cylinder (9d), a double acting single rod oil hydraulic cylinder (9c) of an open circuit unit (79) of the pressure load equipment. (Examples 1, 2, 3, 4, 5, 6, 7, 8, 9, 10, 11)

FIG. 17c is a detailed sectional view showing that a double acting single rod water pressure cylinder (9a) is used for the pressure load equipment, double acting double rod water pressure cylinder, double acting single rod water pressure cylinder (3b), double acting double rod steam pressure cylinder, double acting single rod steam pressure cylinder (3c)used for a double rod cylinder of a reciprocating oil pressure transfer unit. (Examples 1, 3)

FIG. 17d is a detailed sectional view of a conjugate plate cam (42) and a follower (46) of a load-sensitive, closed circuit variable displacement piston pump (25) for two reciprocating oil pressure transfer units, sandwiched by them, and sharing a drive shaft at laterally and vertically symmetrical position and a cam shaft (45), in a multiplex oil hydraulic pump.

FIG. 17e is a detailed view showing that in the multiplex oil hydraulic pump, an upper pump having a drive shaft and a cam shaft (45) which are coaxial is set for a small size open circuit high pressure application, and is a variable displacement piston pump (26) for replacing a hydraulic oil of two reciprocating pumps via a poppet solenoid injection valve (31), an solenoid discharge valve (30), and a lower pump is a closed circuit variable displacement piston pump (27) for pressure loading and allowing for adjustment of length of the follower (46).

FIG. 17f is a detailed side view showing a movement relationship between divided conjugate plate cams (42) of a cam shaft (45) the closed circuit variable displacement piston pump (27) for the pressure load equipment and the follower (46) of an adjustment bolt (51) in the multiplex oil hydraulic pump.

FIG. 18a is a schematic view of an electric circuit simply showing layout of an electric circuit of a poppet solenoid valve (30, 31) for forcing in and out of an open circuit, high pressure, auxiliary piston pump for replacing hydraulic oil of a reciprocating oil pressure transfer unit, electromagnets (6) for the pressure load equipment at three positions where two electromagnets are unified into one, and exciting devices, a poppet water pressure solenoid on-off shut-off valve (67) of a double acting single rod water pressure cylinder, a water pressure solenoid on-off ball valve or butterfly valve (67a, 67b), puppet water pressure solenoid discharge valve (68), water pressure solenoid discharge ball valve or butterfly valve (68a, 68b), poppet solenoid on-off shut-off valve of a single acting single rod steam pressure cylinder, a discharge valve (84, 85), solenoid switching valves (70) on two right and left double acting single rod oil hydraulic cylinder, poppet solenoid on-off shut-off valve of a single acting single rod pneumatic cylinder, discharge valves (74, 75) and poppet solenoid injection, discharge valves (74a, 75a) of right and left single acting air cylinders for supporting the load balance, and an solenoid switching valves (85a, 85b) of a double acting single rod steam pressure cylinder. (Examples 1, 2, 3, 4, 5, 6, 7, 8, 9, 10, 11)

EXPLANATION OF REFERENCE NUMERALS

| | |
|---|---|
| (A) | Gravity power generating unit using balances and having pressure load equipment |
| (1) | Pressure (weight load balance) |
| (2) | Reciprocating balance |
| (3) | Middle portion trunnion pin joint, double acting double rod oil hydraulic cylinder with |
| | upper and lower chambers of the same volume |
| (3b) | Double acting single rod water pressure cylinder |
| (3c) | Double acting single rod steam pressure cylinder |
| (4) | Water pressure pipe (water conduit) |
| (4a) | Discharge port |
| (4b) | High-pressure water electric pump |
| (5) | Single acting air cylinder |
| (6) | Electromagnet |
| (7) | Permanent magnet |
| (8) | Flywheel |
| (9a) | Double acting single rod steam pressure cylinder |
| (9b) | Single acting single rod steam pressure cylinder |
| (9c) | Double acting single rod oil hydraulic cylinder |
| (9d) | Single acting single rod air pressure cylinder |
| (9e) | Air hydraulic |
| (10) | Load frame fixed on the ground |
| (10a) | Electromagnet adjustment frame |
| (10b) | Weight |
| (11) | Power generator |
| (12) | Motor |
| (13) | Crank gear box |
| (14) | Multiplex oil hydraulic pump |
| (15) | Crank rod |
| (16) | Crank arm |
| (17) | Crank gear |
| (18) | Intermediate gear |
| (19) | Bearing base |
| (20) | Middle portion trunnion pin joint, bearing mounted |
| (21) | Clevis pin joint, bearing mounted |
| (22) | Bearing mounted |
| (23) | Hydraulic oil tube (suction and discharge) |
| (24) | Compressed air tube |
| (25) | Closed circuit variable displacement piston pump of reciprocating oil pressure transfer unit |
| (26) | Open circuit auxiliary variable displacement piston pump |
| (27) | small size closed circuit variable displacement piston pump for pressure load equipment |
| (28) | Open circuit auxiliary gear pump |
| (29) | Hydraulic oil tank |
| (30) | Poppet type solenoid valve for discharge |
| (31) | Poppet type solenoid valve for injection |
| (32) | Conductive chain |
| (33) | Driven shaft gear box |
| (34) | Limit switch |
| (35) | Compressed air pressure tank |
| (36) | Intermediate shaft |
| (37) | Relay |
| (38) | Ondelay (digital) timer |
| (39) | Forward/reverse exciter with built-in regulator |
| (40) | Swash plate |
| (41) | Spiral bevel gear |
| (42) | Conjugate plate cam |
| (43) | Suction port and discharge port |
| (44) | Drive shaft |
| (45) | Shaft as drive and cam shaft |
| (46) | Follower |
| (47) | Spur gea |
| (48) | Forward reverse tilt plate (tilted plate) |
| (49) | Spring |
| (50) | Piston |
| (51) | Follower adjustment bolt |
| (52) | Plate adjustment bolt for open circuit piston pump |
| (53) | Power conditioner (control box) |
| (54) | Rod of double rod cylinder |
| (55) | Piston |
| (56) | Aperture of air vent communication pipe of lower piston chamber |
| (57) | Air vent (press-fit hole) socket |
| (58) | Pipe socket (serving also as press-fit socket of other oil hydraulic equipment |
| (59) | Bolt |
| (60) | Air trap |
| (61) | Seal packing |
| (62) | Wear ring |
| (63) | Dust seal |
| (64) | Bearing base of multiplex oil hydraulic pump |
| (65) | Discharge pipe for replacing hydraulic oil |
| (66) | Injection pipe for replacing hydraulic oil |
| (67) | Water pressure solenoid on-off shut-off valve |
| (67a, 67b) | Water pressure solenoid on-off ball valve or butterfly valve |
| (68) | Water pressure solenoid discharge valve |
| (68a, 68b) | Water pressure solenoid discharge ball valve, or butterfly valve |
| (69) | Throttle valve |
| (70) | Solenoid switching valve |
| (71) | Drain tank |
| (72) | High pressure water pump unit |
| (73) | Open circuit oil hydraulic pump |
| (74, 74a) | Pneumatic solenoid on-off shut-off valve |
| (75, 75a) | Pneumatic solenoid discharge valve |
| (76) | Reservoir, water tank |
| (77) | Nuclear, thermal boiler |
| (78) | Nuclear, thermal steam turbine |
| (78a) | Water turbine |
| (78b) | Gas turbine |
| (79) | Open circuit oil hydraulic pump unit |
| (80) | Flush valve |
| (81) | Non-return valve (check valve) |
| (82) | Closed circuit oil hydraulic unit of other system |
| (83) | Steam pressure tube |
| (84) | Steam pressure solenoid on-off shut-off valve |
| (85) | Steam pressure solenoid discharge valve |
| (85a, 85b) | Steam pressure solenoid switch valve |
| (86) | Torque converter automatic transmission |
| (86a) | Torque converter reverse rotation transmission |
| (87) | Pneumatic pump unit |
| (88) | Water cooling-pipe |
| (89) | Water-cooling radiator core of water jacket |
| (90) | Water-cooling fin |
| (91) | Grease injection port |
| (92) | Pressure, flow rate control electric valve |
| (93) | Three variable blades |
| (94) | Spiral bevel gear (bevel gear) of wind turbine axis |
| (95) | Yaw mechanism (rotation assist, braking apparatus) |
| (96) | Connecting shaft |
| (97) | Bearing |
| (97a) | Magnetic bearing |
| (98) | Fixed frame of arcuate blade Darrieus wind turbine |
| (98a) | Fixed frame of straight blade Darrieus wind turbine |
| (99) | Outer variable blade |
| (100) | Inner variable blade |
| (101) | Fixed center shaft |
| (102) | Variable center shaft |
| (103) | Horizontal reinforcing plate of inner variable blade |
| (103a) | Horizontal reinforcing plate |
| (103b) | Straight blade horizontal plate |
| (104) | Blade shaft braking band |
| (105) | Variable blade rotating shaft |
| (106) | Spinning motor (oil hydraulic, electric) |
| (107) | Entirely rotating shaft of a plurality of inner blades |
| (108) | Entirely rotating shaft of a plurality of outer blades |
| (109) | Upper and lower inserting holes for adjusting pitch by sliding arcuate and straight |
| | blades |
| (109a) | Upper and lower plays of blade bearing |
| (110) | Solar panel |
| (111) | Feeding, substation facility |
| (111a) | Substation equipment for transformation to commercial power source, electric power |
| (112) | Load (battery, etc.) |
| (113) | Diesel engine |
| (114) | Gas turbine engine |
| (115) | Compressor |
| (116) | Burner |
| (117) | Feeding circuit in section in train service |
| (118) | Train |
| (118a) | Low-floor rotary motor train |
| (118b) | Low-floor magnetically elevated linear motor train on single track |
| (118c) | Low-floor magnetically elevated linear motor trains on double track |
| (119) | Seats facing sidewall above biaxial wheels without drive motor |
| (119a) | Seats facing travelling direction above triaxial wheels above drive motor |
| (119b) | Low-floor magnetically elevated linear motor train, air conditioning equipment, seats |
| | above cover of control devices (transformer, rectifier, etc.) |
| (120) | Pressure plate of gentle triangle structure to be disposed in tunnel |
| (121) | Pressure plate to be disposed on car body |
| (122) | Small window |
| (123) | Aboveground station |
| (123a) | Starting station |
| (123b) | Next station |
| (123c) | Middle station |
| (124) | Shielded tunnel track on uphill and downhill zones |
| (125) | Level track |
| (126) | Platform |
| (126a) | Railway |
| (126b) | Tunnel |
| (127) | Concrete segment |
| (127a) | Steel segment |
| (127b) | Steel frame material |
| (127c) | Magnetic elevation structural frame |
| (128) | Aboveground area |
| (129) | Floor of platform |
| (130) | Passenger step |
| (130a) | Passenger step to be slid under floor of train |
| (131) | Laterally slide double doors |
| (131a) | Single door which is not subject to wind pressure caused by express train, etc. |
| (132) | Externally threaded shaft (threaded cylinder) |
| (132a) | Crest portion of external threads |
| (133) | Internally threaded portion |
| (133a) | Valley portion of internal threads |
| (133b) | Bearing |
| (134) | Space between platform and train |
| (135) | Door housing portion |
| (136) | Pneumatic cylinder, etc. |
| (137) | Parallel handrail stand on floor |
| (137a) | Hand rail stand on floor for resting body thereon |
| (137b) | Hand rail on side wall |

### MODES FOR CARRYING OUT THE INVENTION

The embodiments of the present invention are explained based on drawings and reference numerals.

At start, operation is performed in such a manner that a power is increased according to the ratio of balances with the use of pressure load equipment, and the increased power is supported by air pressure which is filled in single acting air cylinders (5). At the same time as operation, a timer (38) is adjusted, discharge time from a discharge valve (75a) is set, a device to which load is gradually input and a vector control inverter motor (12) are rotated by lowering output in order to balance with electric load output of a power generator. Through discharge of air pressure little by little and lengthy action of increased oil quantity of a closed circuit variable displacement piston pump (25) of a reciprocating oil pressure transfer unit sensing a load, the increased power is returned to a nominal output while the load output of the motor (12) and the load output of the power generator (11) are balanced. An oil pressure, a water pressure and a steam pressure are basically the same (in function), and the following embodiments will be explained for whole of them according to specifications of the above equipment, etc.

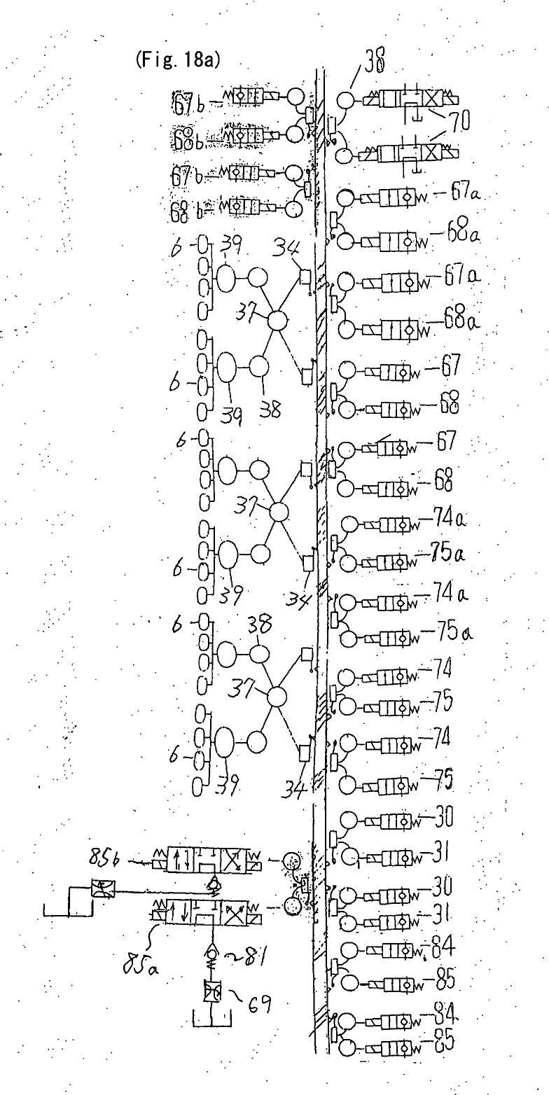

Each of solenoid on-off shut-off valves (67, 67a, 67b, 74, 74a, 84), solenoid switching valves (70), solenoid discharge valves (68, 68a, 68b, 75, 75a, 85), steam pressure solenoid switching valves (85a, 85b), electromagnets (6), relays (37), digital timers (38), exciter devices (39), limit switches (34) as illustrated in FIG. 18 are of unified specification, alternate current, 60 Hz, 220V, a response time for activating each device is within 0.1 second by an electric signal sequence control, and a time is adjusted so that each device is activated smoothly at each timing.

When saturated steam pressure of a large volume of steam pressure is obtained, natural discharge is possible because the steam pressure is an air pressure. An oil pressure is not required in a rod chamber. For the cylinder, a fluorine type elastomer seal packing having heat resistance to about 200° C. and water resistance is employed. Such heat-insulated structure is employed that an electromagnet portion and a spool portion of each solenoid on-off valve and discharge valve are separated into two, and these are coupled with one another by steel spiral springs with radiation property. In order to take a countermeasure against leakage of a sliding portion of the spool, the above seal packing of the fluorine type was used. The sliding resistance of the seal packing of each of the oil pressure, the water pressure, and the steam pressure and other mechanical resistance become heavy load. By virtue of the excellent accuracy of hard chrome plating, etc. and the long lasting durability of the seal packing, etc., leakage from a dust seal (63), a piston seal, a rod seal is almost zero, in particular in closed circuit double rod oil hydraulic cylinder, single or double rod water pressure cylinder, steam pressure cylinder, or the like. In order to achieve similar accuracy with respect to a pump, a pump of higher rank is used.

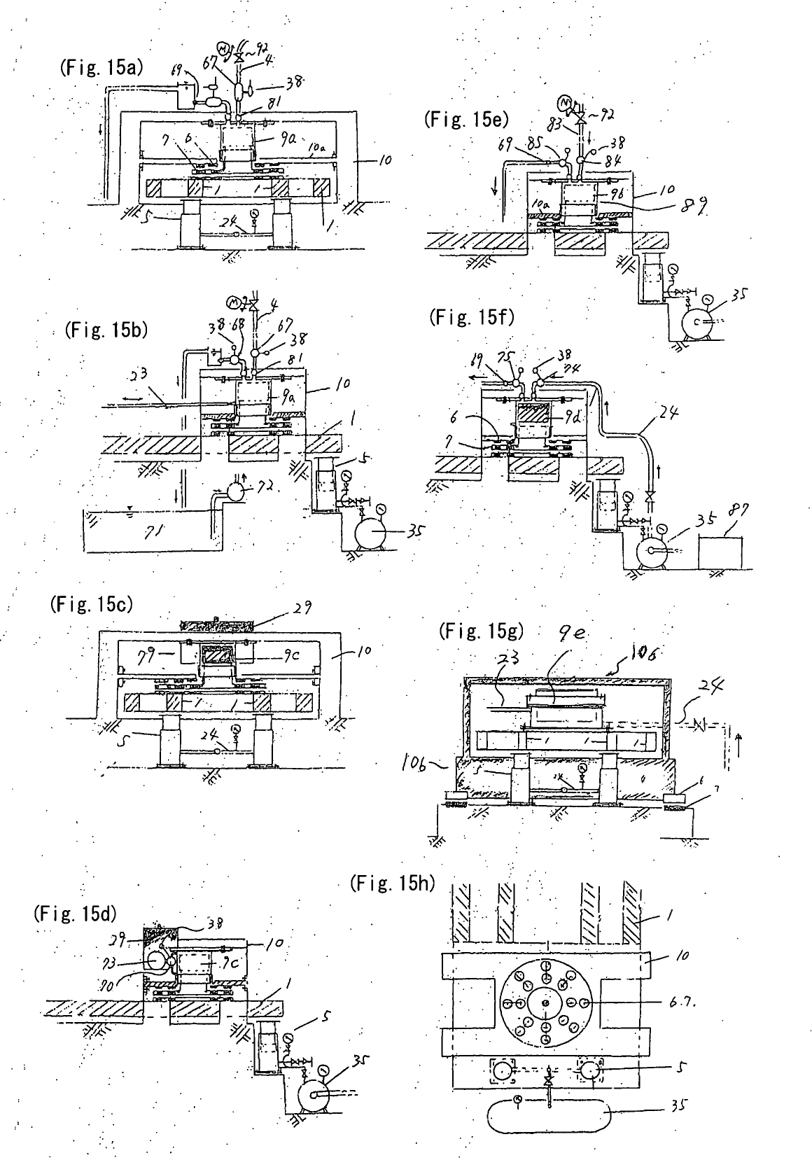

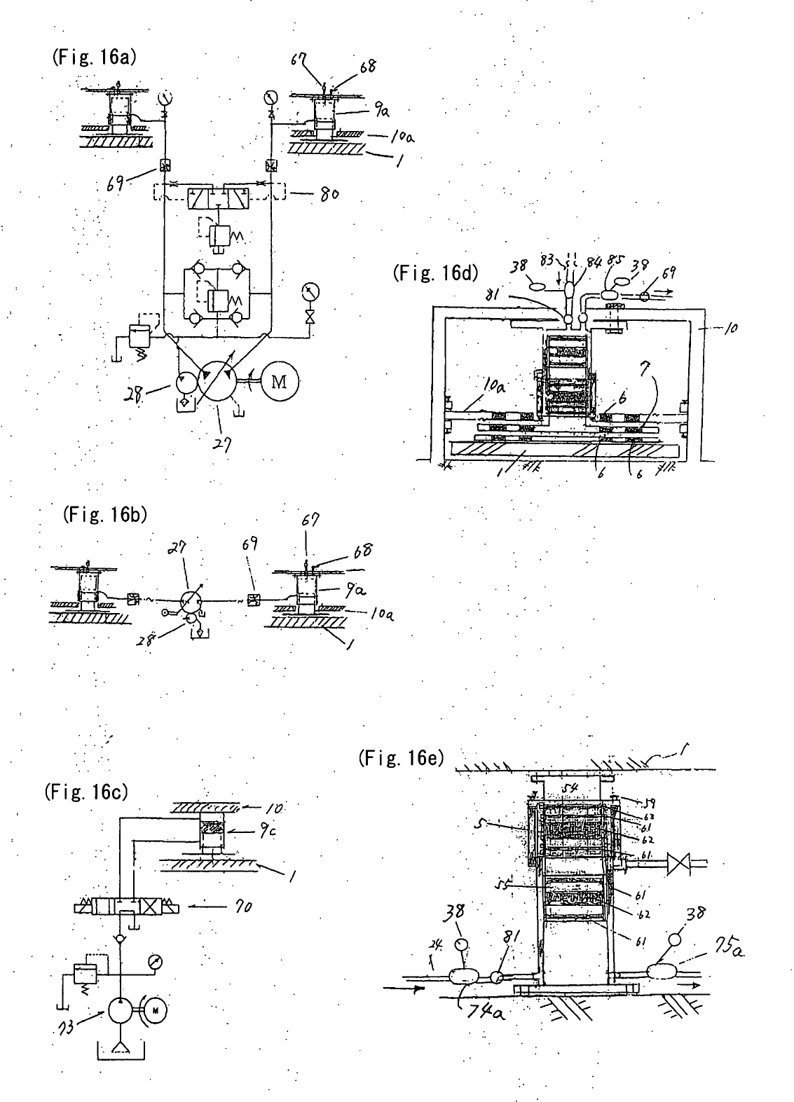

For excitation of electromagnets at upper, middle and lower, three positions as illustrated in FIGS. 15h and 16d, a one-shot method momentary attraction and repulsion forces are used by a relay, a digital timer, and combination of north and south poles for adjustment of strength from a reverse exciter with built-in adjuster. Without sure degaussing and demagnetizing, loading and unloading is not conducted. Unloading is conducted by discharge of air of a single acting steam pressure or single acting pneumatic cylinder and simultaneous momentary attraction, a stroke of about 10 mm within 10 seconds is sufficient, and repulsion serves as an auxiliary device. In a double acting single rod water pressure cylinder (9a) as illustrated in FIGS. 15a, 15b, an open circuit oil hydraulic pump unit (79) as illustrated in FIGS. 15c, 15d, loading and unloading are controlled by an oil pressure force, and the electromagnet is adapted as a device for assisting and combining with it. A limit switch (34), a digital timer (38), a solenoid on-off shutoff valve, a solenoid discharge valve, a quick open, solenoid switching valve, a solenoid of large capacity and large aperture diameter valve, a butterfly valve or the like are used. In addition, a solenoid force-fitting valve (67a), a discharge valve (68a) of a double acting single rod water pressure cylinder (3b) for reciprocating motion, using a plurality of units are used. And a pressure, flow rate control electric valve provided on a water pressure pipe (4), a steam pressure pipe (83) has a structure of increasing flow-rate by opening or closing a valve with the use of an electric motor, through sensing a load from starting or signals from a rotation sensor. For a power generator and a motor which are equipped with electric facilities suitable for apparatuses to be combined or associated, respectively, may be used. A multi polar, low revolution, permanent magnet synchronous generator and a squirrel cage induction generator may be selectively used. Arbitrary voltage and electric current may be employed. Based on signals from a sensor, a vector control inverter is controlled with a programmed controller, and existing technology is used. In the above manner, a hybrid power generating unit is constructed.

### Embodiment 1

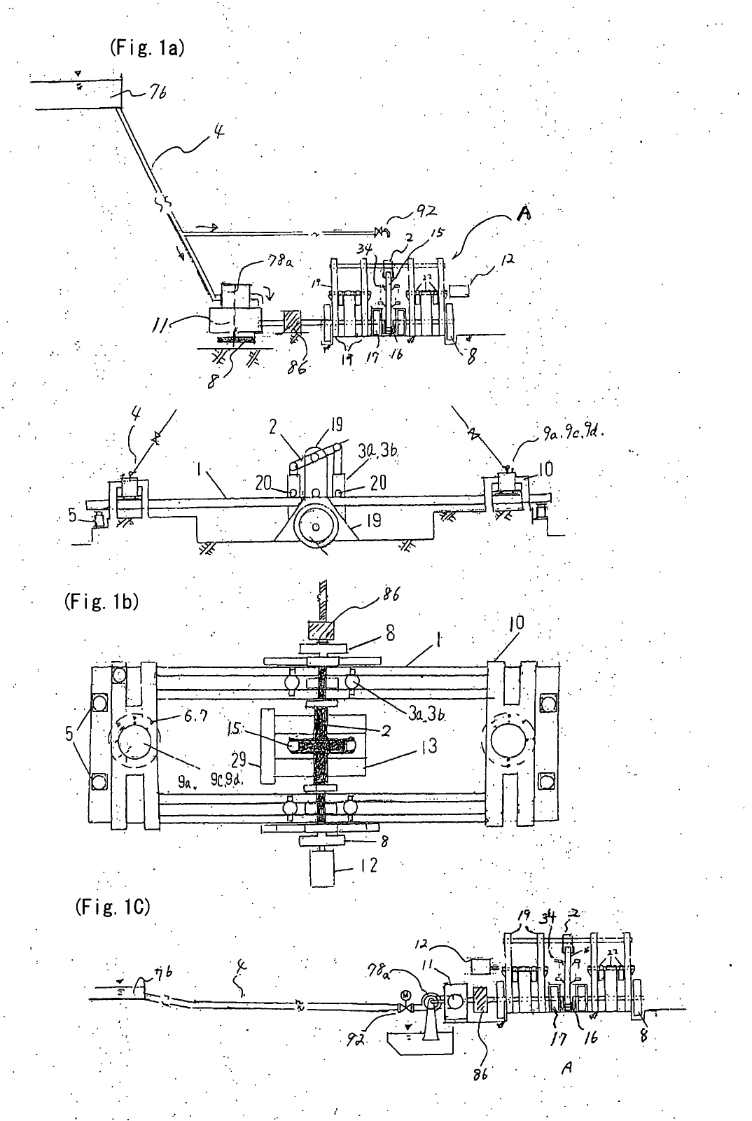

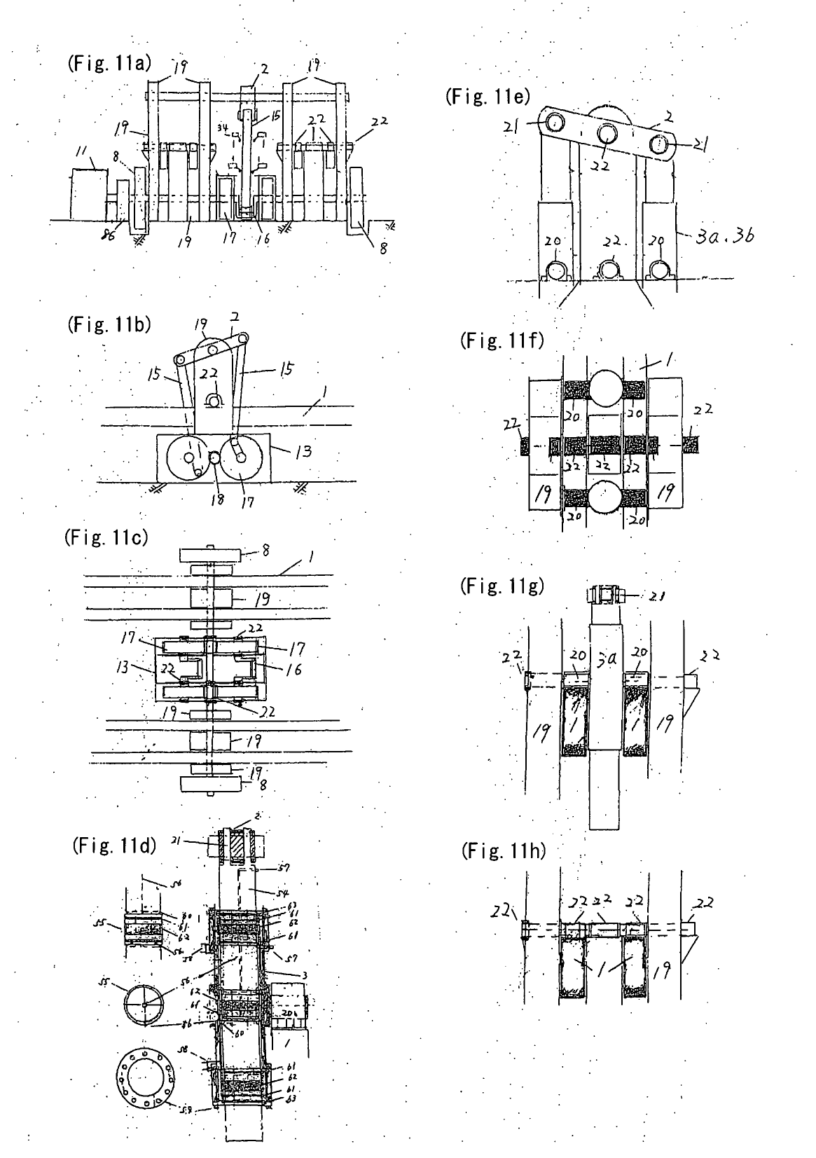

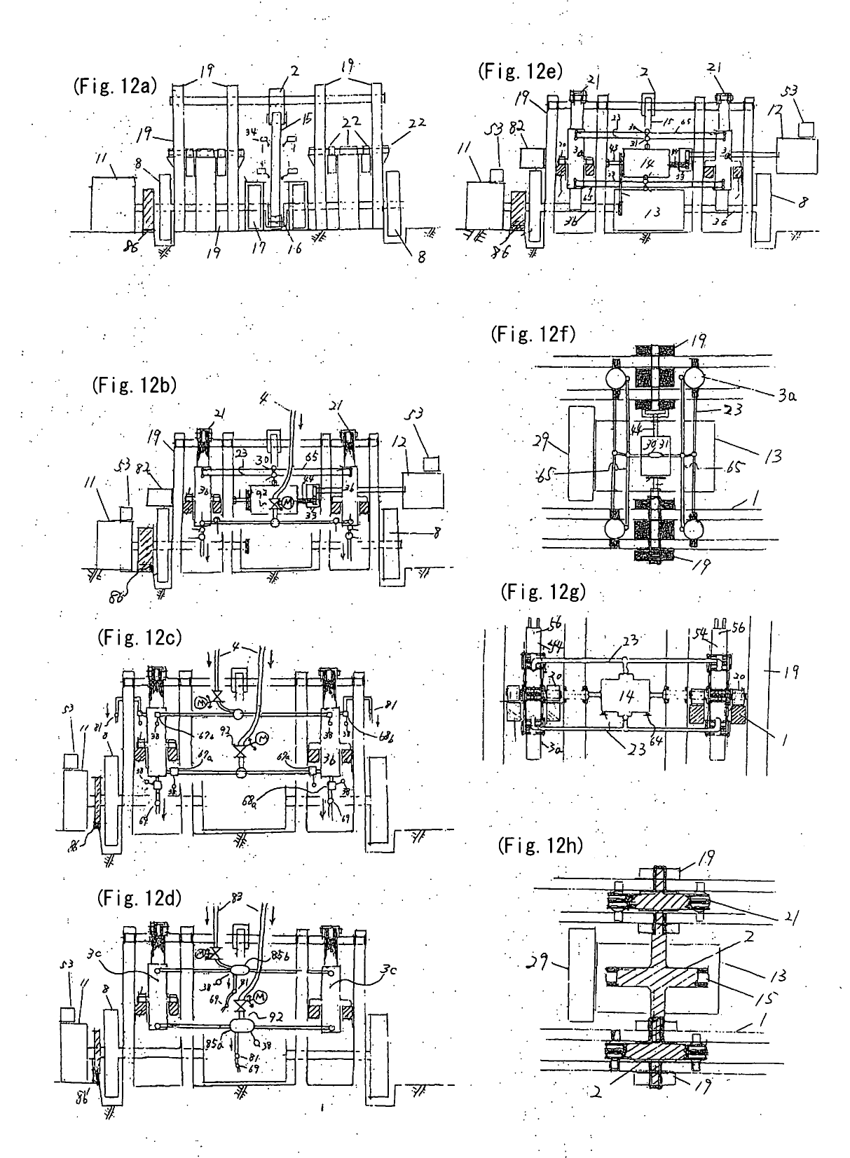

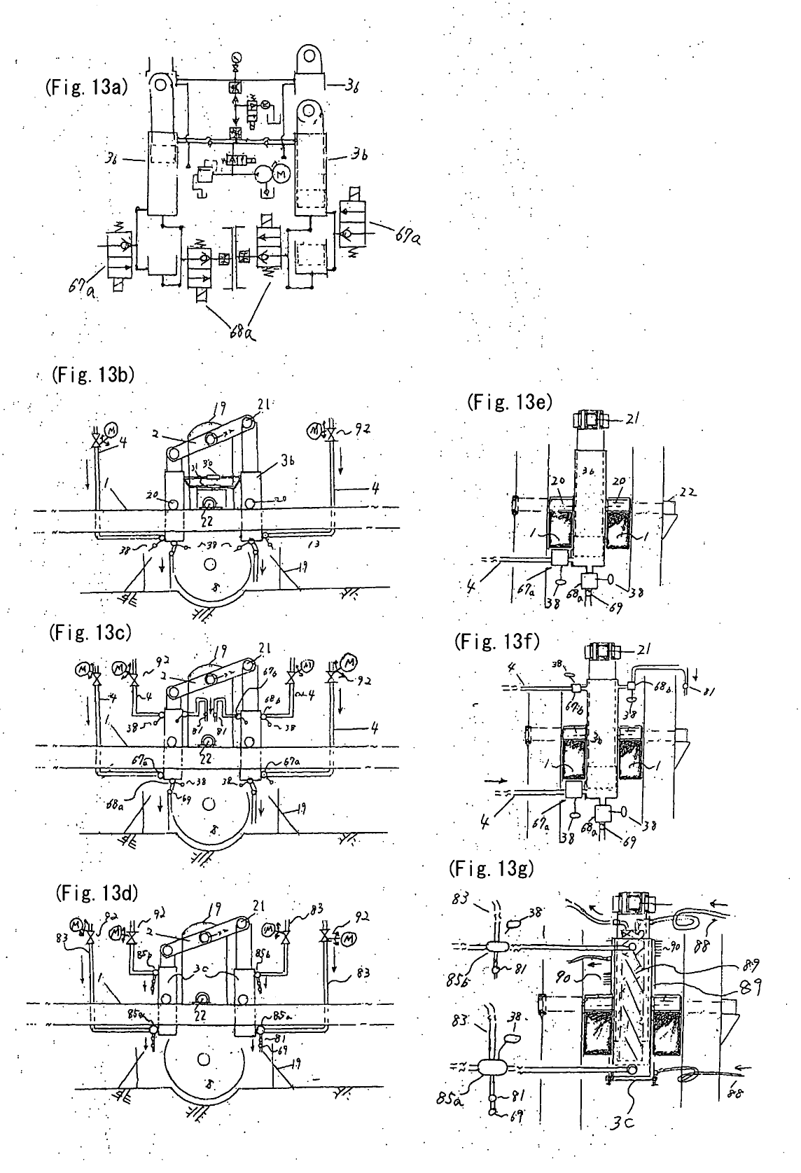

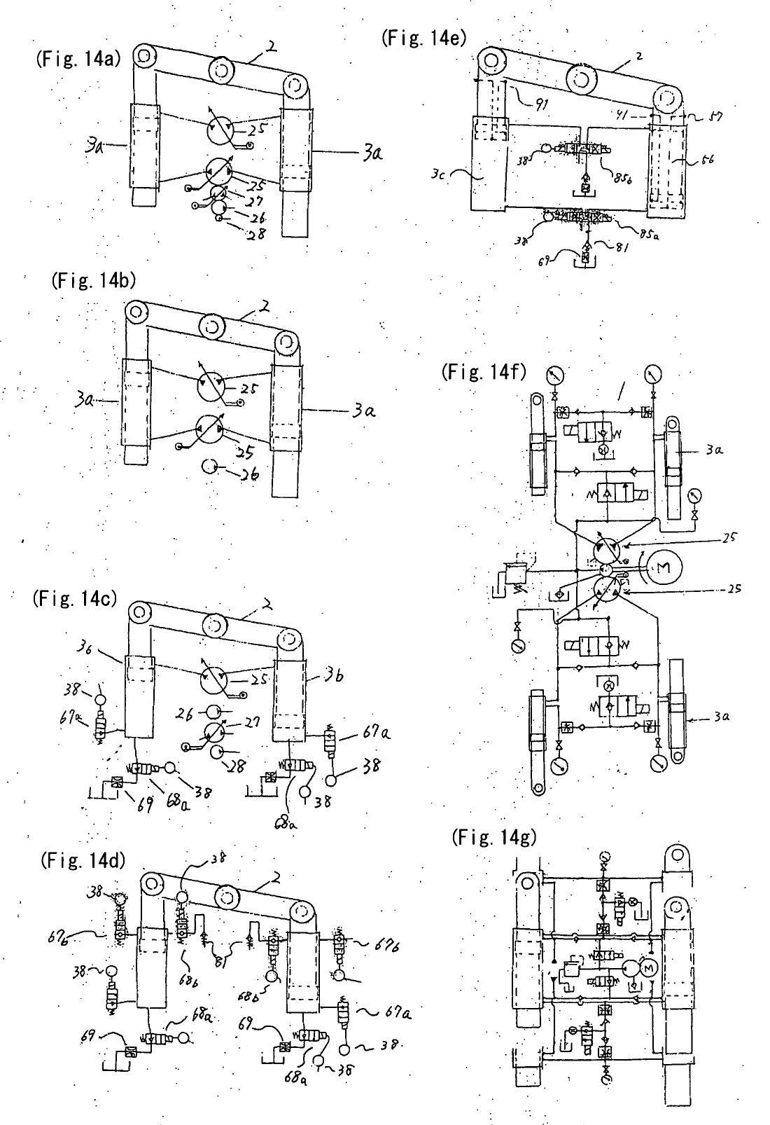

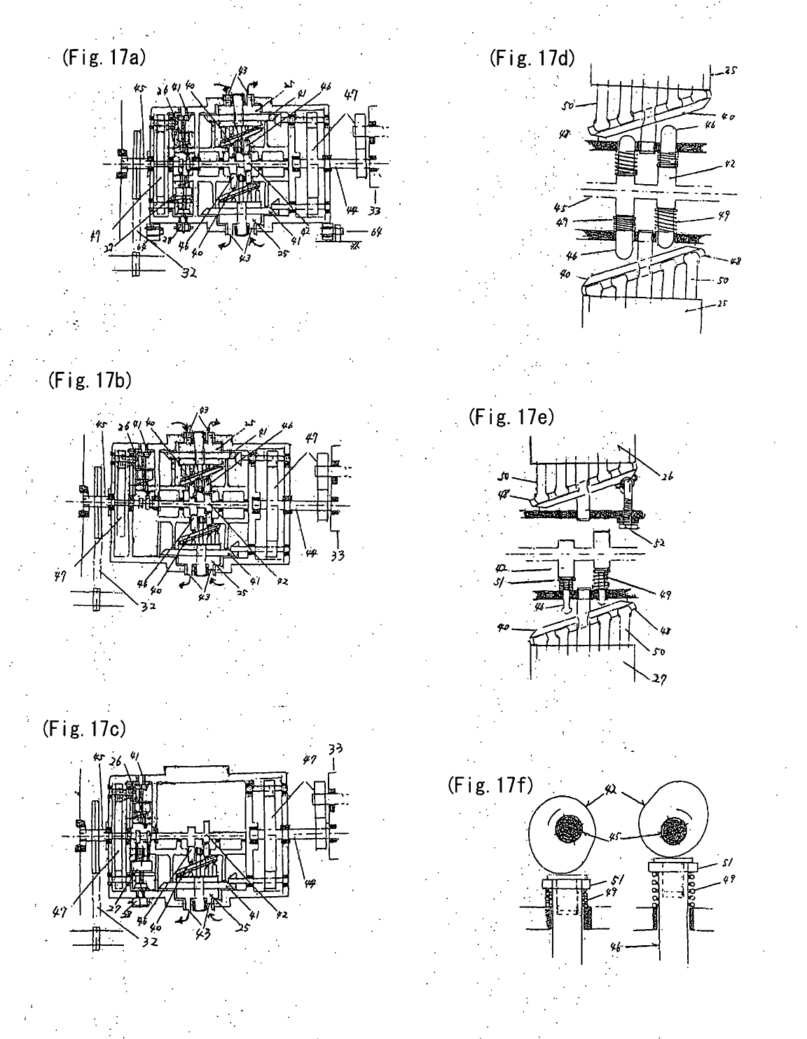

FIG. 1 shows a water turbine using potential energy of a height difference of a large-size hydroelectric power generating station. A water turbine turns at approximately 300 to 800 revolutions per minute by high pressure water supplied by water pressure pipes or the like, the larger the wind turbine is, the less frequently will the wind turbine turn. The wind turbine is coupled with the power generator via a vertical axis. The gravity power generating unit is of an existing invention, comprising pressure load equipment, and using upper and lower, two step balances with their center on their fulcrum. A plurality of double acting single rod water pressure cylinders are provided on right and left leading ends of the lower balance, respectively, a power in a head chamber of the double acting single rod water pressure cylinder (9a) (four units of cylinders of diameter 1 m, total 30,000 cm², and subject to the water pressure at 1 Mpa) is increased by high pressure according to the ratio of the balances, one to six, for example, a pressure force of 300 t will be increased to a pressure force of 1800 t in weight. This pressure force is transmitted and applied alternately on a plurality of double rod cylinders (3a) of a reciprocating oil pressure transfer unit which is disposed on a center portion of the balance extending in right and left, and the double rod cylinders (3a) are disposed on right and left from a fulcrum on an upper step, as illustrated in FIG. 12e. Then, the load of this pressure force is switched alternately, at upper and lower dead points, by closed circuit variable displacement oil hydraulic pumps (25) which connects between upper chambers, and between lower chambers, respectively. The closed circuit variable displacement oil hydraulic pumps (25) are of the same model and coupled with an external driving power. The double rod cylinder has upper and lower chambers of the same small capacity (the cylinder has a diameter of 1.0 m, an area of 7,850 cm², the rod has a diameter of 99.5 cm, an area of 7,772 cm², a stroke of 1.0 m, each of upper and lower chambers has .the capacity of 7.8 L, four cylinders on right and left have total capacity of 31.2 L, the oil pressure communicates between the upper chambers, and between the lower chambers, respectively, and is alternately forced in and out by switching the closed circuit variable displacement oil hydraulic pumps at upper and lower dead points). For example, a weight of 8 t will be increased by an angled variable displacement slant plate about by 30%. A capacity of a pump is 1,800 L/minute and an output of a motor is a maximum pressure of 3 Mpa. And, a squirrel cage induction motor of a vector control inverter of about 300 kW is used. A pump to be used corresponds to an output resulted from a function of increased oil quantity. In order to adjust water flow to the water turbine, a flywheel (8) which balances with the increased power is provided and directly connected to the power generator, the power generator is coupled with an intermediate gear shaft (a transmission gear) via spiral bevel gears, etc. and a torque converter automatic transmission (86). Right and left crank gears are engaged via right and left rod cylinders and crank rods. Rotation of the water turbine is associated with up and down movement of the double rod cylinders, the cylinders act as pumps, the oil hydraulic pump of the closed circuit serves as an oil hydraulic motor, and output revolutions by water supply to the water turbine and the power of 1,800 t increased by loading of the pressure load equipment are balanced gradually. The weight 1,800 t placed on the double rod cylinder which moves up and down is supported by the air pressure filled in the plurality of the single acting air cylinders (5) as illustrated in FIG. 14e, and the air pressure is gradually input in the plurality of the single acting air cylinders via the discharge valves (75a). The water turbine power generator slows down by adjusting an output of water to balance with 1,800 t by the flywheels. Assume that the stroke of the crank is 1 m/second. a ratio of an overdrive gear and a reduction gear are by the water turbine power generator and the torque converter automatic transmission (86), the output by the quantity of water is gradually increased, for example, a fall of water from heights of 100 m is changed from 5 m³ per second to a fall of water of 20 m³ per second, at maximum. The output is affected by the resistive loss, etc., therefore will be 40,00 kW to 16,000 kW. A quantity of an oil is gradually increased by the oil hydraulic pump so as to input a power from zero to 1800 t, gradually, thereby increased output of 12,000 kW at maximum and a nominal power generating capacity of about 28,000 kW is obtained with the fall water of 20 m³ at maximum by gradually increasing supply of water to the water turbine. The inverter vector control squirrel cage induction power generator is used. The upper and lower closed circuit oil hydraulic pumps of the same model, and a plurality of, right and left double rod cylinders serve as conveyance media between both equipment, the gravity power generating unit and the power generator, by closing circuits and using a motor for alternating right and left pump at flow of 1800 L/minute. to transfer a small quantity of hydraulic oil alternately between the right and left ones, With regard to countermeasure against sliding heat as illustrated in FIG. 13g, a water-cooling radiator structure is applied for an inside of the rod and a sleeve. At a dam which can discharge large volume of water, similarly to the pressure load equipment as illustrated in FIGS. 13b, 13c, 13e, 13f, head chambers of right and left double acting single rod water pressure cylinders (3b) are communicated with a water pressure pipe from the dam, instead of oil hydraulic chambers, a water pressure is optionally used also in the rod chambers. Alternately, a double rod water pressure cylinder of arbitrary rod diameter is applied, and both of a water pressure and an oil pressure are applied. A limit switch at a upper dead point, a quick ball solenoid on-off shut-off valve (67a) using a digital timer, a ball solenoid discharge valve (68b) are used, for rod chambers as illustrated in FIG. 17c, one of a multiplex oil hydraulic pump (14), a closed circuit variable displacement oil hydraulic pump (25) is provided, the pump is automatically activated by a cam shaft, double acting single rod water pressure cylinders (9a) on right and left of a load balance of the pressure load equipment, the solenoid on-off shut-off valve (67), the solenoid discharge valve (68) are cooperated with one another, thereby loading and unloading are applied alternately on the right and the left repeatedly and are cooperated with the reciprocating rod cylinders, according to the ratio of the balances. For the reciprocating double acting single rod water pressure cylinder (3b), a water volume is increased by adjusting with a timer, or the like, and rotation output is accordingly increased. Electromagnet apparatus is switched within about 0.1 second, stroke of upper and lower cranks is set at 1 m/s, switching is conducted at a place of upper and lower dead points, and a time before and after when the increased power becomes a complete load is set 0.5 seconds. The increased power is input in a flywheel (8) in inertial circular motion, about 40% of the increased power is lost due to mechanical loss, etc. A generated power capable to be combined with the water turbine power generator is 12,000 kW form 2,000 t, while the power produced by the water turbine power generator is 16,000 kW, about 28,000 kW in total. Large or small size water turbine power generator which is incorporated in a current space and a gravity power generating unit using balances and having pressure load equipment cooperate with one another.

### Embodiment 2

A small size water turbine power generator as illustrated in FIG. 1c is coupled with a gravity power generating unit using balances and having pressure load equipment. A water turbine (selected from a water flow type, a water volume type, and a water pressure type) and a power generator is coupled by a horizontal shaft, and in the most of wind turbine power generators, a height difference relative to a drainage, etc. is 0.2 m to 50 m. A water turbine (78a) and a power generator (11) conforming to volume of water are selected, and the water turbine (78a) and the power generator (11), and a gravity power generating unit are engaged with one another by the horizontal axis. The gravity power generating unit uses two-step, upper and lower balances with their center at a fulcrum of the above mentioned pressure load equipment. For the pressure load equipment, a double acting single rod water pressure cylinder (9a) of large diameter is used. When a pressure of 0.1 Mpa is applied in a head chamber of a diameter 0.4 m, a pressure force relative to 1,256 cm² will be 1.256 t, which is increased to the pressure force of 7.5 t according to the ratio of the balances 1 to 6, this pressure force is applied alternately onto right and left double rod cylinders (3a) (diameter 0.3 m, two units, stroke of 1 m, at interval of 5 mmm, 4.6 L/s) of the reciprocating oil pressure transfer unit on the center portion of the balance extending to right and left, at a position of a fulcrum of the above stated upper balance to pressurize the double rod. Closed circuit variable displacement oil hydraulic piston pumps (25) of the same model which are activated by external driving means are provided between upper chambers and between lower chambers, a load of the pressure is switched alternately at upper and lower dead points. For the water turbine power generator of water-flow type, a low-revolution permanent magnet synchronous power generator (11) is used. The above increased power of 7.5 t is applied gradually on right and left double rod cylinders. The only difference from the previous one is size, large or small, the technique is the existing one. In the water turbine power generator of water volume type by water flow, water pressure force is small. For the pressure load equipment, a weight (10b) is installed on the ground near the right and left leading end portions of the load balance. The balance is balanced by filling air pressure in head chambers of air hydraulic cylinders (9c) on the balance and sealing the head chambers, by alternate injection and discharge in and from oil pressure chambers of small capacity, loading and unloading is repeated, thereby the increased power is input as in the above one. A weight, an oil pressure or an air pressure should be employed in a wind turbine or solar power generation in a place where the high pressure such as a water pressure and a steam pressure as above, or in a ship, railway service and a factory. For example, for a power generator a multi polar low-revolution permanent magnet synchronous power generator capable of power generation at 100 rpm is used, and for the pressure load equipment, the above double acting single rod water pressure cylinder (9a) is used, but a power to be applied is about a half of 7.5 t, 4.0 t. When a water-flow type water turbine power generator of 0.5 m³/second, 0.1 Mpa is used, power generating capacity is 500 W, a low-revolution permanent magnet synchronous power generator (11) about 50 kW is used, control equipment, etc. is the same as above, and output of an external motor of 0.1 Mpa, 300 L/minute, 5 kW is used.

### Embodiment 3

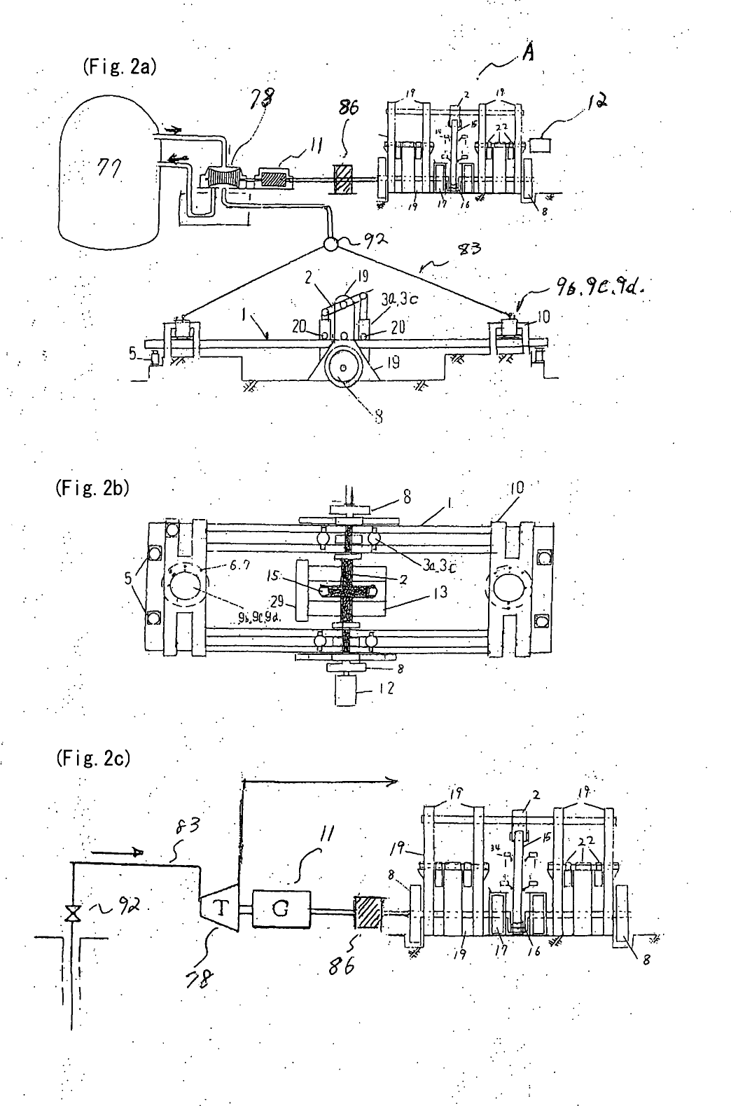

In a system as illustrated in FIG. 2 where a gravity power generating unit using balances and having pressure load equipment is connected to a steam, gas turbine power generator, double acting steam pressure cylinders (9b) as illustrated in FIG. 13e are used for pressure load equipment on right and left leading ends of a load balance, and saturated steam pressure of a boiler (77) of the thermal power generation is supplied in the cylinders. The cylinder is constructed in such a manner that a slight amount of steam is discharged by a slight distance of stroke (a gap relative to a piston head is about 5 mm which prevents bump of the piston head, by raised accuracy) to eliminate drop of an air pressure in a head chamber because an air pressure is used. A fluorine type elastomer seal packing which withstands saturation temperature of the steam is used, a cylinder sleeve is formed into a structure of water-cooling fin (90), water-cooling radiator (89) of a water jacket, and temperature is kept within a heatproof temperature of a seal for protecting the seal. A piston rod is formed into a pipe to be light-weight, and an inside of the piston rod is formed as a water-cooling fin radiator (89).

Since during use of a double rod oil hydraulic cylinder of a reciprocating oil pressure transfer unit as illustrated in FIG. 12e, a double acting single rod steam pressure cylinder (3c), double rod steam pressure cylinder and a double rod oil hydraulic cylinder (3a) of arbitrary rod diameter, rise in oil temperature causes leakage from the seal packing and decrease in oil viscosity, a structure of the water-cooling fin radiator (89) for keeping the oil temperature constant is employed. At a position where a piston end is switched, a gap defined is closed to zero, about a few millimeters, for eliminating variation in pressure. A power increased is placed on movement of a hydraulic oil, and at the position, may be transferred to a clank rod which operates like a cylinder. For a structure of a steam pressure chamber, a heat resistant fluorine type elastomer or the like which is hard and flexible is bonded on a piston head moving up and down, thereby a gap is not created. A steam pressure power generator, a gas turbine power generator, at a nuclear power station and the like, has large-scale with capacity of one million kW per generator. In a system of the present invention, a capacity is one hundred thousand kW, high revolution of 3000 rpm or more is reduced to that of about 500 rpm by providing a reduction gear mechanism on a rear shaft of the power generator, and a torque convertor automatic transmission (86) is provided. Electric control devices, etc. of a crank mechanism of the reciprocating oil pressure transfer unit and the pressure load equipment are for air cylinders which is the difference from the aforementioned pressure load equipment comprising water pressure cylinders. On an electromagnet portion at a part on a route from a water steam pipe (83) to a head chamber, a heat resistant a poppet form solenoid on-off shut-off valve (84) is provided, spaced from a piston, control devices such as a solenoid discharge valve (85), an electromagnet and a permanent magnet on the leading end portion of the rod are provided to construct the pressure load equipment, and the popett form solenoid on-off shutoff valve and the solenoid discharge valve are different from ball, butterfly valves for discharging water at high flow rate in respect of a heat resistant seal packing. A steam pressure of a boiler of the gas turbine power generator is used, or oil hydraulic or pneumatic cylinders are fixed on frames placed on right and left on the ground for the pressure load equipment on the load balance, and simultaneously using attraction and repulsion forces of the permanent magnet, the electromagnet on the leading end of the rod, load and unload are switched alternately. Alternately, as stated above, a weight is placed on the ground, near each of right and left leading ends of the load balance, the weight is supported by a head chamber of an air hydraulic cylinder (9e) which is filled with an air pressure and sealed so as to balance with the weight, force-discharge is applied alternately on right and left rod chambers by one small size closed circuit variable displacement oil hydraulic piston pump (27), thereby loading and contact with the ground is switched alternately, and attraction and repulsion forces of the permanent magnet (7), the electromagnet (6) on the ground are also used. In the thermal power generating station, the nuclear power generating station, a gas turbine engine, and the like, a turbine power generation using high-pressure, high-temperature saturated steam from a boiler. In the example here, a shaft of the power generator of a hundred thousand kW, a power from the aforementioned water pressure cylinder and steam cylinder via the torque converter automatic transmission is increased to the power of 30,000 kW according to a ration of balances, the power of 30,000 kW is input and combined, thereby the power of one hundred thirty thousand kW is obtained in the power generator. The power is the same, and there is difference whether a liquid or an air is applied, and difference in apparatuses. When a geothermal power generator as illustrated in FIG. 2c is coupled, a structure generally the same as the aforementioned thermal, nuclear power generators, however, places suitable for geothermal power generation is limited in view of stable supply of natural steam pressure.

### Embodiment 4

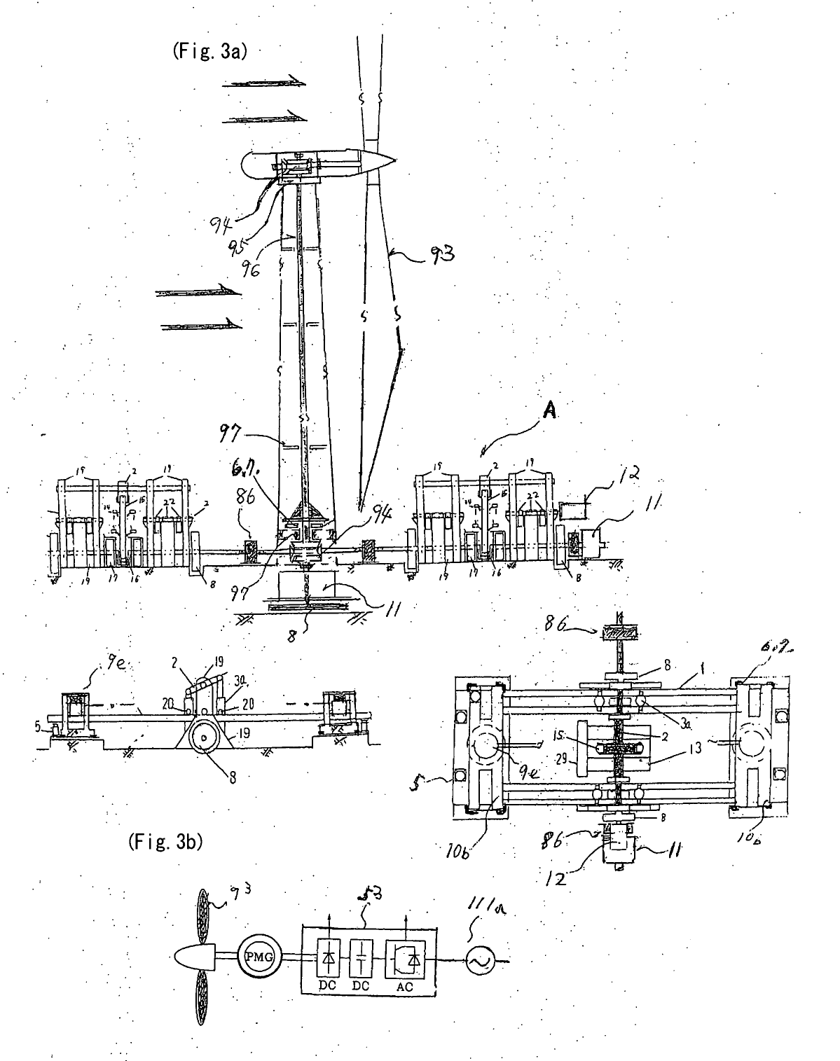

In a horizontal axis wind turbine as illustrated in FIG. 3 is constructed in such a manner that a spiral bevel gear (94), etc. of an axis of an upper portion of a tower is coupled with a gear of rotating rotor portion of a variable-pitch propeller or blade, and a downwind rotor is constructed in such a manner that a portion of a nacelle facing the tower defines a front portion and a hub and the blades define a rear portion in a wind direction. The rotor portion rotates and yaws automatically through a yaw mechanism. A power generator has a mechanism for assisting braking rotation (95), and a long vertical rotating shaft extending onto the ground under the tower is coupled with a horizontal axis gear via the spiral bevel gear. And, a vertical axis power generator in an aboveground tower portion is coupled with the gravity power generating unit via a torque converter automatic transmission. As in the above gas turbine power generation, oil pressure, pneumatic pressure is used for the pressure load equipment, and air hydraulic cylinders which use weight installed on the ground near right and left leading end portions of a load balance are used. A power is increased according to a ratio of balances, the number of revolutions, output are changed so as to correspond to change of wind power, a torque converter automatic transmission (86) adjusts increase or decrease of quantity of oil in double rod cylinders (3a) based on activation of closed circuit variable displacement oil hydraulic piston pumps (25) in a reciprocating oil pressure transfer unit, and pressure and magnetic force of the pressure load equipment. The upper and lower closed circuit variable displacement oil hydraulic piston pumps (25) are of the same model and activated by an external motor. In fair winds (0 to 2 m/s), the increased power serves as start-up electric power, while in strong winds, an external motor serves as a power generator, the double rod cylinders serve as pumps, the pumps serve as a motor. When the weights near the right and left leading ends of the load balance are used, an output from one of a multiplex oil hydraulic pump (14), small closed circuit variable displacement oil hydraulic piston pumps (27), to rod chambers of right and left air hydraulic cylinders (9e) is set constant, and a multi polar vector control inverter permanent magnet synchronous power generator is used so that a transmission gear such as a spiral bevel gear rotates slowly at about 100 rpm, but a squirrel cage induction generator may be used. Generated power is transmitted to a commercial electric power. A power increased by the pressure load equipment coupled with a crank mechanism via a torque converter automatic transmission (86) balances with inertia of a flywheel (8) at a lower portion of a power generator (11), the power increased is combined with an output of the power generator, then transmitted. When the wind turbine has a power generating capacity o 1,000 kW, and a power generation output of the increased power of 500 kW is input in the fly wheel, a combined power of 1,500 kW is generated. A power generator of about 2,000 kW is used, average wind speed is set at around 8 m, in strong winds of 16 m to 20 m, a pitch is adjusted to lower revolution output of power generation, and in stronger winds, axes of blades are rotated so as not to be subject to wind power. In this structure, an existing horizontal axis wind turbine is modified by extending a rotating axis to the ground, a torque converter serves only as a clutch, and both are adapted for independent power generation.

With regard to horizontal wind turbines, those of large-size are employed as mainstream. However, a size is limited because of a turbine structure and a nacelle power generator having a tower, and solar, wind power generating systems depend on natural forces, therefore is inefficient compared to thermal, and water pressure power generating systems. The wind turbine power generator of the present invention is constructed in such a manner that one of vertical axis wind turbine power generators having a power generator on the ground, a Darrieus wind turbine power generator is formed into a multi polar, low revolution, vector control inverter synchronous power generator, in spite of the structure of blades which require a driving force by a wind power of 2 m/s or more, and a construction comprising variable pitch blades, a plurality of blades, an a forward reverse rotating blade axis, and input from balanced construction of an increased power from the pressure load equipment and a fly wheel allow a power generation which can be driven even in wind power 2 m/s or lower, therefore, the wind turbine power generator of the present invention is more efficient than a horizontal axis wind turbine power generator.

### EXAMPLE 5

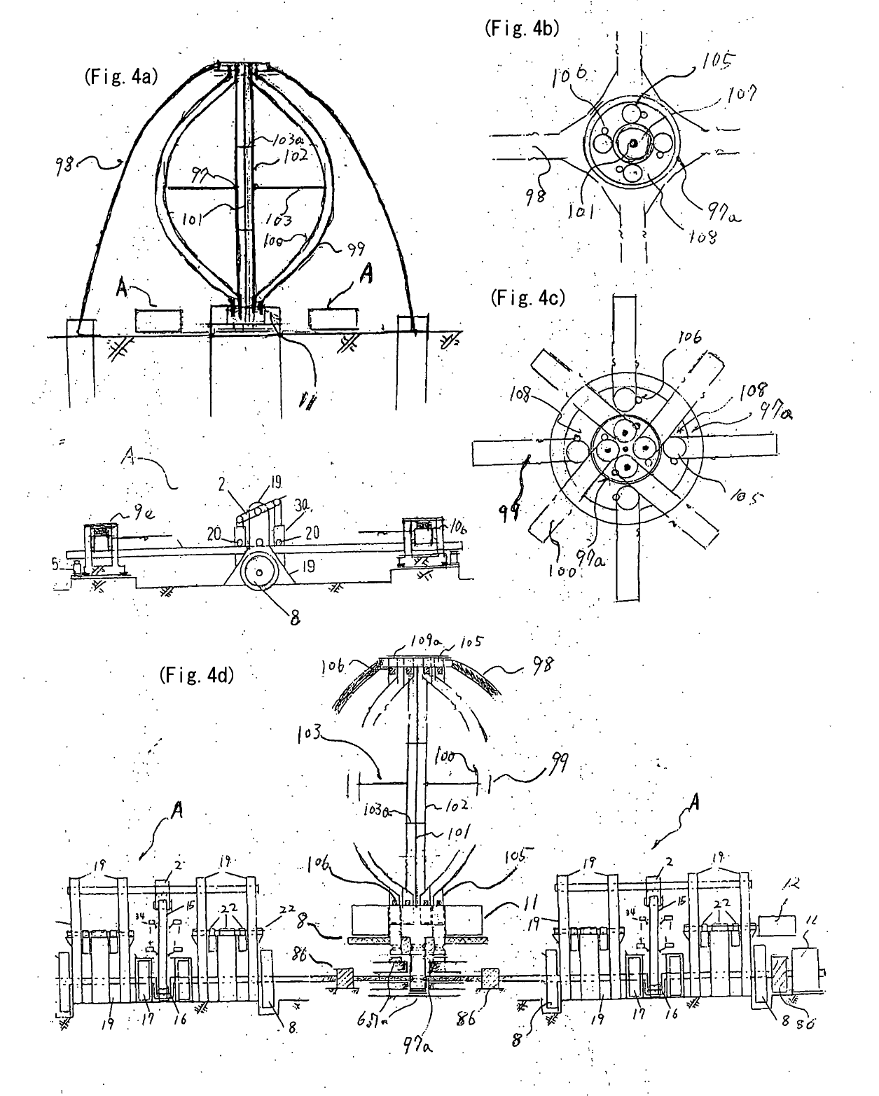

An arcuate Darrieus wind turbine comprises outer blades only, two right and left arcuate blades or a plurality of blades, and rotates only in one direction. A center axis and a tower portion are not provided, and a structural material is fixed on the ground with a semicircular frame member (98) surrounding right and left upper blade shafts on three or four sides. An upper magnetic bearing (97a) and a lower magnetic bearing (97a) of a coupling structural member are adapted for a center bearing portion (107), as illustrated in FIGS. 4b and 4c, an upper blade shaft (105) and a lower blade shaft (105) which are integral with the blades are fitted in the center bearing portion, the upper blade shaft (105) and the lower blade shaft (105) are engaged with an oil pressure or electric spinning motor gear (106), and tightened and fixed by an automatic brake band. By rotation of the oil pressure or electric spinning motor gear (106), right and left, individual blade shaft is moved to an optimum position, this enables self-rotation by slight wind speed. As illustrated in FIG. C, in strong winds, or the like, upper and lower ends of blade plates (100) slide in sliding holes (109) in a shaft to disperse stress and a pitch adjusting portion of an oil pressure and an electrically driven apparatus is activated. Since a center shaft extending between upper and lower center axes is not provided and the structure with blades only is light weight, a slim reinforcing shaft center axis (101) may be used. The right and left blades may be reinforced by a horizontal reinforcing portion (103) at upper or lower middle portions.

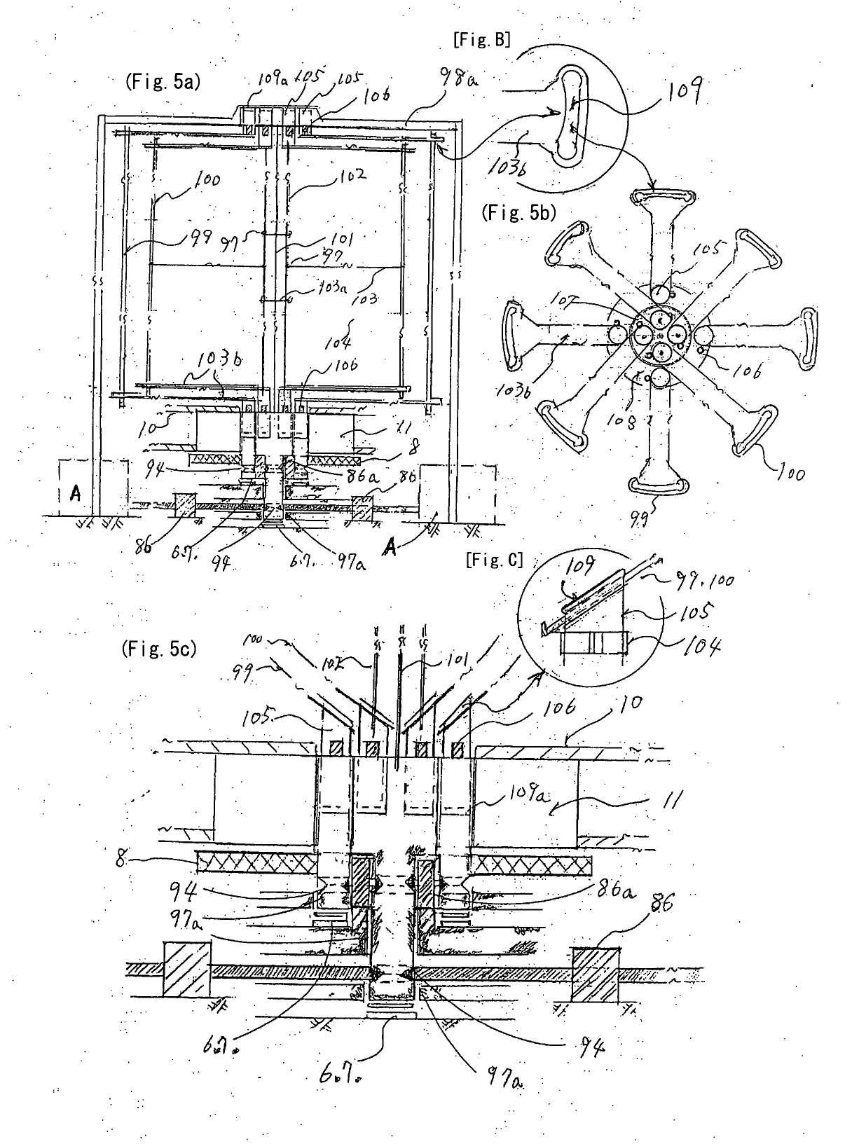

A vertical axis wind turbine as illustrated in FIG. 5 also comprises outer blades only, right and left straight blades, as in the above. As illustrated in FIG. 5b, the method for bearing is the same as above. As illustrated in FIG. B, as a countermeasure against breakage, fatigue, or the like due to stress on blade plates (composite materials such as duralumin, stainless steel, plastic materials) caused by strong winds, the same structure as above is constructed, for a portion in which a horizontal plate (103b) is inserted a slide structure (109) is applied for inserting both ends of the blade therein, blade plate surfaces (as for shape, a lift pressure plate type enabling forward reverse rotation or a general aircraft wing type, of structure allowing unidirectional rotation) are not fixed, and held in an inflexible state, thereby the stress is eluded. Both equipment surrounded by frame fixture member on three or four sides, and the blades are subject to winds and rotate. A low revolution, permanent magnet synchronous power generator (11) is provided on a lower portion of the center shaft, near the ground, and a flywheel (8) is provided under the power generator, to balance with a power increased by the pressure load equipment. Weight of the blade is reduced and floating structure is constructed by repulsion of magnetic force of an permanent magnet (7) and an electromagnet (6) provided in a lower bearing portion. Employed is a structure for reducing load of stress on the blade plates by three points (109, 109e and floating by magnetic force). Self-rotation of the blades may be achieved even in winds at 2 m/s or less, thanks to floating structure, variable pitches and rotation of blade shafts. By fixing four sided semicircular frame members on the ground, a wind turbine which is constructed larger than a present Darrieus wind turbine may be installed on an installation area smaller than the present Darrieus wind. By eliminating a tower and an axis shaft and providing upper and lower shafts at center of right and left blades, the structure of the blades are light-weight. An intermediate gear of a crank mechanism of a reciprocating oil pressure transfer unit of a gravity power generating unit (A) using balances and having pressure load equipment is coupled with an axis of a vector control inverter permanent magnet synchronous power generator via a torque converter automatic transmission. A power such as oil pressure, air pressure of the pressure load equipment on a leading end of the load balance is increased according to a ratio of the balances, and a closed circuit variable displacement oil hydraulic piston pump with an external electric power (25) which connect both double rod oil hydraulic cylinders (3a) of the reciprocating oil pressure transfer unit is activated by an external electric power, the increased power is placed on the cylinder piston for pressurization, an output increased by increasing oil quantity is input in a power generator. A vector control inverter motor (12) of a multiplex oil hydraulic pump (14) is switched to operate by the external electric power which is an electric power generated by wind power, the electric power generated by wind is combined with an electric power generated by the gravity power generating unit. The power generating system is structured by coupling and engaging the wind turbine power generator for wind power generation and the gravity power generating unit using the balances and having the pressure load equipment with one another for the purpose of increasing power generation during drive by wind power.

### Embodiment 6

Places suitable for obtaining wind power constantly are an area on the Sea of Japan side in winter, and areas such as straits and mountains in all seasons. A power generator in FIGS. 4 and 5 allows for increasing a power generation in variable winds, within limited time period, in such places. In the above system, the structural member is fixedly on the ground with the use of semi-circular frame member which surrounds upper and lower portions of right and left blade shafts on three or four sides. It is a Darrieus wind turbine comprising a set of blade shafts in the structural member. In the structural member, two sets of the blades, an outer set and an inner set of the blades rotate in forward and reverse directions, respectively. A support base for upper and lower shafts are fixed completely on the ground, a plurality of sets of Darrieus wind turbine blades are provided and surrounded by the structural member of the semicircular frame member on four sides. As illustrated in FIGS. 4b, 4c, and 5b, the inner set of blade shafts (107) and the outer sets of blade shafts (108) are fitted in two sets, an upper set and a lower set of magnetic bearings (97a), blade plates are mounted in a mounting hole (109) so as to be slidable and adjustable in pitch, for eluding strong and light winds, thereby loads of stress such as flexure, torsion are eliminated, and upper and lower plays (109a) are provided between individual blade shafts (105) and entire, outer and inner shafts (107, 108). As illustrated in FIG. 5c, two sets of blade shafts fitted therein are coupled with the use of a torque converter transmission (86a) so as to be switched in forward and reverse rotating directions, and an axis of the power generator (11) is rotated in one direction. The purpose of this is that the blades are rotated in forward or reverse directions corresponding to wind power, thereby stresses applied onto an axis of the frame structural member is offset and balanced. Two power generators may be installed in separate places, an upper place and a lower place, on the ground and on an axis of an upper portion of the tower for combined power generation. Friction resistance is decreased by variable pitch, adjustable rotation angles of the blade shafts, and combined use of a bearing (97) and a magnetic bearing (97a) which supports weight of blades and provide the blades with floating force by using attraction and repulsion of the permanent magnet (7) and the electromagnet (6), for the above mentioned upper and lower bearings. Since a tower is not provided, and a floating force is provided by wind power, a power may be generated by slighter wind speed. A directly-connected, a vector control inverter, low revolution, multi polar permanent magnet synchronous power generator (11) is used. This vertical axis power generating system comprises a plurality of sets of blade shafts rotating in forward and reverse directions within one wind power generating structural member, and thereby a generated power is doubled.

### Embodiment 7

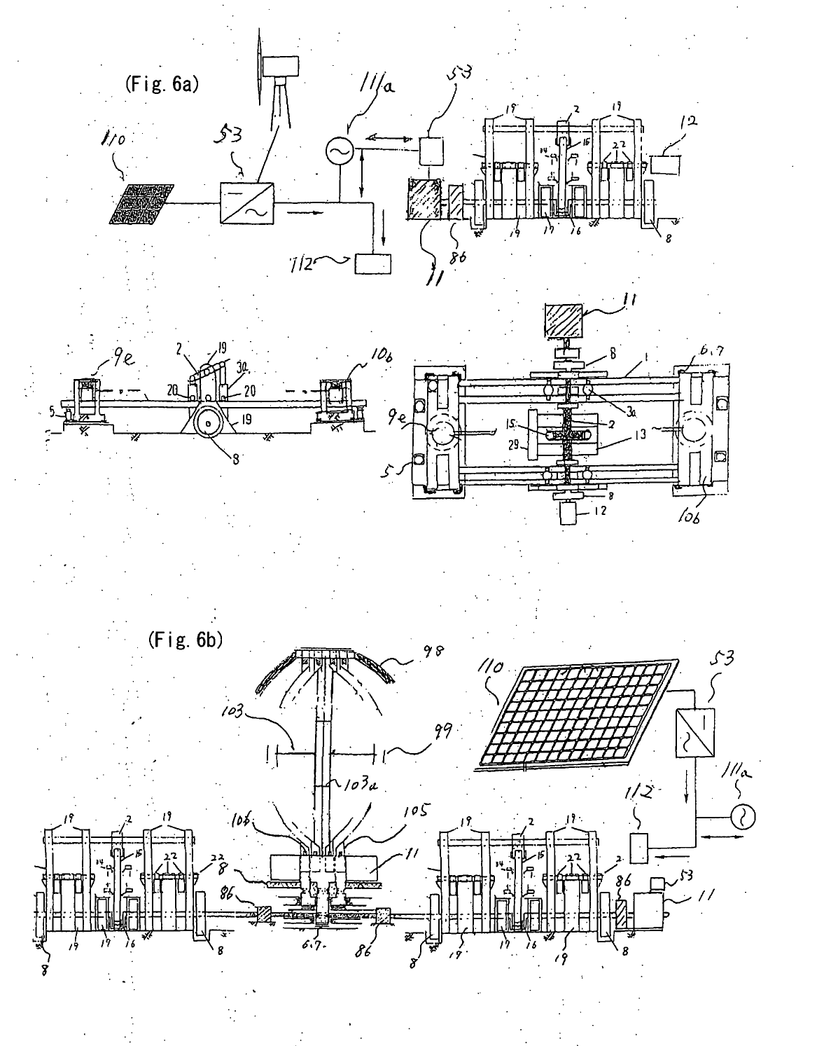

A solar power generation as illustrated in FIG. 6 generates electricity in proportion to daylight hours and the number of the solar panels (110), electricity generated is connected to a commercial power supply (111a) under inverter control by a power conditioner (53) or stored (112), and solar power generation is inefficient generation similarly to wind power generation. The solar power generation is required to increase production of electricity in the limited hours. A gravity power generating unit (A) using balances and having pressure load equipment corresponding to production of electricity of a large-size solar power generating station is installed, and is coupled and engaged with the power generating station. The pressure load equipment is constructed by using an oil hydraulic cylinder (9c), a pneumatic cylinder (9d), an air hydraulic cylinder (9e) using a weight as in the wind power generation. As for the closed circuit variable displacement piston pump of the reciprocating oil pressure transfer unit in a multiplex oil hydraulic pump driven by an external driving power engine, in the solar power generation, instead of a mechanical coupling of a power generator of the engine (water power, thermal power, wind power, water flow) and the gravity power generating unit, a power from solar power generation is used for the motor of multiplex oil hydraulic pump of the reciprocating oil pressure transfer unit and the pressure load equipment. Therefore, constructed is a hybrid power generating system which combines the power generated by inputting a power increased by the weight, oil pressure and an air pressure in double rod cylinders (3a) and a power generated by the solar power generation.

FIG. 6a shows the hybrid power generating system of solar, wind power generators and the gravity power generating unit (A), and although CO₂ is exhausted during manufacturing of the hybrid power generating system, after the hybrid power generating system is installed, the hybrid power generating system serves as more efficient power generating system enabling power generation by renewal energy in places satisfying required conditions that sunlight, wind speed, geothermal heat or water pressure is obtained.

### Embodiment 8

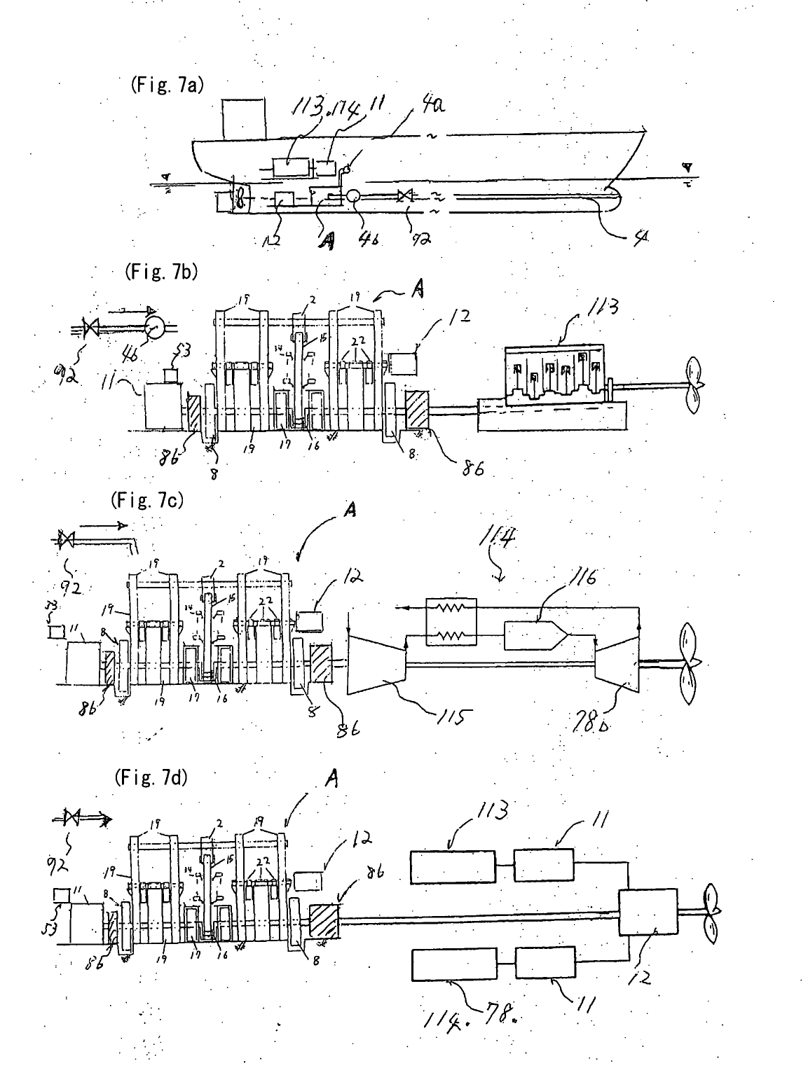

An oil, a liquefaction gas, a coal, an iron ore, a container carrier, a large special service ship, a self-navigation work vessel, a vessel, a submarine, or the like has a propeller shaft of a diesel engine, a gas turbine engine, a nuclear power or a motor propeller shaft from a power generator. Technology for motors for driving ships with fossil fuel has been almost completed, and it is required to operate a ship for a long period of time at low fuel cost. In FIG. 7b, a large diesel engine of low or middle revolution couples a gravity power generating unit with flywheels or the like on a front part of an engine. In FIG. 7c, a gas turbine (114), a nuclear power steam turbine are of a high revolution, and a propeller shaft is coupled with an intermediate gear shaft of a crank gear of a reciprocating oil pressure transfer unit via a reduction gear device for reducing a speed to primary low speed and a torque converter automatic transmission. In head chambers of right and left large double acting single rod water pressure cylinders (9a) of the pressure load equipment, a low water pressure generated with the use of own ship speed is applied through a water pressure pipe (4) from a bow of the ship, a double acting single rod steam pressure cylinder (9a) is used, steam pressure is applied from a boiler (77) by cooling a gas turbine, or steam pressure is applied from a boiler (77) of nuclear power, each steam pressure is injected in a head chamber of the cylinder via a pressure/flow rate control electric valve, thereby a pressure on the leading end of the rod is obtained. The pressure is placed on the right and the left of the load balance, the load is applied constantly thereto, and transmitted to the double rod oil hydraulic pumps (3a). When a high pressure force is required by water flow of self-navigation vessel, a high-revolution water pressure pump (4b) is provided in a water pipe, a gravity power generating unit (A) using balances and having pressure load equipment is installed in an engine room in the vessel, above and under full load draft, a double rod water pressure cylinder or a single rod water pressure cylinder is used instead of a reciprocating double rod oil hydraulic cylinder, and a water pressure to be applied is about 1 Mpa to 2 Mpa, ten times or more of the pressure which is to be obtained by own travelling speed. The right and left head chambers are communicated with one another by a closed circuit, a solenoid ball on-off valve (67a), discharge valve (68a) may be provided, and both upper and lower chambers may be constructed to be activated by water pressure. An oil pressure pump of an external motor, or a stored pneumatic cylinder which is activated by a pneumatic cylinder may be applied for a pressure load cylinder. The above is a structure with an engine directly connected, and a torque converter automatic transmission is coupled to a motor propeller shaft vessel serving as a power generator, and with a propeller shaft motor (12). Then, equipment generally similar to the pressure load equipment and a reciprocating oil pressure transfer unit in the water power, thermal power and wind power generations is constructed. In a large ship, output of load pressure is generated by water flow corresponding travelling speed of the ship, and it is coupled with an engine power generator as a propulsion force, a propeller shaft motor, or an engine. In ships or the like navigating for a long period of time, water flow caused by own navigating speed generates load pressure. When the speed of navigation is raised, fuel cost is saved. In a structure here, an engine power generator as propulsion, a propeller shaft motor or an engine of a large ship is coupled with the gravity power generating unit (A) using balances and having pressure load equipment. A water pipe (4) has an aperture diameter of 20 cm, a sectional area of 314 cm². A navigating speed is 16 to 18 knots, that is, a flow rate is 9 m/second, and pressure of about 0.1 Mpa is applied from a bow of the ship. A pressure cylinder has an aperture of 2.0 m in diameter, 3,000 m², pressure of 0.5 Mpa is applied on the pressure cylinder via the pressure/flow rate control electric valve, a stroke of 5 mm causes 15 L/second, loading time period is 1 second, a solenoid ball on-off shutoff valve, discharge valve are used for a quick valve, 50 L/second results in a power of 50 t which is increased to 900 t according the ratio of the balances 1 to 6. For example, a ship navigates at 16 knots, with nominal rotary drive of engine output, motor shaft output, power generator output of 10000 kW. A closed circuit variable displacement oil hydraulic piston pump (25) of a reciprocating oil pressure transfer unit is activated by an auxiliary motor (12). Output of the closed circuit variable displacement piston pump of a small capacity double rod oil hydraulic cylinder (3a) which is coupled with a main engine with a torque converter automatic transmission (86) will be increased as follows. Pressure of 900 t is placed on a piston moving between upper and lower chambers of a closed circuit double rod cylinder (3a) at 1 m/second, the pressure will be an output of a motor of flow rate, and flowing speed pressurizing the piston, and correspond to the conditions stated in Embodiment 1, 30 L/second, 1,800 L/minutes, 2.0 Mpa. Operation capacity of two closed circuit variable displacement piston pumps may be increased by several times, 600 kW may be obtained, the power of 900 t is decreased to almost half, output of 500 kW due to factors such as resistance loss, output of a propeller driven shaft is increased by 50%, to 15000 kW, and the speed will simply be 20 knots or more. As stated above, for output of an electric pump which generates high pressure through intake of water, output of 600 kW, greater by several times is applied, for the pressure load equipment, load of 2.0 Mpa, 18 L/second is applied, then the power is doubled to 3,600 t according to the ratio of balances as in Embodiment 1. Diameter of upper and lower chambers of the double acting double rod water pressure cylinder, and diameter of upper and lower chambers of the double acting single rod cylinder are arbitrary. Water pressure is about 2.0 to 3.0 Mpa, and water volume used by both cylinders is 50 L/second. The cylinders are constantly communicated with one another by a water tube, an electric power is required only for opening and closing a solenoid ball on-off valve and discharge valve, and output of a motor of the closed circuit variable displacement piston pump (25) requires only small horsepower just for moving a hydraulic oil between right and left cylinders, by making one of upper and lower chambers, a rod chambers to an oil pressure chamber of very small capacity. Then, the increased power is simply doubled, and the output is also doubled.

### Embodiment 9

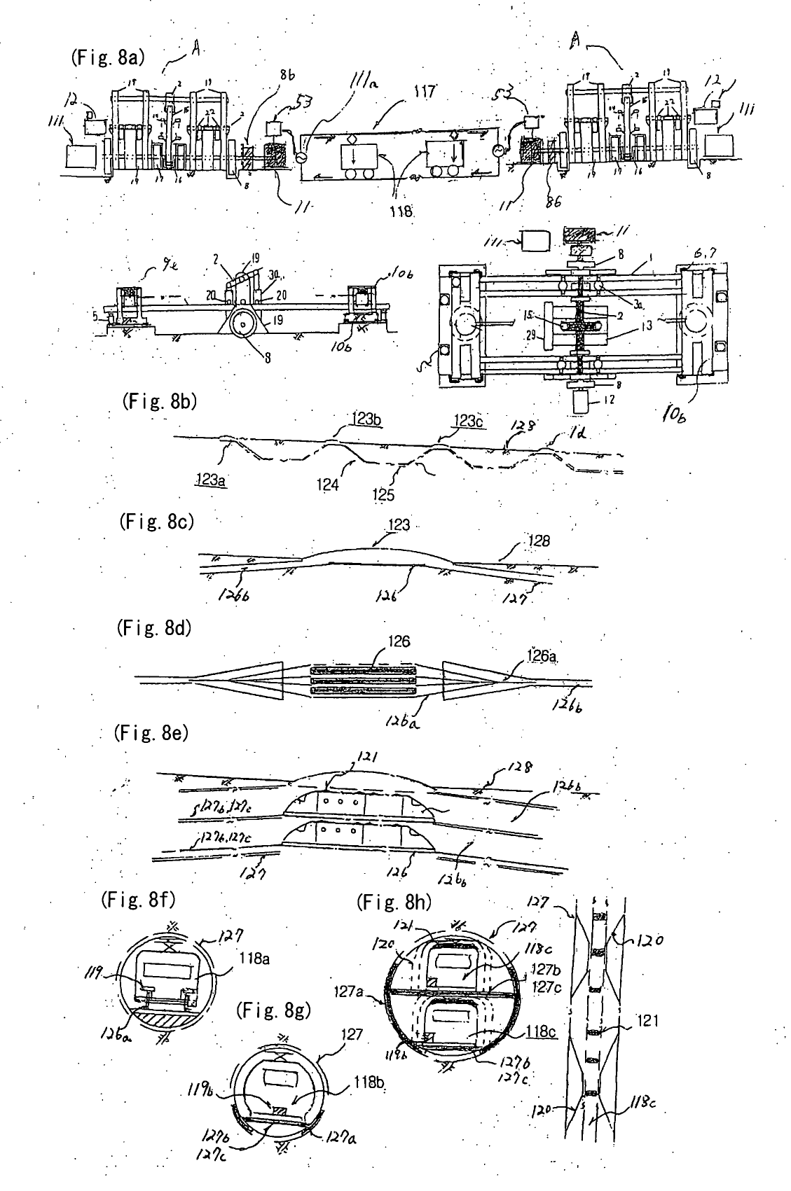

In train service as illustrated in FIG. 8, direct current or alternating current electric power is used for operation of entire number of train services on entire railway routes including uphill and downhill routes by transmitting required electric power via overhead cables. In variable train service such as local train service, and limited express train service, from when a train starts till when the train runs at a nominal velocity, electric power consumption will be decreased when the train operates with inertia driving force, and an electric power when a regenerative brake is used during deceleration is returned via overhead cables, in alternate and direct current trains, the electric power more than required for total number of train services is transmitted, for safety purpose, and the electric power is input from a gravity power generating unit (A) using balances and having pressure load equipment to the aforementioned squirrel-cage induction generator (11). Oil pressure force of two closed circuit variable displacement piston pumps (25) in a multiplex oil hydraulic pump, provided between upper chambers and between lower chambers of a double rod cylinder (3a) of a reciprocating oil pressure transfer unit, and oil pressure force of one close circuit variable displacement piston pump (27) in the multiplex oil hydraulic pump, provided between rod chambers of the aforementioned right and left oil hydraulic cylinders, pneumatic cylinders, air hydraulic cylinders (9e) relative to a weight, of the pressure load equipment, a power is increased by loading alternately on right and left of the balance according to a ratio of balances and an output from increased oil quantity and a generated power of the squirrel-cage induction generator obtained from right and left crank mechanism an intermediate middle shaft are transmitted to a general commercial electric power. The increased power is from a single acting air cylinder (5) which is a device for gradually inputting the increased power, and is balanced with an output, based on a rotation sensor such as a power generator, as programmed by a controller, by using the squirrel-cage induction generator, a motor. A hybrid power generating system is constructed by coupling the gravity power generating unit using the balances and having the pressure load equipment, generating a power using a regenerated electric power.

### Embodiment 10

In construction of a high-speed underground electric railroad in a town area as illustrated in FIG. 8, a single and level track (125) through a tunnel is constructed underground at a depth of about 50 m within the bound of the law. When total distance is supposed to be 30 km, there are five stations from a starting station (1 a) to a terminal station on an aboveground part, a distance between adjacent stations is 7.5 km, each station has three platforms (126), and four to six trains can stop at the station. Each of uphill zone and a downhill zone (124), between a platform and a level zone, is about 1 km, and is adapted for speed-up and slowdown zones. Each section between adjacent stations is connected by an uncurved straight track of a standard gauge or wider gauge. An electric power is fed from a substation at 20,000V. A train having about 10 cars can accelerate to a maximum velocity 350/h. Three cars/train are driven by a three phase alternating current bipolar VVVF inverter vector control high-output squirrel-cage induction motor with output 300 kW. A light-weight low-floor train for which an aluminum alloy is much used is used. The low-floor train has wheels of diameter of 700 mm, six drive axles in a car, and output power is obtained by reduction gears of eighteen motors in three driven cars. An organized output is 5,400 kW/h, a train accelerates to a maximum velocity on a downhill zone of 1 km, then slows down by a regenerative brake and operates with inertial driving force, then slows down again on a uphill zone, and arrives and stops at the platform. It is provided with a transformer, a rectifier and various kinds of control devices, uses a pneumatic brake, and height of bearings is equalized with that of a floor portion by applying small wheels as illustrated in FIG. 10d, 10e. The low-floor train is constructed in such a manner that the wheels are accommodated inside the floor, under seats (119, 119a) on a side wall so as to meet wide rail gauge. An electric power is regenerated by acceleration and braking during operation on a downhill zone along a straight track. For the purpose of enhancing resistance against speed, each of three cars, leading, middle and rear ones is provided with 12 wheels on six axles, and driven by a reduction gear motor, and each of seven cars is provided with non-driven eight wheels and adapted for a passenger car. On a level zone, the train runs at 250 km/h to 300 km/h, then stops. After that, during running on downhill, acceleration by a potential energy is suppressed by regenerative brake. A distance of 700 m of the downhill zone to a level zone is adapted for power regenerating zone. The regenerated power is returned to electric substation equipment installed on the starting station and the terminal station, the power is transformed to low voltage, and input in a vector control inverter motor (12) of a gravity power generating unit (A) using balances and having pressure load equipment to activate it, then intermittent electric power is converted to rotating force at a flywheel (8) of a crank mechanism.

The adjacent stations are connected with a straight track, an uphill and downhill slope of the same inclination of the same inclination is repeated alternately, required time for passenger interchange is about 1 minute, and a train runs on a route of 30 km, from the starting station to the terminal station, five stations away from the starting station, in twelve minutes. Velocity along a straight course is 300 km/h, namely 5 km/minute, an inclination angle of a downhill course of 1 km is 20 to 1, and acceleration time period is about 20 minutes. Each uphill course until when the train stops is the same in inclination angle and distance, the train runs along the uphill course of 1 km in about 40 seconds, decelerating from 300 km, and it takes 2 minutes for the train to run all the way of 7.5 km. The train runs along the regenerative brake zone of the downhill course in about 10 seconds, and the regenerative brake is properly used during uphill run, and it is almost offset with generating energy during downhill run. The gravity power generating unit is adapted for increased power is converted to power generation, and the power generated may cover most of electric power required for acceleration and level and inertia operation of a train.

And, in about 5 seconds after starting along the downhill course of 1 km and inclination of 1/20, and at a point of 100 m from a start, the train accelerates to about 150 km/h, in about 10 seconds, at a point of about 300 m to 400 m, the train accelerates to 400 km/h under an action of potential energy, and the rest of the downhill course of 700 m of travelling time 10 seconds is adapted for the regenerative brake zone. The train decelerates average velocity to 300 km along a level course while regenerating power, along the uphill course to the next station the train runs with inertial driving force, without deceleration. Regenerated electric power of a plurality of inbound and outbound trains is returned to each substation equipment (111), and this intermittent electric power as described in detail in Japanese Patent No. 4367795, etc. is input in an vector control inverter, three phase alternating current, six polar, squirrel-cage induction motor (12), 10,000V, about 5,000 kW/h of the gravity power generating unit (A) using balances and having pressure load equipment in which a flywheel is provided, and the squirrel-cage induction motor (12) provides driving power to two closed circuit variable displacement piston pumps (25) of a multiplex oil hydraulic pump, between upper chambers and between lower chambers of double rod cylinders (a) of the aforementioned reciprocating oil pressure transfer unit, as illustrated in FIG. 17a, an oil hydraulic cylinder (9c), a pneumatic cylinder (9e), and one closed circuit variable displacement piston pump (27) for rod chambers of right and left air hydraulic cylinders (9e) relative to a weight (10b). Attraction and repulsion forces from excitation of an electromagnet on a balance (6), a permanent magnet (7) on the ground assist alternating loading and unloading (contact with the ground) repeatedly. The load of 100 t which is applied alternately on the right and the left is increased to a power of 600 t according to the ration of balances, 1 to 6. The increased power is placed and pushes alternately on right and left double rod cylinders so as to move the right and left double rod cylinders up and down, the power increased (corresponding to the plurality of the trains) by oil quantity increased to an extent within variable displacement of the variable piston pump is again transformed at the substation equipment (111) as a generated power of 10,000 kW/h of the vector control inverter, three phase alternating current, six polar, squirrel-cage induction motor (12), to be returned to a trolley wire, or to be transmitted to a commercial electric power of low voltage. A pressure load (weight) balance (1) at a lower position is long in length, a reciprocating balance (2) at a higher position is short in length, the upper and lower, two step balances are linked and connected by double rod cylinders (3a) on the right and the left of a fulcrum which is fixed on the ground. A power increased by loading alternately on right and left, according to the ration of the balances is input gradually by discharge of single acting air cylinders installed on the ground which is adapted for inputting the increased power gradually. Each solenoid valves and detailed circuit diagrams for controlling each apparatuses are illustrated in FIGS. 13, 14, 15, 16 and 18. A vector control inverter, three phase alternating current, six polar, squirrel-cage induction power generator is used under control of a programmed controller (53) based on detection by a rotational sensor of a power generator or the like, and a power generator having an output for balancing an output of the train and commercial electric power as load is used. A course of 700 m in a tunnel, starting from a position about 400 m from a platform to an underground level position, is adapted for power regeneration zone, and a total electric power which is consumed by four trains running through four tunnels at the same time, is 21400 kW/h and the regenerated power is returned to each of a plurality of the gravity power generating units (A).

According to one of ideas of train services, a travel time required for adjacent stations including passengers interchange is three minutes. Two trains (pair train service) departing from a starting station, a first station (123a), arrive at the next station, a second station (123b) in six minutes, two trains which wait at the next station immediately start for the starting station (123a) in the opposite direction. And initial two trains departing from the second station arrive at a middle station, a third station (123c) in six minutes, while two trains waiting at the third station (123c) depart from the third station, arrive at the second station in six minutes, and wait at the second station. When two trains depart from the third station and arrive at a fourth station (123d), two trains waiting at the fourth station depart for the third station. The initial two trains are to depart the fourth station for a terminal station, a fifth station. The trains which arrive at the third station from the starting station, the first station, and the trains which arrive at the third station from the terminal station, the fifth station, will depart from the third station simultaneously. The third station is located at center of the total distance, at the same distance from the starting station and from the terminal station, and is an important station where inbound and outbound trains wait for adjusting departure time. When a person gets on a train, timing departure time of trains which depart a station prior inbound or outbound two trains, he/she arrives at the next station in three minutes. If he/she misses his/her intended train, he/she can take a following train and arrive at the next train in 6 minutes. The travel time between two stations is six minutes, and that from the starting, first station to the terminal, fifth station is 24 to 25 minutes. In operation with single train in a three minute interval, the travel time is a half, twelve minutes.

In the express railway service here, the rail gauge is a standard or wider gauge, the number of cars in a train is decided on corresponding number of passengers, and each of parts, components, and the like is as per common specification as other railway trains. Light-weight aluminum alloy is used, and a low-floor train (118a) which travels stably during acceleration to high speed.

In order to deal with travelling along the downhill acceleration zone, right and left handrail stands (137), and hand straps are provided. Windows or the like are not required since a train operates in tunnels, width and position of a passenger door, etc. is freely designed. The single railway line and aboveground stations are housed in buildings. A small-diameter wind shielding tunnel does not allow birds, dogs, cats and the like. Counter measure against accidents, etc. must be perfect. Instructions are given by control station, confirmation of safety equipment of each tunnel is instructed, and operators of trains between two stations cooperate and confirm each other. When one train starts after stops, power source of the other train automatically turns off. As such, secondary and tertiary safety structures are provided. Considering emergency stop in a tunnel by earthquake, evacuation on foot from a railway tunnel, etc., the train service is provided with full-scale preparations such as battery facilities, ventilation facilities, and water pressure pump for water seepage, humid, humidity, flooding, etc.

The cost for excavation of a single track tunnel is lower than that for excavation of a double track tunnel. Even allowing for the increased cost in providing two more platforms at each station, the related cost such as cost for purchase of private land, cost for seeking permission for underground construction, is saved by using deep underground. A straight railway service which appeared to be impossible is now possible, a travelling time is now short, and an electric power to be consumed is almost supplied by the gravity power generating unit (A) using the balances and having the pressure load device installed. Each station has a hub function. Since the present railway system is different from existing railway services, mutual exchange is not possible, but a passenger may change from a train to other transportation such as bus at the platform, or the train service cooperates with other transportation service such as route bus service as much as possible on convenience for passengers’ to transfer transportation means. The present train service provides a single track railway operation which allows a train to operate along one section in three or four minutes.

In a single track straight railway with broad gauge of a low-floor rotation induction motor train as illustrated in FIG. 8f, width of a tunnel is 6.0 m, in a railway service of the magnetically elevated linear motor train in FIG. 8g, width of a tunnel is 5.0 m because of no wheel, and in FIG. 8h, a tunnel is divided into upper and lower parts, with vertical width is about 8.0 m and magnetically elevated low-floor linear motor trains (floor level about 2.5 m) are separated on two tracks, respectively. Eight shield machines excavate ground from sites for five stations down to middle portions of right and left level zones, excavation is carried out at the same time as construction of platforms at each station. It takes three yeas to complete. Since a straight course also includes a private land, a tunnel is excavated in a zone at 50 m or more depth. For a course from a slope zone to the station, a public land is used as much as possible. Construction cost includes cost of excavation of four sections, cost of construction of five stations, cost of construction of three platforms at each station, cost of 60 high-speed trains, cost of shielding and laying tracks all along the line, cost of facilities such as an electric facility, cost of manufacturing trains, and cost of purchase of private lands and the like relative to stations. Shield tunneling for eight sections, manufacturing trains, construction of stations and the like on five sections, and others are contracted by an entrepreneur.

### Embodiment 11

In the single track small-diameter tunnel in FIG. 8g, employment of an onboard primary member type magnetically elevated linear motor train (118b) costs a lot of money at present, in view of costs of maintenance of tunnels, costs of tracks and train cars, compared with a low-floor rotation induction motor train. However, a magnetically elevated linear motor train (118b) has an advantage that it can be small-sized. The vertical width of the train, from the ground to a pantograph is made about 3.3 m, a car body is made smaller, and a structure for collecting a power from a current collector shoe may be provided on the ground, and cooling equipment to be installed in a ceiling may be disposed under seats (119b) of side walls near floors or the like, thereby a car body having a lateral length longer than a vertical length may be constructed. On a roof, only pantographs and pressure plates (121) are provided, and a train car having a length 3.3 m or less from a magnetic elevation structural frame member (127c) to a trolley wire may be manufactured. It is not necessary to provide windows on passenger cars. Handrail stands are provided in two rows on a floor, handrails and hand straps are provided on right and left side walls. Passenger cars may be designed with priority on boarding and alighting. Seats for the handicapped (119b) are provided on side walls near floors and the like, and a cover portion fitting with height of both air conditioning equipment and control equipment (transform facility) is used.

As shown in FIG. 8h, a shielded tunnel including shielding concrete segments (127) and the like has a width of 8.0 m, and is divided into upper part and a lower part, thereby operation on double track is possible. Partial steel segments (127a) and a steel frame member (127b) for dividing into the upper and lower parts are adhered and fixed with one another. Different from an existing concrete base, the steel frame member is adapted for a thin car body base which can be easily constructed on the ground and is completely fixed with proper space. The car body base is integral with a linear drive and magnetic elevation structural member (127c). The upper and lower tracks are blocked from one another. Wind pressure caused by linear operation at high speed is caught by a wall surface of the steel segments (127a) and a pressure plate (120) (an angle-adjustable triangular plate capable adaptable for reverse operation in a tunnel of distorted shape) catch winds, and adapted for directing wind power blowing against the plate to a car body from upper, right and left sides thereof to restrain the car body from shaking by applying the air pressure to the car body. The pressure plate (120) is mounted on a steel member which supports each of separated upper and lower steel frame members (127b) from above and below. A car body roof pressure plates (121) for keeping a space between a car body roof and a tunnel are provided and spaced at arbitrary intervals. When an entire length of train cars is 180 m, the pressure plates are spaced about 20 m apart on a side surface, 10 m apart on the roof, both plates are spaced 30 cm apart, and the train runs at 300 km/h, average pressure of 0.05 Mpa is applied to the car bodies from top, right and left sides. In a rotary motor train in FIG. 8f, a car body is heavy because of wheels, is provided with plates on rails and an underside of a floor for reducing an air flow, and pressure plates are not provided. The applied technique of magnetically elevated, wheel type linear reduction motor train is disclose and used practically in various areas. With regard to the magnetically elevated linear motor train, train cars, tunnels and output structure are suitably selected, and a regenerative brake or the like are the same. There is no obstruction to use the above for modifying a design of small size-train car for single and double tracks for small sizing of a diameter of a deep underground tunnel. Practical application of an onboard primary member type superconductive elevated linear motor train will be in progress in near future, but commercial operation at 500 km/h is a problem now. It is required to start with practical commercial operation for a proper short distance.

### EXAMPLE 12

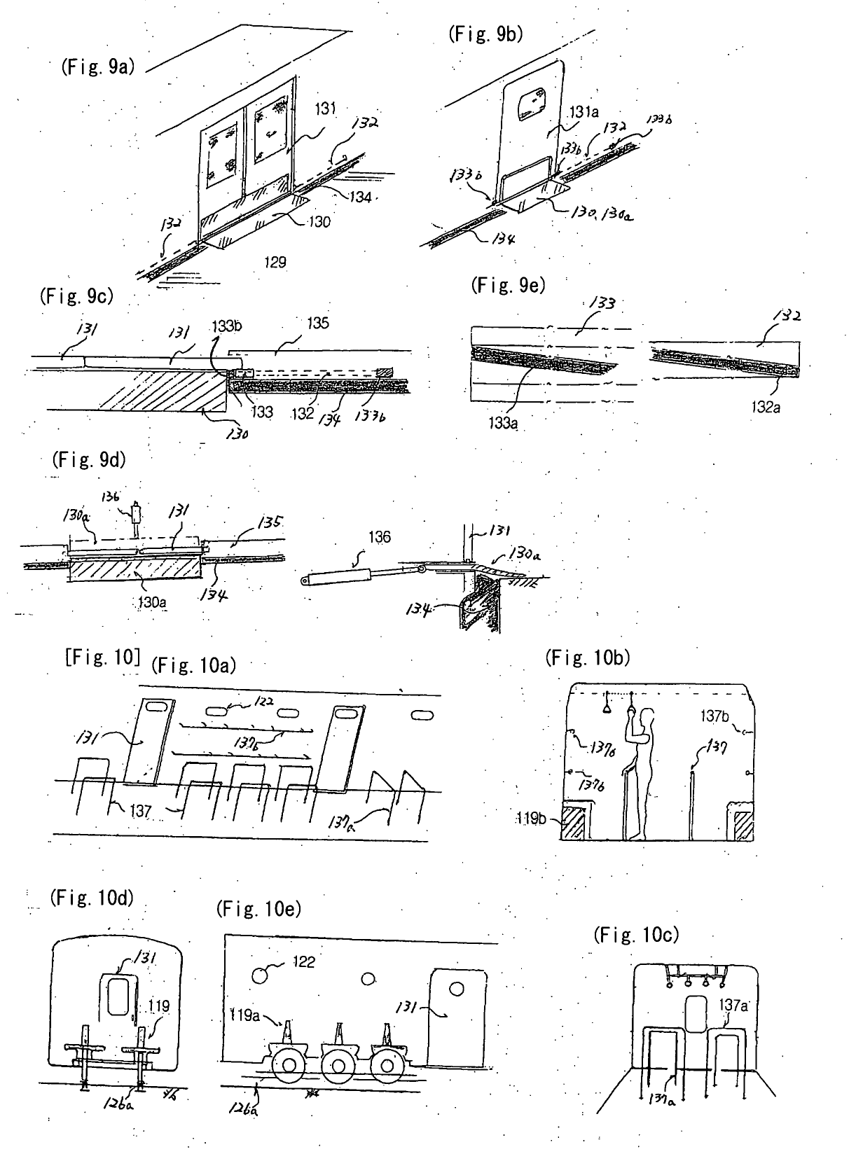

This is not limited only to the high-speed underground electric railway of the present invention, when a passenger cars of a train stops, a gap (134) and a level difference defined between a floor adjacent to a passenger door and a platform (129) varies among railway companies. A passenger step of a train in FIG. 9 is provided for allowing passengers with a carry-bag or a baby baggie, a passenger in wheelchair, or a handicapped passenger for getting on and off the train safely, surely and swiftly. The step (130) of a thin sheet of metal plate, rubber, plastic material or the like is constructed so as to turn automatically in front of rails of the door. The step positioned in a space defined a side surface of a door housing portion facing the car body and a front surface of the door, and the step automatically turns simultaneously opening and closing of the door. In order to conform a straight line length of the door to a turning angle of the step, a loose externally threaded shaft (132) is used, and joined with a loose tubular internally threaded portion (133) on a lower portion of the door in the door housing portion (135). Space of right and left housing portions, in front of right and left door rails, at a position of a level of the floor is adapted for right and left bearings (133b). A crest portion (132a) of the externally threaded shaft is fitted in and engaged with a valley portion (133a) of the tubular internally threaded portion. The tubular threads are formed with a play portion (a leading end portion of the externally threaded portion is not threaded, and the step is held down with springs), addressing to shaking of the car body when the step is extended downwardly and passengers get on and off the train. Right and left coupling portions of the step (130) are fixed to the externally threaded cylindrical shafts (132), the step serves as a turning floor simultaneously with opening the door, while the step is stored on the front portion of the door simultaneously with closing the door. A step of desired shape which varies among manufacturers is modified and installed in an existing train car, or new train car.

A cylinder (136) of pneumatic equipment or motor equipment used for a pneumatic brake for stopping or decelerating a train is provided under the floor or in the door housing portion. Closing and opening action is associated with forward-and-backward motion. In the single track, straight railway service of the present invention, all floors have constant height while all of the trains have floors of constant height. In such case, the step of a thin flexible metal plate, or hard rubber or plastic materials and the like may be extended from or retracted in a mechanism for opening and closing the door. Although this is not limited to a high-speed train, the passenger step may be integral with a side surface of the car body, not to be subject to the wind pressure. And, the step may extended before the door is open, and retracted upon closure of the door, by this construction, the structure for avoiding the wind pressure may be constructed.

### Embodiment 13

FIG. 10 shows a train which stops, a time required for boarding and alighting the train must be reduced safely and surely, in high-speed operation. Handrails (137) from the floor for smooth flow of passengers, a step (130, 130a) associated with opening and closing the door for eliminating a gap (134) and a level difference relative to a platform facilitate boarding and alighting of the entire passengers. Windows are not required because of operation in tunnels. The required number of small windows are provided. Since it is 3 to four minutes from boarding to alighting according to the structure of the present invention, a portion covering wheels, and the like is applied for the required number of seat for the handicapped (119, 119a) in the aforementioned low-floor rotary motor train (118a), and cooling equipment and the like in a roof of a train or various control equipment and the like of the magnetically elevated low-floor linear motor train are placed under the seats on a floor wall. For the rest of the floor, hand straps, etc., handrails on right and left side walls, and the floor is divided in a center of a width of a passenger car which is parallel to sidewalls into two or three parts, and proper number of proper length (about 1.2 m to 1.5 m) and of waist or hip height are provided at position except for positions near passenger doors (131,131a). The handrail stands (137a) instead of seats are partially provided, in an opposite direction of a travelling direction, and a passenger leans on the handrail stand with his/her hand holding the hand strap to elude accelerated gravity of high-speed operation. Seats are eliminated, and the handrail stands (137) are provided for smooth boarding and alighting. The passenger step turns downwardly (130) automatically with the door. The passenger steps are extended from and retracted in under the floor, thereby passengers may board and alight the train smoothly. This is not limited only to the high-speed underground electric railway, this may be applied to commutation trains, automobiles for the handicapped, route bus, and so on.

In FIG. 13, since a seal packing is made from a commercially available seals, a structure for protecting the seal packing from high temperature saturated steam pressure is required. For this purpose, an entire cylinder is constructed in a water cooling structure. A radiator core is mounted in a hollow piston rod to communicate with an external radiator and thereby to cool it, a cylinder tube is formed into a water jacket, and a cylinder is formed into an air cooling fin structure. Thereby a heat resistant structure for protecting the seal packing from the high temperature steam is constructed. When the seal packing, etc. is made by combining fluorine type elastomer of which service temperature limit is 200° C. in common use, temperature of a sliding portion may be kept within 100° C. A temperature of hydraulic oil for a double rod oil hydraulic cylinder is reduced. When pneumatic cylinder, etc. is used, an oil or grease is properly applied to a seal portion. For a double rod water pressure cylinder of arbitrary capacity, both of oil and water is applied in double rod chambers. When a single rod water pressure cylinder is used, a hydraulic oil pressure is used in the rod chamber for protecting the seal. Top ranking method for manufacturing a piston, and top ranking accuracy of hard chrome plating are employed. A composite seal packing is made by combining a polytetrafluoroethylene resin type elastomer having a good slidability and heat resistance with a fluorine type rubber, and formed into a tubular shape so as to cover the piston. The composite seal is fitted and fixed over the piston and a rod seal of a dust sealing portion for air to enter and exit, and this facilities maintenance and repair. A coupling portion of a reciprocating balance is formed to have the same diameter as the rod, and provided with removable structure. A piston rod is pulled out from beneath the cylinder. The rod seal and the dust seal are removed as a unit. By employing the tubular shape widely, assembly and disassembly are eased. The durable seal packing with enhanced sealing property may be used for water pressure and steam pressure.

FIG. 17 is a detailed view of an inside of a multiplex oil hydraulic pump. FIG. 17a, 17b, 17c are sectional views of the multiplex oil hydraulic pump which organizes pumps into one, viewed from the side. The multiplex oil hydraulic pump is a quintuplex one comprising a conjugate plate cam (42) and a forward reverse tilt plate (48) for a reciprocating oil pressure transfer unit, two, upper and lower closed circuit variable displacement piston pumps (25) of the same model, a small-sized closed circuit variable displacement piston pump (27) for loading by pressure, an auxiliary piston pump (26) in setting of open-circuit high-pressure for replacement of hydraulic oil, and a gear pump. A multiplex oil hydraulic pump unit (14) used for a water pressure cylinder (9a) of a pressure load equipment, triplex cylinders, a steam pressure cylinder (9b), an oil hydraulic cylinder (9c) and a pneumatic cylinder (9d), and quadruplex reciprocating water pressure cylinders (3b). FIGS. 17a, 17b, 17c are views showing arrangements of a drive shaft (44) from motor, drive shafts of three small-sized output pumps (26, 27, 28). The drive shaft (45) is driven by an intermediate shaft of a power generator (11) via a power transmission chain (32) and also serves as a cam shaft. The variable displacement piston pump (25) of vertical symmetry is provided with a spiral bevel gear (41). A plurality of, right and left double rod cylinders (3a) of the reciprocating oil pressure transfer unit is associated with right and left double acting single rod water pressure cylinders (9a) of the pressure load equipment so as to operate therewith simultaneously. Both apparatuses are connected with closed circuits which is filled and sealed. However, flow rate and slight time difference of pressure due to difference of pipe lines in length must be adjusted slightly. Slight adjustment of each apparatus includes adjustment of position of a limit switch (34), adjustment of a timer (38) of poppet type solenoid valves (30, 31a), adjustment of each throttle valve, adjustment of pressure and flow rate by a tilt plate adjusting bolt (52) of an open circuit variable displacement piston pump (26) set at high pressure for replacing an hydraulic oil, and adjustment of injection and discharge volume by adjusting time. Linkage of both apparatuses is balanced in regard to entire operation by adjusting time of contacting with the tilt plate by adjusting a follower (46) and a conjugate plate cam (42) through an adjusting volt (51) of the follower (46) of the closed circuit variable displacement piston pump (27) for the pressure load equipment, by adjusting the timer (38) of the throttle valve, an electromagnet (6), by adjusting magnetic force of a forward reverse excitation adjusting device (39) and so on.

A power increased from load of pressure is gradually input during the time from start-up to normal operation, load output of a power generator driven by output of a motor of an external electric power must be balanced the increased power, under control of a vector control inverter by a programmed controller (53), and is also balanced with one of load outputs, motor devices, etc. under control, and thus operation is continued.

FIG. 17d is a detailed view of two closed circuit variable displacement piston pumps (25) with a cam shaft for reciprocation therebetween, FIG. 17e shows an upper open circuit variable displacement piston pump (26) which is small-sized pump set at high pressure and adapted for replacing hydraulic oil, and a lower closed circuit variable displacement piston pump (27) which is a small-sized pump adapted for loading by weight, and FIG. 17f is a detailed view showing a conjugate plate cams (42) of the closed circuit variable displacement piston pump for pressure loading, and a follower (51) equipped with an adjustment bolt.

Accuracy (shockless property) of leakage free solenoid on-off, discharge, switch valves is important. When in and out timing of solenoid valves are controlled through relay via a timer, response is slow. In and out timing of the solenoid valves are controlled by high-performance digital timer, up and down movement is switched to cause inertial rotational movement of a flywheel, a power increased by rotation caused by smooth switching generate pressure and rotational movement.

As explained above, a power (weight) itself has no energy, and fossil fuel itself is not energy. Both are converted to energy by assisting actions from other substance. The increased power of the equipment is placed on fluid of closed circuit, oil hydraulic, water pressure, or steam pressure apparatus, pressurized, and converted to pressure by loading and unloading (contacting with the ground) by right and left portions of a balance constantly. Depending on magnitude of an auxiliary energy of this external driving power (water pressure, steam pressure, engine, motor), pressure of the pressure load equipment, size of each equipment, and energy to be obtained are decided.

Water pressure from a high place is not always available. It takes cost for managing facilities. Wind power generation is not reliable power source equipment, because a place for installment is limited, wind power difference among spring, summer, autumn, and winter, and sometimes it is calm. Solar power generation depends on average day light hours. In a hybrid power generation where equipment of the present invention is combined, consumption of fossil fuel is reduced due because of supply of energy, a superconductive flywheel equipment, etc. is installed in a facility for storage, a high performance rechargeable battery is charged, or a hydrogen is filled at high-pressure via electrolyzation, thereby it may be one of systems for controlling unreliable natural energy. It may be applied for power generation for areas of agriculture and fishery in primary industries in the future, and equipment/facility of important water supply.

### INDUSTRIAL APPLICABILITY

Energy which is unrecognized and unused is discarded. Since fossil fuel is used easily, resulting in accumulated air pollution. In particular, pollution by carbon dioxide gas and petroleum chemical substance, and radiation contamination in the worst case, is a matter of an earth environment and creatures' survival at present and in future. Although there are many means for taking renewable natural energy, there are a few means for taking in all of power from movement around us and taking its kinetic energy efficiently. According to the present invention, there is provided a gravity power generating unit using balances and having pressure load equipment which is provided with means for obtaining a potential energy from the movement and means for converting it from a mechanical energy to an electric energy. Consumption of energy from the present fossil fuel will be limited in near future. The energy policy for the future must be reviewed soon, to convert economy of consumption to economy of environment, to reduce consumption of fossil fuel by half, and reduce exhaust of contaminated substances.

Efficient means for storing required energy is limited to a battery, a flywheel for a short term, and water pumping to a high place for a long term. One of such means is the equipment of the present invention for converting means for increasing power to water pumping force. The equipment of the present invention comprises pressure load equipment for increasing power in large diameter cylinders using water pressure of the high place. The further increased power according to a ratio of balances, is placed on up and down strokes (in large-size equipment, strokes of a double rod chamber correspond to diameter of a cylinder) of double rod water hydraulic cylinders of a reciprocating oil pressure transfer unit. A discharge of the large cylinder is a slight amount of water (stroke of about 10 mm of a head chamber). An amount of water of an water hydraulic rod chamber is also slight, therefore an oil hydraulic rod chamber requires very small capacity of sliding and timing adjustment. Input from an associated crank to a power generator generates driving output for a water power generating station. According to one of plans, in a large-size water resource of a dam, water is shared by water pipes (water pressure pipes) for city water, water for power generation, and farm land. An amount of rain water to be stored is larger than an amount of water which is consumed by a power station of the present equipment. Therefore, it is allows for constant water power generating station which require the water pressure and a slight amount of water. In a dry season, an amount of water required for the farm land may be obtained by pumping groundwater by inexpensive electric power. Inexpensive electric power finally leads to industrial, agricultural or fishery products, therefore equal to storage of energy.

A major purpose of conventional water power generation is for temporary power generation by using large amount of water which has been pumped up with the use of night power. Unlike the conventional power generation, when a power station of the present equipment is employed, water flow is increased in a downstream area, inexpensive electric power is available by constant power generation, and agricultural water is available constantly. This changes necessarily forms of agriculture, increases amount of water in the downstream area, and increases marine life (such as phytoplankton) in the sea of this area. And, the hybrid power generation station of the gravity power generating unit using the balances and having the pressure load equipment will bring the result of restored natural environment and therefore increased productivity of agriculture and fishery.

In a large ship, pressure caused by water flow caused by the large ship increases cruising speed by 30%, and this saves fuel cost. In a vertical axis wind turbine (such as Darrieus wind turbine), by a mechanism of pitch adjustment and variable rotating shafts with the equipment of the present invention, power is generated even in slight winds, and control and braking in strong winds may be secured. And, in a high-speed underground electric railway service which comprises deep underground small-diameter shield tunnels, a plurality of stations on the ground, and straight sloping tracks of the same distance and the same inclination therebetween, an electric power which is regenerated by braking during downhill run of rotary, linear motor trains at super high speed, this allows for energy saving travelling of trains.

What is claimed is:

1. A hybrid power generating system for coupling a large-scale water turbine generator with a gravity power generating unit using balances, the gravity power generating unit having pressure load equipment, the hybrid power generating system, comprising;
a water turbine (78a) to be subject to water pressure energy of height difference of a large-scale hydroelectric power plant, and to be rotated by a large volume of water from a water pressure pipe at high pressure,
a power generator (11) integral with the water turbine (78a),
a gravity power generating unit (A) having pressure load equipment, using upper-lower two step balances with a center on their fulcrum, each of the balances and having a fulcrum point at a center thereof, and
a torque converter automatic transmission (86) disposed between the water turbine generator and the gravity power generating unit (A), for coupling the water turbine generator with the gravity power generating unit (A) into one power generating system;
wherein the larger the wind turbine is, the less frequently will the wind turbine turn.
wherein double acting single rod water pressure cylinders (9a) are provided on right and left leading end portions of the lower balance, a separate pressure water pump for applying water pressure by the height difference communicates in a head chamber of each of the double acting single rod water pressure cylinder (9a), via a pressure control electric valve and a flow control electric valve, leading ends of the cylinder rods are on right and left portions of a load balance (1), and apply a pressure force constantly in proportion a pressure receiving area of a piston in the head chamber,
wherein rod chambers of the right and left double acting single rod cylinders communicate with one another via a oil hydraulic tube (23), load is applied alternately to the right and left rod chambers by pressurizing the hydraulic oil by an variable displacement oil hydraulic piston pump (27) for a closed circuit in a multiplex oil hydraulic pump (14),
wherein the pressure load equipment has control device, the control device comprises a quick acting solenoid on-off shut-off valve (67) and a solenoid discharge valve between the pressure water pipe (4) and the head chamber, permanent magnet (7) and an electromagnet (6) on the leading end portion of the rod;
wherein a reciprocating oil pressure transfer unit is provided on a center portion between right and left ends of the balance, the reciprocating oil pressure transfer unit has a plurality of, right and left a double rod oil hydraulic cylinder (3a) at positions each of which set by a short distance according to a ratio of balances, a power increased by the pressure load equipment is transferred alternately to the double rod oil hydraulic cylinders to pressurize a piston,
wherein upper and lower chambers of the double rod oil hydraulic cylinders are continued via two closed circuit variable displacement oil hydraulic piston pump (25) of the same model which are activated by an external motor, the right and left double rod oil hydraulic cylinders is switched by the closed circuit variable displacement oil hydraulic piston pump (25), using a limit switch (34) at upper and lower dead center positions and a timer (38), at the same time as activation of the pressure load equipment,
wherein the multiplex oil hydraulic pump (14) is a multiplex quintuplex oil hydraulic pump (14) activated by an external motor, in the multiplex quintuplex oil hydraulic pump (14), two auxiliary pumps (26, 28) for replacing hydraulic oil are incorporated at a vertically and laterally symmetrical position, a fulcrum,
wherein a forward reverse tilt plate is angled by sensing a load of an increased power, the forward reverse tilt plate is switched by an automatic cam (46) under power transmission of an intermediate shaft, to define a variable displacement tilt plate angle for increasing quantity of the hydraulic oil,
wherein the external motor (12) activates the auxiliary pump so as to serve a function of supplying the hydraulic oil,
wherein the vertical axis water turbine generator (11) has a flywheel (8) for adjusting volume of water, an rotation axis of the vertical axis water turbine generator rotates a horizontal axis with a spiral bevel gear, the horizontal axis rotating is coupled with a shaft of right and left crank gears (17) of the gravity power generating unit, and coupled with right and left double rod cylinders (3a) and a crank rod (15), a water turbine rotates with up and down movement of the double rod cylinder, the cylinder functions as a pump, the oil hydraulic pump of the closed circuit functions as an oil hydraulic motor, the pump motor functions as a power generator,
wherein the water turbine transmits a commercial electricity as a load,
wherein a device is provided for gradually inputting an increased power to the double rod cylinders moving up and down,
wherein in the generator, an output configuration is arranged in such that a power increased according to a ratio of balances is input from the torque converter automatic transmission, balancing with the flywheel, a water turbine (78a) gradually increases an output by increased volume of water, balancing with an output of the water turbine power generator, accordingly the power which is increased with pressurizing the variable displacement oil hydraulic piston pump is converted to rotation output, the water turbine generator is capable of generating and combining power,
wherein a synchronous or an induction generator of a vector control inverter is used,
wherein the upper and lower closed circuit oil hydraulic pump (25) of the same model, and the right and left double rod oil hydraulic cylinders serve as conveyance media for coupling both power generators by closing circuits to transfer a small quantity of hydraulic oil alternately between the right and left ones,
wherein as countermeasure against sliding heat, a water-cooling radiator (89) of water jacket is applied for an inside of a pipe piston rod and a cylinder sleeve, or to the double acting single rod water pressure cylinder (3b), a double rod water pressure cylinder of arbitrary rod diameter is applied, the double rod water pressure cylinder includes head and rod chambers in which both a water pressure and an oil pressure are applied, and is incorporated in a power generation space.

2. A hybrid power generating system for coupling a small-size small-scale water turbine generator with a gravity power generating unit using balances, the gravity power generating unit having pressure load equipment, the hybrid power generating system, comprising;
a small-size small-scale water turbine generator having a water turbine (78a) and a power generator (11), the water turbine (78a) being selected according to water volume, water flow to use a source of water, a drainage canal or the like at a place of small height difference,
a gravity power generating unit (A) including pressure load equipment and upper-lower two step balances and further including a power generating equipment coupled with the power generator (11) via a horizontal axis, the power generating equipment having a rotating intermediate axis disposed at a position of the balance,
wherein double acting single rod water pressure cylinders (9a) of large diameter are provided on right and left leading end portions of the lower balance, reciprocating oil pressure transfer units are provided on a left and a right of an upper reciprocating balance with respect to a fulcrum point thereof for connecting and linking the upper and lower balances to one another, a pressure from the small volume of water and height difference is increased according to a ratio of balances into a high pressure, the high pressure is transmitted in upper and lower chambers of closed circuit double rod oil hydraulic cylinders (3a) of the reciprocating oil pressure transfer unit,
wherein closed circuit variable displacement oil hydraulic piston pumps (25) of the same model are coupled with external driving means and are connected between upper chambers and between lower chambers, a load of an increased power is applied alternately pistons of the right and left closed circuit double rod oil hydraulic cylinders (3a), at upper and lower dead points, a power further increased is input in the water turbine power generator (11) from the closed circuit double rod oil hydraulic cylinders (3a) and a crank at a position thereof,
wherein or, an air hydraulic cylinders (93) are used as pressure load equipment, instead of the water pressure cylinders, an air pressure is filled in head chambers of the air hydraulic cylinders (93), a load which is more lightweight than a weight placed on the ground is applied on leading ends of a load balance, when the weight contacts the ground by adjusting an oil pressure force in a rod chamber, no load is applied, a power is increased by switching the load alternately to one another, according to a ratio of balances, and inputs in the power generator from the crank mechanism of the double rod cylinders,
wherein alternatively, double acting single rod pneumatic cylinders having an open circuit oil hydraulic unit (79) and a storage tank may be used as pressure load equipment,
wherein a power is increased by discharge of an air pressure of a single acting air cylinder which is a device for gradually inputting a power and by increase of the air pressure by the closed circuit variable displacement oil hydraulic piston pumps (25) of the reciprocating oil pressure transfer unit, the power serves as rotating output, the output by the volume of water is combined with the increased power while adjusting a volume of water of the water turbine power generator and balancing with the increased power, to increase the output, the increased power is input in the water turbine power generator (11), thereby combined with the generated power,
wherein multi polar low revolution synchronous power generator (111) is used in a vector control inverter,
wherein the upper and lower closed circuit variable displacement oil hydraulic pump (25) of the same model, and the right and left double rod oil hydraulic cylinders (3a) are conveyance media for coupling both power generators by closing circuits to transfer a small quantity of hydraulic oil alternately between the right and left ones,
wherein the multiplex oil hydraulic pump (14) is multiplex and is activated by a vector control inverter motor (12) for a commercial electric power, the multiplex oil hydraulic pump (14) organizes one closed circuit variable displacement piston pump for a rod chamber of the double acting single rod water pressure cylinder (9a) and for a rod chamber of the air hydraulic cylinder (9e) of the device, a high-pressure variable displacement piston pump (26) which is one of auxiliary pumps for increasing or replacing the hydraulic oil in the double rod cylinder with its circuit closed, and an auxiliary gear pump (28) which is one for the pressure load equipment,
wherein a device is provided for gradually inputting an increased power to the double rod cylinders moving up and down,
wherein a water turbine (78a) gradually increases an output by increased volume of water, balancing with an output of the water turbine power generator, accordingly the power which is increased with two closed circuit variable displacement oil hydraulic piston pump (25) is rotation output, the water turbine generator is capable of generating and combining power,
wherein a synchronous or an induction generator (11) of a vector control inverter are used,
wherein in order to ensure switching of loading and unloading of the pressure load equipment, a permanent magnet and an electromagnet are provided on frames placed on the balance and the ground, or the frame placed on the ground, and an attraction and repulsion forces thereof is used,
wherein revolution each of a motor (12) and a power generator (11) of the vector control inverter is controlled by a programmed controller, and a power is increased by a small volume of water using each control device and combined with the small-size small scale water turbine power generator that is coupled thereto.

3. A hybrid power generating system, comprising:
a power generator (12) of a boiler (77) of thermal power generation of a steam, gas turbine power generating equipment, geothermal, nuclear power generation, and
a gravity power generating unit (A) which is coupled to the power generator (12) using balances and having pressure load equipment,
wherein double acting single rod steam pressure cylinders (3c)are applied to the pressure load equipment on right and left leading ends of a lower load balance, a stroke of the cylinder is set so as to discharge a slight quantity of steam, not to cause a pressure drop in a head chamber where saturated steam pressure which is air pressure is added,
wherein a seal packing or the like made of a fluorine type elastomer seal packing which withstands saturation temperature of the steam is used, a cylinder sleeve is formed into a structure of water-cooling fin (90), water-cooling radiator (89) of a water jacket in consideration of heatproof temperature of a seal for protecting the seal,
wherein since a piston rod is adapted alternately to load and unload by using attraction and repulsion forces of a permanent magnet and an electromagnet, the piston rod is formed into a lightweight pipe having a structure of water-cooling radiator fin (89)
wherein the rod chamber is open-ended and unloaded, or is loaded by loading alternately on right and left cylinders by a small-size closed circuit variable displacement oil hydraulic piston pump (27), one of a multiplex oil hydraulic pump (14), by switching load and unload under protection by the seal packing,
wherein a lower load balance (1) and an upper reciprocating balance (2) are connected and linked to one another at right and left positions with respect to fulcrum by double rod oil hydraulic cylinders (3a) of the reciprocating oil pressure transfer unit,
wherein right and left upper rod chambers are the same in quantity of a hydraulic oil, right and left lower chambers are the same in quantity of the hydraulic oil, loading is switched alternately between right and left rod chambers by the multiple oil hydraulic pump (14) activated by the vector control inverter motor (12) with external supply of electric power,
wherein alternatively, a double acting single rod steam pressure cylinder (3c), or a double rod steam pressure cylinder of an arbitrary rod diameter is used, the upper and lower chambers are protected by the seal packing, and one of oil hydraulic chambers is pressurized by a closed circuit variable displacement piston pump,
wherein since rise in oil temperature decreases viscosity in oil, and may cause leakage of hydraulic oil, a water-cooling radiator structure is employed for keeping the oil temperature constant,
wherein for the multiplex oil hydraulic pump (14), a vector control inverter motor (12) is used,
wherein in a power generator coupling mechanism comprising a turbine power generator by steam from the boiler (77), the double rod oil hydraulic cylinder (3a) linking the upper and lower balances, and an intermediate axis of a crank mechanism, a steam gas turbine power generator has high revolution, is provided with a speed reducer and a torque converter automatic transmission (86) on a rear axis thereof, and is coupled with the crank mechanism of the reciprocating oil pressure transfer unit,
wherein for electric control devices relative to a force-discharge valve of the pressure load equipment, since a steam has high temperature, a heat-resistant poppet type solenoid on-off shut-off valve activated by a limit switch (34), a timer (38), a solenoid discharge valve (85), an electromagnet (6) or a permanent magnet (7) on a leading end portion of the rod are applied, thereby input from a steam pipe (83) into a head chamber is controlled,
wherein when steam pressure is not used in the gas turbine power generator, by using double acting single rod oil hydraulic cylinders (9c) or single rod pneumatic cylinders (9d) of oil hydraulic pump units fixed on frames placed on right and left on the ground for the pressure load equipment on the load balance, and simultaneously using attraction and repulsion forces of the permanent magnet, the electromagnet on the leading end of the rod, load and unload is repeated,
wherein alternatively, an air hydraulic cylinder (9e) having a head chamber filled with an air pressure and sealed is used for the pressure load equipment, the air pressure balances with a weight (10b) placed on the ground, near each of right and left leading ends of the load balance (1), loading and connection to the ground are repeated by force-discharge alternately by right and left small-size closed circuit variable displacement oil hydraulic piston pumps (27), flushing is done by an auxiliary pump (28), and attraction and repulsion forces of the permanent magnet (7), the electromagnet (6) on the ground and the balance are also used,
wherein a power increased by each of the pressure load cylinders is input from a crank to the steam turbine power generator (11) coupled with the intermediate axis,
wherein a rotating output is increased by the closed circuit variable displacement oil hydraulic piston pump (25) sensing two loads and also by gradual increase of oil pressure and replacement of the hydraulic oil by the auxiliary pump (26),
wherein the air pressure filled in the head chamber of the single acting air cylinder (5) of the device placed on a lower portion of the load balance (1) for gradually inputting an increased power is discharged, and an air pressure is input therein,
wherein the power generator is thermal power generator, nuclear steam power generator or gas turbine generator, for using high pressure from the boiler, turbine power generation of saturated steam of high temperature,
wherein when a geothermal power generation is used, a steam pressure is generated by pressure difference and the volume of steam in a steam borehole, high pressure is obtained by using a double acting single rod steam pressure cylinder (9b) of large diameter in the pressure load equipment,
wherein in the geothermal power generation, the double rod oil hydraulic cylinder (3a) of closed circuit in the reciprocating oil pressure transfer unit, the multiplex oil hydraulic pump (14) which is activated by the vector control inverter motor (12), the pressure load equipment and the crank mechanism are the same in structure except for output difference as the boiler (77) of the aforementioned thermal, nuclear power generation, control devices is used, synchronous generator (11) or inductive generator (11) of the vector control inverter is applied for the power generator, the steam, gas turbine power generator are combined with the gravity power generating unit using balances and having the pressure load equipment.

4. A hybrid power generating system, comprising:
a large-size horizontal axis variable-pitch propeller wind turbine, and
a gravity power generating unit using balances and having pressure load equipment, the gravity power generating unit is coupled with the propeller wind turbine,
wherein a gear of a rotor of the large-size horizontal axis variable-pitch propeller wind turbine is coupled with an axis of an upper portion of a tower, with a spiral bevel gear or a bevel gear,
wherein a blade surface is configured to automatically rotate blades in such a manner that the tower is located in front of a hub and the blade (93), a yaw mechanism of a downwind rotor assists rotation, and functions as a braking apparatus (95),
wherein a gear power generator (11) having a horizontal axis is provided, the gear power generator (11) is coupled with vertically rotating long shaft (96) which extends down onto the ground under the tower, via the spiral bevel gear, alternately, a vertical axis motor (11) is provided in the aboveground tower portion,
wherein by using a plurality of bearings of a middle portion, the shaft and the tower are formed into an integral stress construction,
wherein or, a spinning mechanism for controlling wind direction may be also structured in such a manner that a nacelle and a tower portion are formed into an integral fixed structure, a yaw mechanism is provided in an aboveground portion, in strong winds the orientation of the nacelle is changed automatically while in light winds the nacelle spins by also using an auxiliary oil hydraulic spinning motor with a controller according to information on wind direction from a sensor.
wherein the generator (11) having the horizontal axis or having the vertical axis, is coupled with a gravity power generating unit (A) using balances and having pressure load equipment and is adapted for gradually inputting an power increased according to a ratio of the upper-lower two step balances, by the torque converter automatic transmission (86),
wherein a pressure device selected from an oil hydraulic cylinder (9c) of a oil hydraulic unit (79) and a pneumatic cylinder (9d), or an air hydraulic cylinder (9e) subject to weight of a weight (10b) placed on the ground near right and left leading ends of the pressure load equipment (1) is used for the pressure load equipments on right and left leading end portions of a lower balance,
wherein the power increased according to the ratio of balances is transmitted to the double rod hydraulic oil cylinder (3a) which is connected and linked to the reciprocating balance (2) on the upper step at a position of a fulcrum, the power increased according to the ratio of balances is associated with an oil volume increased and decreased by two closed circuit variable displacement oil hydraulic piston pumps (25) of the multiplex oil hydraulic pump (14) activated by the vector control inverter motor (12) driven by an external supply of electric power, the upper and lower closed circuit variable displacement piston pumps (25) are the same model,
wherein the pressure load equipment is structured in such a manner that an alternate output in chambers of right and left cylinders by one small-size closed circuit variable displacement oil hydraulic piston pump (27) is constant, an air pressure is filled and sealed in a head chamber, the air pressure is balanced with weight of the weight (10b), with assistance of attraction and repulsion forces of a permanent magnet (7) on the ground and the electromagnet (6) of the weight, and alternate loading and unloading are repeated between right and left cylinders at positions of upper and lower dead points of the air hydraulic cylinders,
wherein the power which is adjusted to be increased is added alternately on pistons of the right and left double rod cylinders of which upper chambers are the same in quantity of a hydraulic oil and lower chambers are the same in quantity of the hydraulic oil, then pressurizes the pistons to output an output power from the intermediate axes of right and left cranks which are coupled with and work with the reciprocating balance, the output power is gradually balanced with an output of a flywheel ‘(8) which is placed near the power generator (11) and conditions revolutions of wind power and change of the output
wherein in light winds, the gravity power generating unit (A) using balances and having the pressure load equipment is activated by an external electric power to be a starting motor for driving the wind turbines, while in strong winds, the gravity power generating unit (A) provides and transmits a combined electric power to a commercial electricity that is load, an external electric power is switched to an internal electric power, by a revolution output of the wind turbines, the double rod cylinders (3a) act as oil hydraulic pumps, the oil hydraulic pumps act as oil hydraulic motors, the motor (12) just provides an output for moving up and down the weight (10b) of the pressure load equipment, and the power of increased difference is input and combined in the commercial electricity, thereby combined electric power is provided,
wherein a low revolution multi polar vector control inverter permanent magnet synchronous generator (11) capable of corresponding wind power strength is used, a flywheel (8) is used as an auxiliary device for adding conditions of wind power and gravity, vertical axis power generator (1) is adapted for supporting weight by attraction and repulsion forces of an permanent magnet (7) and an electromagnet (6) in an under portion of the rotation shaft, control devices is provided,
wherein in the hybrid power generating system, the large-size horizontal axis variable-pitch propeller wind turbine, and a gravity power generating unit using balances and having pressure load equipment are coupled with one another to provide combined power generation both in light and strong winds.

5. A hybrid power generating system, comprising:
one of vertical axis wind turbine power generators, an arcuate Darrieus wind turbine power generator and a straight blade wind turbine power generator, and
a gravity power generating unit using balances and having pressure load equipment, the gravity power generating unit is coupled with the power generator,
wherein the vertical axis wind turbine power generator, the arcuate Darrieus wind turbine power generator or the straight blade wind turbine power generator is structured to have a variable pitch blade, a variable blade axis, and a forward reverse revolution axis,
wherein for right and left two blades or a plurality of blades, a central shaft, namely a tower portion is not provided, blade shafts (107) are provided to be entirely located on right and left upper portions, a tower structural member (98) which is a semicircular frame member surrounding the blade shafts on three or four sides is fixed on the ground for supporting the blade shafts,
wherein an upper axis of a coupling structural member and an axis of a lower power generator are adapted for a main magnetic bearing portion, a plurality of, right and left upper blade shafts and lower blade shafts are entirely formed into one fit-in shaft (107), the fit-in shaft (107) is fitted in a main shaft, thereby a rotating shaft for whole blades is constructed,
wherein one center shaft (101) extending through between center of upper and lower main shafts and the plurality of the blade shafts (102) reinforced with a horizontal reinforcing plate (103) are provided, the horizontal reinforcing plate surface (103) and the blade plate surface are fixed, thereby a structure of the blade shaft (102) and the flexible center shaft (101) is constructed, in the fit-in shaft (107) in the bearing of the blade plate fixed on the horizontal reinforcing plate (103) and the upper and lower main shafts, an inserting hole (109) is formed for inserting each of a plurality of blade shafts (105) which may be variably controlled and braked, therein, the blade plate (100) may be slid up and down in each bearing,
wherein adjustment of expansion and contraction of the blade against bend, flexure and torsion of the blade, etc., in strong winds, and adjustment of pitch are possible, and upper and lower play portions (109a) are provided in bearing portions of the blade,
wherein each shaft is rotated by oil hydraulic or electric motor gear (106), suppressed by being automatically tightened by a brake band, each shaft serves as a variable blade shaft rotating in right and left directions, thereby a structure of right and left blade surface lifting force blades is constructed,
wherein the blade may be subject to a wind power in a framing member tower (98) and rotated forwardly and reversely even in light winds by moving the blade surface so as to rotate forwardly and reversely, and adjusting the blade shaft to an optimum position,
wherein each of the right and left blades (100) is reinforced by a horizontal reinforcing plate (103) at an arbitrary position such as a vertical center portion, and a rotation structure is constructed by receiving the right and left blades by upper and lower reinforcing shafts (102) which are designed slim and light-weight and a blade central axis (101),
wherein alternately, when wind pressure is borne in upper and lower play portions in upper and lower shafts and material of the blade has sufficient strength, the shaft (102) and the horizontal reinforcing plate (103) are not required,
wherein the arcuate Darrieus wind turbine is structured in such a manner that when each blade shaft (105) rotates by around 90 degrees, each shaft moves to such position that all blade plates (100) are oriented in a direction of wind, thereby wind power is eluded in strong winds or typhoons blow,
wherein in the straight bladed wind turbine, semicircular frame members to be fixed on the ground are framed upright thereby forming a tower (98a) surrounding the blades on three or four sides or any number of sides, instead of providing a central tower as in the arcuate Darrieus blades,
wherein an entire blade rotating shaft (107) for the plurality of blade plate surfaces (100) and fixedly coupled horizontal plates (103b) is adapted for the fit-in shaft (107) which is fitted in the main shaft center magnetic bearing (97a),
wherein each of the blade shafts may rotate forwardly and reversely by about 90 degrees,
wherein a low revolution permanent magnet synchronous power generator (11) is provide in a lower shaft (107), weight of the blade is reduced by floating action caused by repulsion, and increased by loading caused by attraction, by adjusting magnetic force of a permanent magnet (7) and an electromagnet (6) provided in the lower bearing portion, self-rotation of the blade is achieved even in slight winds thanks to floating structure, by using an magnetic bearing (97a) and a bearing (97) simultaneously for the upper bearing,
wherein fixing of the above frame structure member on the ground allows for installation of a wind turbine larger than the present straight blade Darrieus wind turbine on an installation area smaller than before, a size may be reduced by providing a plurality of blades, the shaft of a center axis of the tower which is reduced in diameter and weight defines an axis for receiving a horizontal reinforcing plate (103), the upper and lower shafts of each blade is adapted for a rotating gear axis (105), thereby the straight blade with turbine having blades without a tower is constructed,
wherein a torque converter automatic transmission (86) is provided on an axis of a permanent magnet synchronous power generator (11) or inductive power generator (11) of a vector control inverter multi polar low revolution structure, and an axis of an intermediate gear of a crank mechanism of reciprocating oil pressure transfer unit of the gravity power generating unit (A) using balances and having the pressure load equipment is coupled with an axis of the power generator,
wherein a power of oil pressure, air pressure, weight etc. added on the pressure load equipment on a leading end of the load balance (1) is increased according to a ratio of balances, the increased power is placed on a hydraulic oil which is filled and sealed in upper and lower chambers of the cylinder piston with the same volume, by activating right and left double rod cylinders (3a) of the reciprocating oil pressure transfer unit with use of two closed circuit variable displacement oil hydraulic piston pumps (25) of the same model, an output is increased by increasing oil quantity by pressurizing pistons, and input into the power generator while balancing with a flywheel (8),
wherein a vector control inverter motor of a multiplex oil hydraulic pump (14) is actuated by switching between the external electric power and an electric power generated by wind power, the wind power generation and the power generation of the gravity power generating unit are combined, one of the vertical axis Darrieus wind turbine generator and the straight blade wind power generator is coupled with the gravity power generating unit using balances and having pressure load equipment, thereby the hybrid power generating system is constructed for the purpose of increasing power generation in high wind operation.

6. A hybrid power generating system, comprising:
one of vertical axis wind turbine power generators, an arcuate Darrieus wind turbine power generator and a straight blade wind turbine power generator, and
a gravity power generating unit using balances and having pressure load equipment, the gravity power generating unit being coupled with the power generator,
wherein a structural member is installed fixedly on the ground with the use of a tower frame member which surrounds the wind turbine on three or four sides, and vertical axis wind turbines, an arcuate Darrieus wind turbine or a straight bladed wind turbine having a plurality of blades rotating in one way is constructed in the structural member, in the wind turbine, stress such as a centrifugal force on a bearing portion caused by one-way rotation is a great burden, a force exerted on the blades, a bearing and a fixed base which are exposed to wind and rain for a long time period is divided into two by pitch control, to construct a wind turbine having an inner and an outer forward reverse rotation wind blades, in the wind turbine, the arbitrary number of inner blades and the arbitrary number of outer blades are provided, respectively, the distance of spacing between inner and outer blades is increased as much as possible, respectively, for eliminating difference in wind speed due to inner and outer blades, a flywheel (8) is provided for converting varied wind speeds to constant revolutions at intersection, a stress, a centrifugal force on upper and lower shafts are balanced each other for reducing a burden on the bearing, and are balanced with a power increased according to a ratio of balances,
wherein two magnetic bearings (97a) on upper and lower portions of the tower serve to eliminate sound of winds by rotating two rotating shafts, an rotating shaft (107) for the inner blades, an entire rotating shaft (108) for outer blades forwardly and reversely,
wherein forward reverse revolutions are switched and combined in one electric power generator (11) by a torque converter reverse rotation transmission (86a) of a lower axis,
wherein the outer blade (99) is not provided with a reinforcing plate, each blade shaft (105) includes upper and lower plays (109a) for sliding (109) blade plates,
wherein for supporting weight of a plurality of the blades (99, 100) and the flywheel (8) and a floating force by wind power, repulsion and attractive forces of a permanent magnet (7) and an electromagnet (6), a magnetic bearing and a bearing are used concurrently to reduce frictional resistance,
wherein a structure without central tower is constructed, expansion and contraction of the blades and entire floating force by strong winds are absorbed in the upper and lower play portions (109a) of a shaft center, thereby the burden on the blades is reduced,
wherein pitch is adjusted by clockwise and counterclockwise rotations of each blade shaft, the blade is rotated to a position for causing a blade lift force even in breeze, thereby control is made allowing for power generation,
wherein a low revolution, multi polar, vector control inverter permanent magnet synchronous power generator (11) or an induction power generator (11) is directly-connected and used, revolutions of axes of separate power generators are combined by a spiral bevel gear (94) of a torque converter transmission (86a),
wherein an intermediate gear shaft of the reciprocating oil pressure transfer unit of the gravity power generating unit (A) using the balance and having the pressure load equipment is coupled with the power generator via a torque converter automatic transmission (86),
wherein a power of oil pressure, air pressure, weight etc. added on the pressure load equipment on a leading end of the load balance (1) is increased according to a ratio of balances, the increased power is placed on a hydraulic oil which is filled and sealed in upper and lower chambers of the cylinder piston with the same volume, by activating right and left double rod cylinders (3a) of the reciprocating oil pressure transfer unit with use of two closed circuit variable displacement oil hydraulic piston pumps (25) of the same model, an output is increased by increasing oil pressure (quantity) by pressurizing pistons, and input into the power generator while balancing with the flywheel (8),
wherein a vector control inverter motor (12) of a multiplex oil hydraulic pump (14) is actuated by switching between an external electric power and an electric power generated by wind power, the power generated by wind and the power generated by the gravity power generating unit are combined, it serves as an auxiliary motor (12) activated by an external electric power for start up of rotation of the blades in light winds, when power is generated by wind in fair winds, the electric power is switched from an external commercial electric power to an internal wind power generated power, then used, inner and outer forward reverse rotation blades are combined, the vertical axis Darrieus wind turbine generator or the straight blade wind power generator is coupled with the gravity power generating unit using balances and having pressure load equipment, thereby the hybrid power generating system is constructed.

7. A hybrid power generating system, comprising:
a gravity power generating unit (A) using balances and having pressure load equipment, adapted for inputting generated power in solar generated power of a large size solar power generating station, the gravity power generating unit being adapted for increasing a power according to a ratio of two step, upper and lower balances, and for inputting the increased power in the solar power generation of the large size solar power generating station,
wherein in solar power generation, a power is generated in proportion to daylight hours and the number of the solar panels (110), the generated power is connected to a commercial power supply (111a) and is stored in a power storage system (112) by means of inverter control, and since the daylight hours are limited, solar power generation is required to increase production of power within the limited hours,
wherein a multiplex oil hydraulic pump (14) used for the pressure load equipment and a reciprocating oil pressure transfer unit is activated by a motor (12) which is driven by an external electric power,
wherein for the pressure load equipment provided on a leading end portion of a lower load balance (1) extending to the right and left, a water pressure cylinder by obtaining a water pressure from a high place, a steam pressure cylinder in a place where steam pressure is available, an oil hydraulic cylinder (9c) of an oil hydraulic unit (79), a pneumatic cylinder (9d), or an object which supports weight of the weights (10b) on right and left leading end portions of the load balance (1) by the air hydraulic cylinder (9c) may be used, any one of them repeats loading and unloading alternately on the right and the left of the balance,
wherein a power is increased by the pressure load equipment according to the ratio of balances, the increased power is transferred to right and left double rod oil hydraulic cylinders (3a) which are connected and linked to an upper reciprocating balance (2) at a fulcrum position,
wherein for the multiplex oil hydraulic pump (14) a vector control inverter motor driven by the external electric power is used, the double rod oil hydraulic pump (3a) is driven by two closed circuit variable displacement piston pumps of the same model which are provided between the upper chambers, and between the lower chambers, respectively,
wherein an alternate output of the water pressure, the steam pressure, the oil pressure or the air pressure from one small size closed circuit variable displacement oil hydraulic piston pump (27) provided between the pressure load equipments, or an alternate output into right and left rod chambers of the air hydraulic cylinders is constant,
wherein an air pressure is filled in the head chamber of the air hydraulic cylinder, to be balanced with weight of a weight (10b), or a pressure is injected and discharged in a head chamber of the water pressure, the steam pressure, or the pneumatic cylinder, and injected alternately right and left oil hydraulic rod chambers,
wherein with assistance of attraction and repulsion forces of the permanent magnet (7) and the electromagnet (6) of the weight on the ground or the load balance, loading and unloading is switched repeatedly, alternately on the right and left cylinders at a position of upper and lower dead points of the crank,
wherein a power increased by loading is placed alternately on pistons of right and left double rod cylinders (3a) in which volume of oil is the same between the upper chambers, and between the lower chambers, thereby pushing the pistons,
wherein by increasing oil quantity with an auxiliary pump (26) an output of the power generator (11) is gradually increased via intermediate axes of right and left cranks which are coupled and associated with the reciprocating balance, the output of the power generator is combined with the solar generated power by a power conditioner (53),
wherein in hours without sunshine, such as nighttime and rainy day, the gravity power generating unit (A) using the balances and having the pressure load equipment is driven by a vector control inverter motor (12) which is activated by an external electric power, and functions as a solo gravity power generating unit or as a power generation unit constructed by combining the gravity power generating unit (A) and a wind turbine power generator, a power from each pressure load equipment is increased according to the ratio of balances and input in the gravity power generating unit (A),
wherein in strong winds, a combined electric power is transmitted to the commercial electric power which is a load,
wherein in a place where a water pressure from a high place is available, the water pressure cylinder is employed for each cylinder of the pressure load equipment, the reciprocating oil pressure transfer unit, in a place where a steam pressure is available from a boiler and a geothermal heat, the steam pressure cylinder is employed for each cylinder of the pressure load equipment, the reciprocating oil pressure transfer unit, alternately, an oil hydraulic (9c), a pneumatic cylinder (9d), a weight and air hydraulic cylinder (93) is used for the pressure load equipment,
wherein in a combined power generating station, a power is generated mainly by solar power generation in unpredictable sunshine hours in daytime, the power is combined by connecting the power conditioner (53) of the solar power generation to unpredictable wind power generation,
wherein a low revolution multi polar vector control inverter permanent magnet synchronous generator (11) capable of corresponding wind power strength is used, during either of solar power generation or wind power generation, an external electric power is switched to an internal electric power, by a revolution output of the wind turbine power generation, the double rod cylinders (3a) act as oil hydraulic pumps, the oil hydraulic pumps act as oil hydraulic motors, an output of the motor (12) is applied just as an output for moving up and down the weight (10b) of the pressure load equipment, and the power of increased difference is input in the commercial electricity, thereby combined electric power is provided,
wherein in the hybrid power generating system, a generated power of a wind power generation or a separate gravity power generating unit (A), and a solar generated power are combined by the power conditioner (53), each control device is provided for increasing output, and the gravity power generating unit using the balance and having the pressure load equipment is coupled.

8. A hybrid power generating system, comprising:
an oil, a liquefaction gas, a coal, an iron ore, a container carrier, a large special service ship, a self-navigation work vessel, a vessel, a submarine having a motor (12) propeller shaft connected to a diesel engine (113) and a power generator, a steam turbine propeller shaft of a gas turbine engine (114) or a nuclear power and a power generator, and
a gravity power generating unit using balances and having pressure load equipment,
wherein a large size diesel engine is of low or middle revolution, a flywheel (8) is provided on a front part of the engine, a gas turbine (78b), a nuclear power steam turbine (78) are of high revolution,
wherein the propeller shaft is coupled with an intermediate gear shaft of a crank gear of a reciprocating oil pressure transfer unit of the gravity power generating unit (A) using the balance and having the pressure load equipment, via a reduction gear device and a torque converter automatic transmission (86),
wherein in head chambers of right and left large size double acting single rod water pressure cylinders (9a) of the pressure load equipment, a high water pressure is taken through a water pipe (4) from a bow of the ship with the use of own ship speed,
wherein when a double acting single rod steam pressure cylinder (9b) is used, each of a boiler steam pressure (77) by cooling of a gas turbine (78b) and a boiler steam pressure of a nuclear power is injected in a head chamber of a cylinder via a pressure/flow rate control electric valve (92), thereby a pressure on a leading end of the rod is obtained, injection quantity of the steam pressure is very small so as to cause a slight stroke,
wherein the pressure is placed on a right and left of the load balance so as to be applied thereon constantly,
wherein water is discharged while steam is circulated,
wherein a high water pressure pump (4b) to be activated by a motor (12) is provided in a pressure water pipe, thereby water flow of the self-navigation vessel is made at high pressure,
wherein for the reciprocating cylinder, a double rod oil hydraulic cylinder (3a), a double acting double rod water pressure cylinder, or double acting single rod water pressure cylinder (3b) is used, oil pressure is applied in a rod chamber of the double rod cylinder, used is the double rod cylinder in which oil pressure is applied in a rod chamber and water pressure is applied the other rod chamber, while used is the double acting single rod cylinder in which the water pressure is applied in the head chamber, and the oil pressure is applied in the rod chamber,
wherein the stroke is associated with a crank (15), and operating directions of the pistons are switched alternately between the right and the left cylinders by a switch (34) at upper and lower dead points,
wherein in a vessel without using water pressure force, the double acting single rod oil hydraulic cylinder (9c) of which activation is controlled by the oil hydraulic pump, or the double acting single rod pneumatic pump (9d) which is pressurized by the air pressure compressor and pressurized air pump is used,
wherein the structure of connecting the above directly to the engine is employed, the generator or a motor propeller shaft of the motor propeller shaft ship is coupled via a torque converter automatic transmission,
wherein power is generated at an arbitrary place where the water flow or the steam pressure is introduced, and the power is transmitted.
wherein control is carried out by each control device provided in the pressure load equipment of the gravity power generating unit (A) using the balances and having the gravity power generating unit,
wherein in the case of a ship on cruise for a long period of time, water flow caused by the ship according to the cruising speed provides a loading output, and a fuel cost is saved by using the steam pressure to increase cruising speed, and the gravity power generating unit using the balances and having the pressure load equipment is coupled.

9. A hybrid power generating system, comprising:
a train such as local train and limited express train, and
a gravity power generating unit using balances and having pressure load equipment,
wherein an electric power which is used for operation of the number of train services for the entire distance of railway routes including uphills and downhills is transmitted to trains (118) by a plurality of substations using direct current or alternating current via overhead cables,
wherein an electric power consumption becomes to a maximum from when a train starts till when the train runs at a nominal velocity, will be decreased when the train operates with inertia driving force, and when a regenerative brake is used for deceleration, an electric power is returned via overhead cables in direct current and alternate current trains, the electric power more than required for total number of train services is transmitted, for safety purpose,
wherein to reuse properly the regenerated electric power which otherwise should have been discarded, the gravity power generating unit (A) using balances and having the pressure load equipment is installed at each substation,
wherein two closed circuit variable displacement piston pumps (25) of the multiplex oil hydraulic pump (14) of a reciprocating oil pressure transfer unit and one closed circuit variable displacement piston pump (27) are driven by a motor (12) activated by the regenerative brake, the closed circuit variable displacement piston pumps (25) are provided between upper chambers and between lower chambers of the double rod cylinders (3a), respectively, the closed circuit variable displacement piston pump is provided between rod chambers of the pressure load equipment using oil pressure, air pressure, a weight, or water pressure from a rain reservoir, etc. of a building at a high place or between rod chambers of right and left air hydraulic cylinders (9e) using a weight, oil pressure force is controlled by the closed circuit variable displacement piston pump (27),
wherein a single acting air cylinder (5) is adapted for input of power which is gradually increased by right and left alternate loading according to a ratio of the balances, output by discharge of the single acting air cylinder (5) and by increased oil pressure (oil volume) of two closed circuit variable displacement piston pump (25) is transmitted to a commercial electric power, as generated power of a generator (11) of a vector control inverter, from a rotation sensor of a power generator or the like via a controller (53), alternately, a power generated by an increased power by the motor (12) activated by a surplus electric power is fed, thereby regenerated power at a substation of a train is used efficiently.

10. A hybrid power generating system, to be coupled with the gravity power generating unit using the balance and having the pressure load equipment, as set forth in claim 9,
wherein in a high-speed underground electric railroad service in land over a public land and a private land such as a town area, under bottom of the sea, or the like, a train runs on a single track straight railway of standard gauge or wider gauge connecting stations to one another, provided in a deep underground small diameter tunnel (126b),
wherein a plurality of platforms (126b) are provided per station in a starting station, a terminal station, and a plurality of intermediate stations which are provided on the ground, between adjacent stations, provided are an uphill zone and a downhill zone (124) which have the same inclination relative to a platform and the same distance, and a level zone which also has the same depth and distance,
wherein a part of the plurality of the platforms is adapted for the platforms for access to street cars on the ground or for access to route buses,
wherein the train service is based on a shuttle service on a single track between stations, therefore, when a route is completed between two stations, it may be adapted for commercial railway,
wherein for a train, a low-floor train (118a) driven by an alternate current high output rotating vector control inverter VVVF induction motor having each control device is used, allowing for acceleration up to 400 km/h along the downhill zone (for employing in smaller diameter tunnels, a magnetically elevated low-floor linear motor train is used), the train is accelerated to a maximum speed along the downhill zone, for braking a potential energy on the zone, a regenerative brake is used,
wherein a regenerated power is returned to substation facilities (111) installed on the plurality of the stations, input as a driving power of a vector control inverter motor (12) of a multiplex oil hydraulic pump (14) of the gravity power generating unit (A) using the balance and having the pressure load equipment,
wherein the gravity power generating unit (A) using the balances and having the pressure load equipment has each control device and is driven at a low voltage, the multiplex oil hydraulic pump (14) organizes main pumps (25, 27) for each cylinder of the reciprocating oil pressure transfer unit and the pressure load equipment, and auxiliary pumps (26, 28) for flushing and increasing oil pressure (volume) into one unit,
wherein the pressure load equipment is activated by a closed circuit oil hydraulic piston pump (27), the pressure load equipment is an air hydraulic cylinder (9e) which are disposed under the right and left portions of the load balance (1) for applying a load of a weight (10b) alternately on the right and left of the load balance, or an apparatus for applying the load by a pressure force from any of an oil hydraulic unit, pneumatic cylinder, a water pressure cylinder using a water pressure from the high place, along with attraction and repulsion forces of a permanent magnet (7) and an electromagnet (6),
wherein by a reciprocating oil pressure transfer unit, right and left double rod cylinders (3a) located with a fulcrum of the load balance (1) therebetween are linked and connected to one another with the use of the reciprocating balance (2), in bilaterally symmetrical relation, a power increased according to a ratio of length between the reciprocating balance and the load balance is transmitted to the double rod cylinders (3a), one and the other upper chambers, and one and the other lower chambers are communicated by two closed circuit variable displacement oil hydraulic piston pumps (25) for producing a reciprocating drive force,
wherein single acting air cylinders (5) which support the right and left portions of the load balance and gradually input a power thereto are installed on the ground, a power which is increased by discharge of the single acting air cylinder (5) is gradually input in the reciprocating oil pressure transfer unit,
wherein at the same time, from the auxiliary pump (26) a quantity of oil, an amount of fluid pumped corresponding to the increased power is gradually added, a rotation output is increased, a flywheel (8) is provided in an intermediate gear shaft engaging with right and left crank gears of the speed increasing gear box (13) of a crank mechanism which is associated with the double rod cylinders (3a) coupled with the reciprocating balance (2), the power is input from the intermediate gear shaft in the vector control inverter generator (11) and output therefrom,
wherein an electric power is generated corresponding to an electric power to be consumed by a plurality trains, is transformed to alternate current electricity at high voltage and fed to overhead wires, or transmitted to a commercial electric power,
wherein the train runs on a level zone, an uphill zone to a platform and arrives at the platform on the ground, using a power regenerated during run on a downhill zone and a power generated by the gravity power generating unit (A),
wherein most of an amount of electric power for a plurality of single-track trains is supplied from the gravity power generating unit (A) using the balances and having the pressure load equipment, each of the single-track train departs from a station at 3 to 4 minute intervals,
wherein in the train service, a plurality of platforms (126) at each station are used, trains operate on a single track in such a manner that a train departs from a starting station (123a), arrives at a next station (123b), another train waiting at the next station (123b) departs immediately for the starting station (123a), the train stopping at the next station (123b) immediately departs for an intermediate station (123c), after the train arrives at the intermediate station (123c), yet another train waiting at the intermediate station (123c) departs for the next station (123b), a train service comprises a train service stopping at every station between the starting station to the terminal station and a simple shuttle train service between stations, in the train service, a train departs from the starting station (123a) to the terminal station, at the same time a (different) train departs from the terminal station for the starting station, a person who gets on at the starting station (123a) and gets off at the terminal station and a person who gets on the terminal station directing the starting station do not change trains, although trains stop at every station, a person who gets on at any of intermediate stations may always get on a train waiting at the station or may await and get on either of the train directing the starting station and the train directing the terminal station, a waiting time corresponds to a driving time between the stations,
wherein in regard to boarding and exiting of passengers, seats are eliminated, and instead, handrail stands (137) are provided on a floor, for smooth flow of passengers, a passenger step (130, 130a) is provided, the passenger step automatically operates with opening and closing of a door, thereby a gap and a level difference between the train and the platform are eliminated, allowing a passenger such as a passenger in a wheel chair, or a passenger with a baby buggy to get on and off swiftly and without inconvenience and to afford to spend time for getting on and off from arrival to departure of the train,
wherein for a single track train service, a safety equipment is arranged on rails (126a) alongside of a platform at a train-stop-station, the safety equipment has a mechanism for allowing only one train in a tunnel between the stations,
wherein in the high-speed underground electric railroad service, a section is connected between aboveground stations via a small-diameter deep underground tunnel (126b), each section includes a downhill zone, a level zone, and an uphill zone of generally the same distance, the section is of a straight railway with a single track of broad gauge, most of an electric power required for driving a plurality of low-floor trains (118a) driven by an alternate current high-output rotary induction motor may be provided by a plurality of the gravity power generating units (A) using the balances and having the pressure load equipments which effectively use an electric power regenerated in operation on the downhill zone.

11. A hybrid power generating system for coupling a gravity power generating unit using balances and having pressure load equipment, and a high-speed underground electric railroad service in land over a public land and a private land such as a town area, under bottom of the sea, or the like, as set forth in claim 10,
wherein a plurality of platforms (126) are provided at each station of the starting station, the terminal station and a plurality of the intermediate stations, a deep underground single track tunnel is provided in each section between the stations, each of the deep underground single track tunnels has a structure of the same distance, the same downhill and uphill zones, a level zone of the same distance and depth, the deep underground single track tunnel may be a small-diameter shielded tunnel,
wherein the magnetically elevated low-floor linear motor (118b) is a small-size high speed onboard primary member type magnetically elevated linear motor train (118b), a low-floor train (118a) which can operate stably at high-speed,
wherein alternately a shielded tunnel of large size is provided, the shielded tunnel is divided into upper and lower parts for operation on a double track,
wherein in the magnetically elevated low-floor linear motor train (118c), an air conditioner and a control device to be disposed in a ceiling of a compartment is disposed under seats (119b) provided on a side wall adjoined to a floor, thereby a vertical width is decreased compared to the aforementioned magnetically elevated low-floor linear motor train (118b),
wherein concrete segments (127) of the tunnel are partly replaced with steel segments (127a), and a thin steel structural member (127b) which is provided integrally with a magnetically elevated structural member (127c) is adhered and fixed onto the steel segments (127a) of a center potion of the tunnel, thereby the tunnel is divided and blocked,
wherein a pressure plate (120) has a structure of applying wind pressure to restrain shaking of a body of the train running at high speed which is caused by distorted structure of an inside of a double track tunnel having upper and lower tracks, the pressure plates are provided on the steel structural members supporting the segments and the steel structural members (127b), spaced at arbitrary regular interval, the pressure plates are provided also on a roof of the train, thereby constructing a structure for maintaining constant airflow relative to top, right and left sides of the body of the train to restrain shaking of the body of the train,
wherein a service of the magnetically elevated low-floor linear motor train (118c) uses an aboveground station having two-storied, upper and lower platforms,
wherein the magnetically elevated linear motor trains (118b, 118c) operating on a single and double tracks are accelerated to the maximum speed on the downhill zone, a regenerated power by a regenerative brake used in the zone is input in the vector control inverter motor (12) of the multiplex oil hydraulic pump (14) of the gravity power generating unit using the balance and having the pressure load equipment, via each control device of a substation facility (111), as a driving electric power,
wherein a generated power of the vector control inverter power generator (11) is transformed again to an alternate current high voltage and fed to overhead cables or transformed to a commercial electric power, by a structure similar to a low-floor rotating motor train (118a),
wherein the magnetically elevated low-floor linear motor train (118b, 118c) is driven by using an alternating current high-output vector control inverter VVVF induction linear motor, when each distance between stations is longer and higher speed is required, a superconductive elevated linear motor train is employed, the high-speed underground electric railroad service comprises the small diameter deep underground tunnels.

12. A high-speed underground railroad service, as set forth in claim 10,
wherein a passenger step used by passengers are adapted for facilitating swift, safe and sure boarding and alighting,
an internally threaded portion is formed in a lower portion of a housing portion of a sliding door (131), side portions of the step (130) on right and left portions contacting with a floor of a body of a train is adapted for bearings (133b), right and left externally threaded shafts are fitted in the internally threaded portions, then the shafts are connected to right and left portions of the step (130), the internally threaded portion (133) rotates the externally threaded shaft (132) about an axis along with opening and closing of the door, thereby the step of a proper width contacts a floor of a platform, the step is provided with a play as counter measure against shaking of the train, the passenger step has a simple and sure mechanical structure for being stored in front of the door and extended to contact with the floor of the platform repeatedly,
wherein alternately, in a train having cars which are configured so as to define generally constant gap and level difference relative to a platform along an entire length of the train cars, provided is a mechanism which is actuated by using an electric, pneumatic apparatus for extending the passenger step (130a) from an underside of a floor adjacent to a door and retracting the passenger step (130a) therein, cooperating with opening and closing of the door, two types of step equipment (130, 130a) comprises a metallic portion and an elastic material such as rubber or plastic for eliminating the gap (134) and the level difference between the platform (129) and the floor adjacent to the passenger door, the passenger step is non-slip, and has proper width and thickness, thereby the passenger step is structured so as to allow passengers with a large carry-bag or a baby baggie, a passenger in wheelchair, or a handicapped passenger for getting on and off the train surely and safely, the passenger step may be applied for the linear motor train, an aboveground street car or a route bus, the high-speed underground railroad service is provided with the passenger step (130, 130a) for allowing reduction in boarding and alighting time surely and safely in a high-speed train operation.

13. A high-speed underground railroad service, as set forth in claim 10,
wherein handrail stands are provided for facilitating smooth flow of passengers getting on and off a train which stops at a station, since the train departs from a station at 3 to 4 minute intervals and operates through tunnels in a short time period, no window is required, in a low-floor rotary motor train (7), a portion such as a floor which covers wheels is used for the required number of seats (119, 119a) for the handicapped, in a magnetically elevated low-floor linear motor train, each air conditioner, control device or the like to be disposed in a ceiling is positioned under seats on a side wall which contacts with the floor, a rest of the floor is not provided with seats, instead, hand straps or the like are provided, and hand rails on right and left side walls (137b) (hand rest) are provided, and two rows of the handrail stands (137) are provided on a center portion of the floor, in parallel relation to the side walls, or on the floor in parallel relation to the side walls,
wherein the proper number of the handrail stands (137) having proper length roughly at waist height are provided at positions except for those near passenger doors (131, 131 a), or a portion of a floor which does not disturb passengers from boarding or alighting, the handrail stands (137a) in place of seats are provided perpendicular to the direction of travel, since the handrail stands (137a) are roughly waist-high, a passenger is allowed to lean his body on the handrail stand, while holding the strap with his hand, thereby the passenger may be prepared for acceleration during travelling at high-speed, the high-speed underground electric railroad service which are provided with the handrail stands by eliminating seats for facilitating smooth flow of passengers boarding and alighting may be applied to a commuting train, vehicle for the handicapped, or route bus.
